(19) United States
(12) Patent Application Publication
(10) Pub. No.: US 2023/0224891 A1
(43) Pub. Date: Jul. 13, 2023

(54) METHOD AND APPARATUS FOR RECEIVING DOWNLINK AND UPLINK RADIO RESOURCES IN UNLICENSED BAND

(71) Applicant: WILUS INSTITUTE OF STANDARDS AND TECHNOLOGY INC., Gyeonggi-do (KR)

(72) Inventors: Minseok NOH, Seoul (KR); Kyungjun CHOI, Gyeonggi-do (KR); Geunyoung SEOK, Seoul (KR); Jinsam KWAK, Gyeonggi-do (KR)

(21) Appl. No.: 17/928,263

(22) PCT Filed: May 28, 2021
(86) PCT No.: PCT/KR2021/006705

§ 371 Date: Nov. 28, 2022

(30) Foreign Application Priority Data
May 28, 2020 (KR) 10-2020-0064451
Jun. 10, 2020 (KR) 10-2020-0070609
Jan. 28, 2021 (KR) 10-2021-0012061

(51) Int. Cl. H04W 72/1263; H04W 72/232; H04L 5/00; H04W 56/00; H04W 74/08

(52) U.S. Cl. CPC H04W 72/1263; H04W 72/232; H04L 5/0048; H04L 5/0053; H04W 56/001; H04W 74/0833; H04W 16/14

(57) ABSTRACT

The present invention relates to a method and an apparatus for configuring downlink and uplink radio resources in an unlicensed band. The present invention provides a method comprising the steps of: receiving information indicating at least one synchronization signal/physical broadcast channel (SS/PBCH) block index from a base station in the unlicensed band; and receiving downlink control information (DCI) for allocation of resources for a physical downlink shared channel (PDSCH) in the unlicensed band from the base station. Therefore, efficient transmission of downlink and/or uplink data or control information in an unlicensed band is possible.

### TECHNICAL FIELD

The disclosure relates to wireless communication and, more specifically, to a resource configuration method, apparatus, and system for downlink channel reception in an unlicensed band, a resource configuration method, device, and system for uplink signal or channel transmission in an unlicensed band, a downlink channel reception method, apparatus, and system in an unlicensed band, an uplink signal or channel transmission method, apparatus, and system in an unlicensed band, and a method, an apparatus, and a system for downlink channel reception and uplink channel transmission.

### BACKGROUND ART

3GPP new radio (NR) defines uplink/downlink physical channels for physical-layer signal transmission. For example, a physical uplink shared channel (PUSCH) which is a physical channel for transmitting data via an uplink, a physical uplink control channel (PUCCH) for transmitting a control signal, a physical random-access channel (PRACH), and the like, are defined. A physical downlink control channel (PDCCH) for transmitting an L1/L2 control signal as well as a physical downlink shared channel (PDSCH) for transmitting data via a downlink are defined.

Among the channels above, the downlink control channel (PDCCH) corresponds to a channel for transmitting uplink/downlink scheduling allocation control information, uplink transmission power control information, and other control information by a base station to one or multiple terminals. Since resources available for the PDCCH which can be transmitted by a base station at one time are limited, different resources cannot be allocated to different terminals, and a resource area is to be shared and control information is to be transmitted to a random terminal. The PDCCH is transmitted in a control resource set (CORESET) including one, two, or three OFDM symbols. Unlike LTE in which control channels are over the entire carrier system bandwidth, the bandwidth of the CORESET may freely configured with multiple six RBs. For example, in 3GPP NR, 12 resource elements (REs) included in one RB of one OFDM symbol are grouped into a resource element group (REG), six REGs are grouped into one control channel element (CCE), the PDCCH configures 1, 2, 4, 8, or 16 CCEs and identifies a PDCCH resource obtained by aggregating one or multiple CCEs to the terminal, and multiple terminals may use the CCEs by sharing the same. Here, the number of the CCEs included in the PDCCH is referred to a CCE aggregation level, and a resource to which the CCEs are allocated according to a possible CCE aggregation level is referred to as a search space. The search space may include a common search space defined for each base station, and a terminal-specific (or UE-specific search space) defined for each terminal. The terminal monitors one or more PDCCH candidates to receive DCI having CRC scrambled by a specific radio network temporary indicator (RNTI) in the PDCCH common search space (CSS) and UE-specific search space (USS). The terminal may perform PDCCH decoding for the number of all possible CCE aggregation cases which can be included in the PDCCH, in the search space, and may identify whether the PDCCH corresponds to its own PDCCH through a user equipment (UE) identifier included in the PDCCH. Accordingly, in the operation of the terminal, a time required to decode the PDCCH is long and consuming a great amount of energy is inevitable.

After commercialization of 4th generation (4G) communication system, in order to meet the increasing demand for wireless data traffic, efforts are being made to develop new 5th generation (5G) communication systems. The 5G communication system is called as a beyond 4G network communication system, a post LTE system, or a new radio (NR) system. In order to achieve a high data transfer rate, 5G communication systems include systems operated using the millimeter wave (mmWave) band of 6 GHz or more, and include a communication system operated using a frequency band of 6 GHz or less in terms of ensuring coverage so that implementations in base stations and terminals are under consideration.

A 3rd generation partnership project (3GPP) NR system enhances spectral efficiency of a network and enables a communication provider to provide more data and voice services over a given bandwidth. Accordingly, the 3GPP NR system is designed to meet the demands for high-speed data and media transmission in addition to supports for large volumes of voice. The advantages of the NR system are to have a higher throughput and a lower latency in an identical platform, support for frequency division duplex (FDD) and time division duplex (TDD), and a low operation cost with an enhanced end-user environment and a simple architecture.

For more efficient data processing, dynamic TDD of the NR system may use a method for varying the number of orthogonal frequency division multiplexing (OFDM) symbols that may be used in an uplink and downlink according to data traffic directions of cell users. For example, when the downlink traffic of the cell is larger than the uplink traffic, the base station may allocate a plurality of downlink OFDM symbols to a slot (or subframe). Information about the slot configuration should be transmitted to the terminals.

In order to alleviate the path loss of radio waves and increase the transmission distance of radio waves in the mmWave band, in 5G communication systems, beamforming, massive multiple input/output (massive MIMO), full dimensional MIMO (FD-MIMO), array antenna, analog beam-forming, hybrid beamforming that combines analog beamforming and digital beamforming, and large scale antenna technologies are discussed. In addition, for network improvement of the system, in the 5G communication system, technology developments related to evolved small cells, advanced small cells, cloud radio access network (cloud RAN), ultra-dense network, device to device communication (D2D), vehicle to everything communication (V2X), wireless backhaul, non-terrestrial network communication (NTN), moving network, cooperative communication, coordinated multi-points (CoMP), interference cancellation, and the like are being made. In addition, in the 5G system, hybrid FSK and QAM modulation (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced connectivity technologies, are being developed.

Meanwhile, in a human-centric connection network where humans generate and consume information, the Internet has evolved into the Internet of Things (IoT) network, which exchanges information among distributed components such as objects. Internet of Everything (IoE) technology, which combines IoT technology with big data processing technology through connection with cloud servers, is also emerging. In order to implement IoT, technology elements such as sensing technology, wired/wireless communication and network infrastructure, service interface technology, and security technology are required, so that in recent years, technologies such as sensor network, machine to machine (M2M), and machine type communication (MTC) have been studied for connection between objects. In the IoT environment, an intelligent internet technology (IT) service that collects and analyzes data generated from connected objects to create new value in human life can be provided. Through the fusion and mixture of existing information technology (IT) and various industries, IoT can be applied to fields such as smart home, smart building, smart city, smart car or connected car, smart grid, healthcare, smart home appliance, and advanced medical service.

Accordingly, various attempts have been made to apply the 5G communication system to the IoT network. For example, technologies such as a sensor network, a machine to machine (M2M), and a machine type communication (MTC) are implemented by techniques such as beamforming, MIMO, and array antennas. The application of the cloud RAN as the big data processing technology described above is an example of the fusion of 5G technology and IoT technology.

Generally, a mobile communication system has been developed to provide voice service while ensuring the user's activity. However, the mobile communication system is gradually expanding not only the voice but also the data service, and now it has developed to the extent of providing high-speed data service. However, in a mobile communication system in which services are currently being provided, a more advanced mobile communication system is required due to a shortage phenomenon of resources and a high-speed service demand of users.

In addition, in such a situation, a scheme that uses an unlicensed frequency spectrum or unlicensed frequency band (e.g., 2.4 GHz band, 5.8 GHz band, or the like) for providing the cellular communication service has been devised as a solution to a spectrum shortage problem.

However, in the unlicensed band, a communication service provider does not secure an exclusive frequency use right through a procedure such as auction, and multiple communication facilities can be simultaneously used without limit when only a predetermined level of adjacent band protection regulation is observed. As a result, it is difficult to guarantee communication quality at a level provided in the licensed band and an interference problem with a device performing communication by using the conventional unlicensed band (e.g., a Wi-Fi network) may occur.

Therefore, research into a coexistence scheme with the conventional unlicensed band device and a scheme for efficiently sharing a radio channel needs to be preferentially made in order to settle LTE and NR-unlicensed technology in the unlicensed band. That is, a robust coexistence mechanism (RCM) needs to be developed in order to prevent a device using the LTE and NR-unlicensed technology in the unlicensed band from influencing the conventional unlicensed band device.

In relation to the standardization, currently in 3GPP, various communication business operators as well as manufacturers including Qualcomm are actively and continuously introducing standards for LTE and NR-unlicensed technology in the unlicensed band and developing standard technology, and are proceeding with standardization for commercialization as technology which enables dual connectivity and licensed assisted access including standalone to be performed. In addition, a foundation for commercialization of various services and new technologies is established without usage designation under the condition that basic radio etiquette in the frequency sharing band or the unlicensed low power band is observed. On the other hand, most of the unlicensed bands including an ISM band are operated on the basis of usage designation, and thus technical research and related policy establishment relating to the operation of the unlicensed bands need to be performed first.

### DISCLOSURE OF INVENTION

### Technical Problem

A technical problem of the disclosure is to provide a resource configuration method and a transmission/reception method and system for downlink channel reception and uplink signal/channel transmission on an unlicensed band in a wireless communication system, particularly, a cellular wireless communication system.

Another technical problem of the disclosure is to provide a method, an apparatus, and a system for uplink channel transmission according to scheduling information through a downlink control channel in a 3GPP NR system.

Another technical problem of the disclosure is to provide a method and an apparatus for indicating an RB set of a UL BWP by using an RB set in which a DCI format is received.

Another technical problem of the disclosure is to provide a method and an apparatus for indicating an RB set of a UL BWP by using an RB set of a UL BWP before BWP switching.

Another technical problem of the disclosure is to provide a method and an apparatus for indicating an RB set when there is no RB set of an UL BWP, which overlaps with an RB set in which a DCI format is received.

Another technical problem of the disclosure is to provide a method and an apparatus for indicating multiple RB sets by using a DCI format.

Technical problems to be solved by the disclosure are not limited to the problems described herein.

### Solution to Problem

According to an aspect of the disclosure, a method for processing a downlink channel by a terminal in an unlicensed band is provided. The method may include: receiving information indicating one or more synchronization signal/physical broadcast channel (SS/PBCH) block indices from a base station in the unlicensed band, wherein the one or more SS/PBCH block indices are used to recognize one or more resources corresponding to the one or more SS/PBCH block indices, respectively, among multiple resources based on candidate SS/PBCH block indices; and receiving downlink control information (DCI) for allocating resources for a physical downlink shared channel (PDSCH) from the base station in the unlicensed band, wherein the PDSCH is received on the basis of a resource remaining after excluding the one or more resources from among the resources allocated by the DCI.

In an aspect, the PDSCH is decoded on the basis of the resources when the resources for the PDSCH and the one or more resources do not overlap with each other. When the resources for the PDSCH and the one or more resources partially or completely overlap with each other, resources partially or completely overlapping with the one or more resources among the resources may not be used for the PDSCH.

In an aspect, the SS/PBCH block indices correspond to multiple resources, and when SS/PBCH blocks are received in some resources among the multiple resources within a DRS transmission window, a resource remaining after excluding some resources from the multiple resources within the DRS transmission window is not used for reception of the PDSCH.

In another aspect, the method further includes receiving information on a maximum number of the one or more SS/PBCH block indices from the base station, wherein rate matching of the PDSCH is performed in one or more resources corresponding to the maximum number within a DRS transmission window, among the multiple resources based on the candidate SS/PBCH block indices.

In another aspect, a semi-static channel access mode is configured in the unlicensed band, and when the one or more resources among the multiple resources based on the candidate SS/PBCH block indices overlap with an idle period of a fixed frame period (FFP), the PDSCH is decoded on the basis of the resources for the PDSCH.

In another aspect, a semi-static channel access mode is configured in the unlicensed band, and in the information indicating the one more synchronization signal/physical broadcast channel (SS/PBCH) block indices, a bit value corresponding to a resource overlapping with an idle period of an FFP is configured as 0.

According to another aspect, a method for processing an uplink signal by a terminal in an unlicensed band is provided. The method may include: receiving information indicating one or more synchronization signal/physical broadcast channel (SS/PBCH) block indices from a base station in the unlicensed band, wherein the one or more SS/PBCH block indices are used to recognize one or more resources corresponding to the one or more SS/PBCH block indices, respectively, among multiple resources by candidate SS/PBCH block indices; and determining a resource for the uplink signal in the unlicensed band, wherein the resource for the uplink signal is determined on the basis of the one or more resources corresponding to the one or more SS/PBCH block indices, respectively.

In an aspect, the uplink signal is a random access preamble, the resource for the uplink signal is a physical random access channel (PRACH) occasion within a PRACH slot, and in a case where uplink/downlink configuration information is not provided, if the PRACH occasion does not precede the one or more resources corresponding to the one or more SS/PBCH block indices, respectively, and starts after at least Ngap symbols from a last reception symbol of the one or more resources, the PRACH occasion may be determined as valid.

In another aspect, the uplink signal is a random access preamble, the resource for the uplink signal is a PRACH occasion within a PRACH slot, and in a case where uplink/downlink configuration information is provided, if the PRACH occasion does not precede the one or more resources corresponding to the one or more SS/PBCH block indices, respectively, starts after at least Ngap symbols from a last downlink symbol, and starts from at least Ngap symbols from a last reception symbol of the one or more resources, the PRACH occasion may be determined as valid.

In another aspect, a semi-static channel access mode is configured in the unlicensed mode, the uplink signal is a random access preamble, and the resource for the uplink signal is a PRACH occasion within a PRACH slot, and when the one or more resources overlap with an idle period of a fixed frame period, the PRACH occasion may be determined regardless of the one or more resources.

In another aspect, the uplink signal is a random access preamble, the resource for the uplink signal is a PRACH occasion within a PRACH slot, and validity of the PRACH occasion may be determined on a premise that SS/PBCH blocks having the one or more SS/PBCH block indices are transmitted in the one or more resources corresponding to all the one or more SS/PBCH block indices, respectively, within a DRS transmission window.

In another aspect, the uplink signal is a physical uplink control channel (PUCCH) repetition, the resource for the uplink signal is N slots for PUCCH transmission, and the N slots may be selected from among multiple slots including an uplink symbol or a flexible symbol not overlapping with the one or more resources corresponding to the one or more SS/PBCH block indices, respectively.

In another aspect, the uplink signal is a PUCCH repetition, the resource for the uplink signal is N slots for PUCCH transmission, when the SS/PBCH block indices correspond to multiple resources and SS/PBCH blocks are received in some resources among the multiple resources within a DRS transmission window, the N slots may be selected from among multiple slots including an uplink symbol and a flexible symbol which remain after excluding some resources from the multiple resources within the DRS transmission window.

In another aspect, the uplink signal is a PUCCH repetition, the resource for the uplink signal is N slots for PUCCH transmission, and a slot including an uplink symbol or a flexible symbol not overlapping with the one or more resources corresponding to the one or more SS/PBCH block indices, respectively, may be determined as the resource for the uplink signal on a premise that SS/PBCH blocks having the one or more SS/PBCH block indices are transmitted in the one or more resources corresponding to all the one or more SS/PBCH block indices, respectively, within a DRS transmission window.

In another aspect, the uplink signal is a PUCCH repetition, the resource for the uplink signal is N slots for PUCCH transmission, and when the one or more resources corresponding to the one or more SS/PBCH block indices, respectively, overlap with an idle period of a fixed frame period, the N slots may be determined regardless of the one or more resources corresponding to the one or more SS/PBCH block indices, respectively.

In another aspect, the uplink signal is a physical uplink shared channel (PUSCH) repetition, the resource for the uplink signal is a resource for PUSCH transmission.

An uplink symbol or a flexible symbol not overlapping with the one or more resources corresponding to the one or more SS/PBCH block indices, respectively, may be determined as the resource for the PUSCH transmission.

In another aspect, the uplink signal is a PUSCH repetition, the resource for the uplink signal is a resource for PUSCH transmission, and when the SS/PBCH block indices correspond to multiple resources and SS/PBCH blocks are received in some resources among the multiple resources within a DRS transmission window, an uplink symbol and a flexible symbol of a resource, which remain after excluding some resources from the multiple resources within the DRS transmission window may be determined as the resource for the PUSCH transmission.

In another aspect, the uplink signal is a PUSCH repetition, the resource for the uplink signal is a resource for PUSCH transmission, and an uplink symbol or a flexible symbol not overlapping with the one or more resources corresponding to the one or more SS/PBCH block indices, respectively, may be determined as the resource for the PUSCH transmission on a premise that SS/PBCH blocks having the one or more SS/PBCH block indices are transmitted in the one or more resources corresponding to all the one or more SS/PBCH block indices, respectively, within a DRS transmission window.

In another aspect, the uplink signal is a PUSCH repetition, the resource for the uplink signal is a resource for PUSCH resource, and when the one or more resources corresponding to the one or more SS/PBCH block indices, respectively, overlap with an idle period of a fixed frame period, the resource for the PUSCH transmission may be determined regardless of the one or more resources corresponding to the one or more SS/PBCH block indices, respectively.

According to another aspect of the disclosure, a method for interpreting an RB set of a UL BWP on the basis of a frequency domain resource assignment (FDRA) field of a downlink control information (DCI) format and performing communication on the basis of the interpretation is provided.

In an aspect, a terminal may interpret the RB set of the UL BWP by using scheduling information of an RB set in which DCI is received and RB sets adjacent to the RB set.

In an aspect, interlaces of the UL BWP, indicated from the FDRA field of the DCI format, may be grouped and interpreted as scheduling information.

The above-describe solutions are only some of preferred embodiments of the disclosure, various changes to which the technical feature of the disclosure is applied can be understood by those skilled in the art to which the disclosure belongs, and the following detailed description of the disclosure can be referred to.

### Advantageous Effects of Invention

A resource configuration method and transmission/reception method for downlink channel and uplink signal/channel transmission in an unlicensed band are provided, whereby downlink and/or uplink data or control information can be efficiently transmitted on the unlicensed band. In addition, the terminal can perform uplink transmission according to indication of a downlink control channel.

The effects obtainable in the present disclosure are not limited to the above-mentioned effects, and other effects that are not mentioned above may be clearly understood by those of ordinary skill in the art from the following description.

### BRIEF DESCRIPTION OF DRAWINGS

FIG. 1 illustrates an example of a wireless frame structure used in a wireless communication system.

FIG. 2 illustrates an example of a downlink (DL)/uplink (UL) slot structure in a wireless communication system.

FIG. 3 is a diagram for explaining a physical channel used in a 3GPP system and a typical signal transmission method using the physical channel.

FIG. 4 illustrates an SS/PBCH block for initial cell access in a 3GPP NR system.

FIGS. 5a and 5b illustrate a procedure for transmitting control information and a control channel in a 3GPP NR system.

FIG. 6 illustrates a control resource set (CORESET) in which a physical downlink control channel (PUCCH) may be transmitted in a 3GPP NR system.

FIG. 7 illustrates a method for configuring a PDCCH search space in a 3GPP NR system.

FIG. 8 is a conceptual diagram illustrating carrier aggregation.

FIG. 9 is a diagram for explaining single carrier communication and multiple carrier communication.

FIG. 10 is a diagram showing an example in which a cross carrier scheduling technique is applied.

FIG. 11 illustrates a New Radio-Unlicensed (NR-U) service environment.

FIG. 12 illustrates an embodiment of an arrangement scenario of a UE and a base station in an NR-U service environment.

FIG. 13 illustrates a communication method (e.g., wireless LAN) operating in an existing unlicensed band.

FIG. 14 illustrates a channel access procedure based on Category 4 LBT according to an embodiment of the present disclosure.

FIG. 15 illustrates an embodiment of a method of adjusting a contention window size (CWS) based on HARQ-ACK feedback.

FIG. 16 illustrates the locations of OFDM symbols occupied by SSBs in a slot including 14 OFDM symbols.

FIG. 17 illustrates the location of a symbol which can be occupied by an SSB in one slot.

FIG. 18 illustrates the location of a slot which can be occupied by an SSB within 5 ms corresponding to a half radio frame.

FIG. 19 is a flowchart illustrating a method for processing a downlink signal in an unlicensed band according to an example.

FIG. 20 illustrates at least one candidate SS/PBCH block which can be transmitted within a DRS transmission window according to an example.

FIG. 21 illustrates an FBE operation in a semi-static channel access mode according to an embodiment.

FIG. 22 is a flowchart illustrating a method for processing an uplink signal in an unlicensed band according to an example.

FIG. 23 illustrates a method for indicating an RB set of a UL BWP by using an RB set in which a DCI format is received according to an example.

FIG. 24 illustrates a method for indicating an RB set of a UL BWP by using an RB set in which a DCI format is received according to another example.

FIG. 25 illustrates a method for indicating an RB set of a UL BWP by using an RB set of a UL BWP before switching according to an example.

FIG. 26 illustrates a method for indicating an RB set when there is no RB set of a UL BWP, which overlaps with an RB in which a DCI format is received, according to an example.

FIG. 27 illustrates a method for indicating an RB set when there is no RB set of a UL BWP, which overlaps with an RB in which a DCI format is received, according to another example.

FIG. 28 illustrates a method for indicating an RB set when there is no RB set of a UL BWP, which overlaps with an RB in which a DCI format is received, according to another example.

FIG. 29 illustrates a method for indicating multiple RB sets by using a DCI format according to an example.

FIG. 30 illustrates a method for indicating multiple RB sets by using a DCI format according to another example.

FIG. 31 illustrates a method for indicating multiple RB sets by using a DCI format according to another example.

FIG. 32 is a block diagram illustrating a terminal and a base station according to an example.

### BEST MODE FOR CARRYING OUT THE INVENTION

Terms used in the specification adopt general terms which are currently widely used as possible by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the present disclosure. Accordingly, it intends to be revealed that a term used in the specification should be analyzed based on not just a name of the term but a substantial meaning of the term and contents throughout the specification.

Throughout this specification and the claims that follow, when it is described that an element is “connected” to another element, the element may be “directly connected” to the other element or “electrically connected” to the other element through a third element. Further, unless explicitly described to the contrary, the word “comprise” will be understood to imply the inclusion of stated elements but not the exclusion of any other elements unless otherwise stated. Moreover, limitations such as “more than or equal to” or “less than or equal to” based on a specific threshold may be appropriately substituted with “more than” or “less than”, respectively, in some exemplary embodiments.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), and the like. The CDMA may be implemented by a wireless technology such as universal terrestrial radio access (UTRA) or CDMA2000. The TDMA may be implemented by a wireless technology such as global system for mobile communications (GSM)/general packet radio service (GPRS)/enhanced data rates for GSM evolution (EDGE). The OFDMA may be implemented by a wireless technology such as IEEE 802.11 (Wi-Fi), IEEE 802.16 (WiMAX), IEEE 802-20, evolved UTRA (E-UTRA), and the like. The UTRA is a part of a universal mobile telecommunication system (UMTS). 3rd generation partnership project (3GPP) long term evolution (LTE) is a part of an evolved UMTS (E-UMTS) using evolved-UMTS terrestrial radio access (E-UTRA) and LTE-advanced (A) is an evolved version of the 3GPP LTE. 3GPP new radio (NR) is a system designed separately from LTE/LTE-A, and is a system for supporting enhanced mobile broadband (eMBB), ultra-reliable and low latency communication (URLLC), and massive machine type communication (mMTC) services, which are requirements of IMT-2020. For the clear description, 3GPP NR is mainly described, but the technical idea of the present disclosure is not limited thereto.

Unless otherwise specified herein, the base station may include a next generation node B (gNB) defined in 3GPP NR. Furthermore, unless otherwise specified, a terminal may include a user equipment (UE).

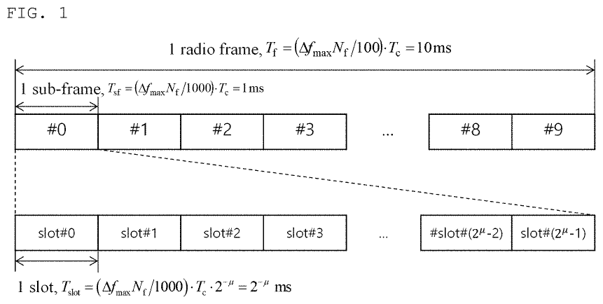

FIG. 1 illustrates an example of a wireless frame structure used in a wireless communication system. Referring to FIG. 1, the wireless frame (or radio frame) used in the 3GPP NR system may have a length of 10 ms (ΔfmaxNf/100)*Tc). In addition, the wireless frame includes 10 subframes (SFs) having equal sizes. Herein, Δfmax=480*103 Hz, Nf=4096, Tc=1/(Δfref*Nf,ref), Δfref=15*103 Hz, and Nf,ref=2048. Numbers from 0 to 9 may be respectively allocated to 10 subframes within one wireless frame. Each subframe has a length of 1 ms and may include one or more slots according to a subcarrier spacing. More specifically, in the 3GPP NR system, the subcarrier spacing that may be used is 15*2 μkHz, and μ can have a value of μ=0, 1, 2, 3, 4 as subcarrier spacing configuration. That is, 15 kHz, 30 kHz, 60 kHz, 120 kHz and 240 kHz may be used for subcarrier spacing. One subframe having a length of 1 ms may include 2μ slots. In this case, the length of each slot is 2-μ ms. Numbers from 0 to 2μ−1 may be respectively allocated to 2μ slots within one wireless frame. In addition, numbers from 0 to 10*2μ−1 may be respectively allocated to slots within one subframe. The time resource may be distinguished by at least one of a wireless frame number (also referred to as a wireless frame index), a subframe number (also referred to as a subframe index), and a slot number (or a slot index).

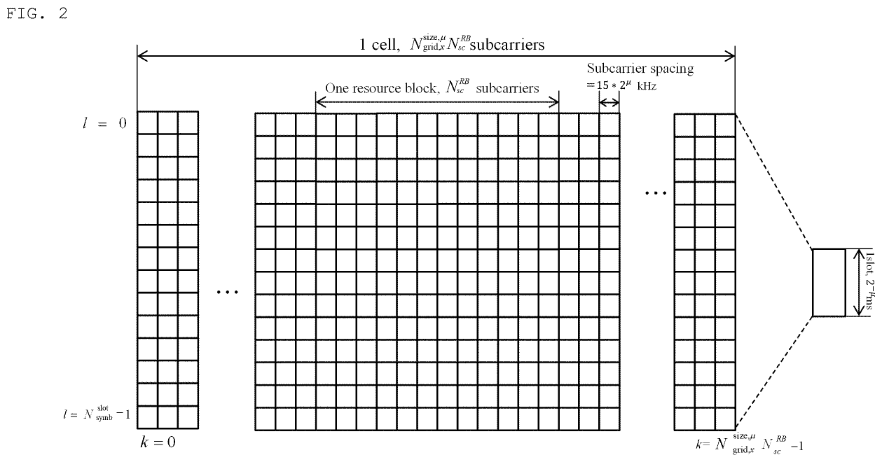

FIG. 2 illustrates an example of a downlink (DL)/uplink (UL) slot structure in a wireless communication system. In particular, FIG. 2 shows the structure of the resource grid of the 3GPP NR system. There is one resource grid per antenna port. Referring to FIG. 2, a slot includes a plurality of orthogonal frequency division multiplexing (OFDM) symbols in a time domain and includes a plurality of resource blocks (RBs) in a frequency domain. An OFDM symbol also means one symbol section. Unless otherwise specified, OFDM symbols may be referred to simply as symbols. Referring to FIG. 2, a signal transmitted from each slot may be represented by a resource grid including Nsize,μgrid,x*NRBsc subcarriers, and Nslotsymb OFDM symbols. Here, x=DL when the signal is a DL signal, and x=UL when the signal is an UL signal. Nsize,μgrid,x represents the number of resource blocks (RBs) according to the subcarrier spacing constituent μ (x is DL or UL), and Nslotsymb represents the number of OFDM symbols in a slot. NRBsc is the number of subcarriers constituting one RB and NRBsc=12. An OFDM symbol may be referred to as a cyclic shift OFDM (CP-OFDM) symbol or a discrete Fourier transform spread OFDM (DFT-s-OFDM) symbol according to a multiple access scheme.

The number of OFDM symbols included in one slot may vary according to the length of a cyclic prefix (CP). For example, in the case of a normal CP, one slot includes 14 OFDM symbols, but in the case of an extended CP, one slot may include 12 OFDM symbols. In a specific embodiment, the extended CP can only be used at 60 kHz subcarrier spacing. In FIG. 2, for convenience of description, one slot is configured with 14 OFDM symbols by way of example, but embodiments of the present disclosure may be applied in a similar manner to a slot having a different number of OFDM symbols. Referring to FIG. 2, each OFDM symbol includes Nsize,μgrid,x*NRBsc subcarriers in the frequency domain. The type of subcarrier may be divided into a data subcarrier for data transmission, a reference signal subcarrier for transmission of a reference signal, and a guard band. The carrier frequency is also referred to as the center frequency (fc).

One RB may be defined by NRBsc (e. g., 12) consecutive subcarriers in the frequency domain. For reference, a resource configured with one OFDM symbol and one subcarrier may be referred to as a resource element (RE) or a tone. Therefore, one RB can be configured with Nslotsymb*NRBsc resource elements. Each resource element in the resource grid can be uniquely defined by a pair of indexes (k, 1) in one slot. k may be an index assigned from 0 to Nsize,μgrid,x*NRBsc−1 in the frequency domain, and 1 may be an index assigned from 0 to Nslotsymb−1 in the time domain.

In order for the UE to receive a signal from the base station or to transmit a signal to the base station, the time/frequency of the UE may be synchronized with the time/frequency of the base station. This is because when the base station and the UE are synchronized, the UE can determine the time and frequency parameters necessary for demodulating the DL signal and transmitting the UL signal at the correct time.

Each symbol of a radio frame used in a time division duplex (TDD) or an unpaired spectrum may be configured with at least one of a DL symbol, an UL symbol, and a flexible symbol. A radio frame used as a DL carrier in a frequency division duplex (FDD) or a paired spectrum may be configured with a DL symbol or a flexible symbol, and a radio frame used as a UL carrier may be configured with a UL symbol or a flexible symbol. In the DL symbol, DL transmission is possible, but UL transmission is impossible. In the UL symbol, UL transmission is possible, but DL transmission is impossible. The flexible symbol may be determined to be used as a DL or an UL according to a signal.

Information on the type of each symbol, i.e., information representing any one of DL symbols, UL symbols, and flexible symbols, may be configured with a cell-specific or common radio resource control (RRC) signal. In addition, information on the type of each symbol may additionally be configured with a UE-specific or dedicated RRC signal. The base station informs, by using cell-specific RRC signals, i) the period of cell-specific slot configuration, ii) the number of slots with only DL symbols from the beginning of the period of cell-specific slot configuration, iii) the number of DL symbols from the first symbol of the slot immediately following the slot with only DL symbols, iv) the number of slots with only UL symbols from the end of the period of cell specific slot configuration, and v) the number of UL symbols from the last symbol of the slot immediately before the slot with only the UL symbol. Here, symbols not configured with any one of a UL symbol and a DL symbol are flexible symbols.

When the information on the symbol type is configured with the UE-specific RRC signal, the base station may signal whether the flexible symbol is a DL symbol or an UL symbol in the cell-specific RRC signal. In this case, the UE-specific RRC signal can not change a DL symbol or a UL symbol configured with the cell-specific RRC signal into another symbol type. The UE-specific RRC signal may signal the number of DL symbols among the Nslotsymb symbols of the corresponding slot for each slot, and the number of UL symbols among the Nslotsymb symbols of the corresponding slot. In this case, the DL symbol of the slot may be continuously configured with the first symbol to the i-th symbol of the slot. In addition, the UL symbol of the slot may be continuously configured with the j-th symbol to the last symbol of the slot (where i<j). In the slot, symbols not configured with any one of a UL symbol and a DL symbol are flexible symbols.

The type of symbol configured with the above RRC signal may be referred to as a semi-static DL/UL configuration. In the semi-static DL/UL configuration previously configured with RRC signals, the flexible symbol may be indicated as a DL symbol, an UL symbol, or a flexible symbol through dynamic slot format information (SFI) transmitted on a physical DL control channel (PDCCH). In this case, the DL symbol or UL symbol configured with the RRC signal is not changed to another symbol type. Table 1 exemplifies the dynamic SFI that the base station can indicate to the UE.

TABLE 1

| | Symbol number in a slot | | | | | | | | | | | | | | | Symbol number in a slot | | | | | | | | | | | | | |
|---|---|---|---|---|---|---|---|---|---|---|---|---|---|---|---|---|---|---|---|---|---|---|---|---|---|---|---|---|---|
| index | 0 | 1 | 2 | 3 | 4 | 5 | 6 | 7 | 8 | 9 | 10 | 11 | 12 | 13 | index | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D | 28 | D | D | D | D | D | D | D | D | D | D | D | D | X | U |
| 1 | U | U | U | U | U | U | U | U | U | U | U | U | U | U | 29 | D | D | D | D | D | D | D | D | D | D | D | X | X | U |
| 2 | X | X | X | X | X | X | X | X | X | X | X | X | X | X | 30 | D | D | D | D | D | D | D | D | D | D | X | X | X | U |
| 3 | D | D | D | D | D | D | D | D | D | D | D | D | D | X | 31 | D | D | D | D | D | D | D | D | D | D | D | X | U | U |
| 4 | D | D | D | D | D | D | D | D | D | D | D | D | X | X | 32 | D | D | D | D | D | D | D | D | D | D | X | X | U | U |
| 5 | D | D | D | D | D | D | D | D | D | D | D | X | X | X | 33 | D | D | D | D | D | D | D | D | D | X | X | X | U | U |
| 6 | D | D | D | D | D | D | D | D | D | D | X | X | X | X | 34 | D | X | U | U | U | U | U | U | U | U | U | U | U | U |
| 7 | D | D | D | D | D | D | D | D | D | X | X | X | X | X | 35 | D | D | X | U | U | U | U | U | U | U | U | U | U | U |
| 8 | X | X | X | X | X | X | X | X | X | X | X | X | X | U | 36 | D | D | D | X | U | U | U | U | U | U | U | U | U | U |
| 9 | X | X | X | X | X | X | X | X | X | X | X | X | U | U | 37 | D | X | X | U | U | U | U | U | U | U | U | U | U | U |
| 10 | X | U | U | U | U | U | U | U | U | U | U | U | U | U | 38 | D | D | X | X | U | U | U | U | U | U | U | U | U | U |
| 11 | X | X | U | U | U | U | U | U | U | U | U | U | U | U | 39 | D | D | D | X | X | U | U | U | U | U | U | U | U | U |
| 12 | X | X | X | U | U | U | U | U | U | U | U | U | U | U | 40 | D | X | X | X | U | U | U | U | U | U | U | U | U | U |
| 13 | X | X | X | X | U | U | U | U | U | U | U | U | U | U | 41 | D | D | X | X | X | U | U | U | U | U | U | U | U | U |
| 14 | X | X | X | X | X | U | U | U | U | U | U | U | U | U | 42 | D | D | D | X | X | X | U | U | U | U | U | U | U | U |
| 15 | X | X | X | X | X | X | U | U | U | U | U | U | U | U | 43 | D | D | D | D | D | D | D | D | D | X | X | X | X | U |
| 16 | D | X | X | X | X | X | X | X | X | X | X | X | X | X | 44 | D | D | D | D | D | D | X | X | X | X | X | X | U | U |
| 17 | D | D | X | X | X | X | X | X | X | X | X | X | X | X | 45 | D | D | D | D | D | D | X | X | U | U | U | U | U | U |
| 18 | D | D | D | X | X | X | X | X | X | X | X | X | X | X | 46 | D | D | D | D | D | X | U | D | D | D | D | D | X | U |
| 19 | D | X | X | X | X | X | X | X | X | X | X | X | X | U | 47 | D | D | X | U | U | U | U | D | D | X | U | U | U | U |
| 20 | D | D | X | X | X | X | X | X | X | X | X | X | X | U | 48 | D | X | U | U | U | U | U | D | X | U | U | U | U | U |
| 21 | D | D | D | X | X | X | X | X | X | X | X | X | X | U | 49 | D | D | D | D | X | X | U | D | D | D | D | X | X | U |
| 22 | D | X | X | X | X | X | X | X | X | X | X | X | U | U | 50 | D | D | X | X | U | U | U | D | D | X | X | U | U | U |
| 23 | D | D | X | X | X | X | X | X | X | X | X | X | U | U | 51 | D | X | X | U | U | U | U | D | X | X | U | U | U | U |
| 24 | D | D | D | X | X | X | X | X | X | X | X | X | U | U | 52 | D | X | X | X | X | X | U | D | X | X | X | X | X | U |
| 25 | D | X | X | X | X | X | X | X | X | X | X | U | U | U | 53 | D | D | X | X | X | X | U | D | D | X | X | X | X | U |
| 26 | D | D | X | X | X | X | X | X | X | X | X | U | U | U | 54 | X | X | X | X | X | X | X | D | D | D | D | D | D | D |
| 27 | D | D | D | X | X | X | X | X | X | X | X | U | U | U | 55 | D | D | X | X | X | U | U | U | D | D | D | D | D | D |

| | |
|---|---|
| 56~255 | Reserved |

In Table 1, D denotes a DL symbol, U denotes a UL symbol, and X denotes a flexible symbol. As shown in Table 1, up to two DL/UL switching in one slot may be allowed.

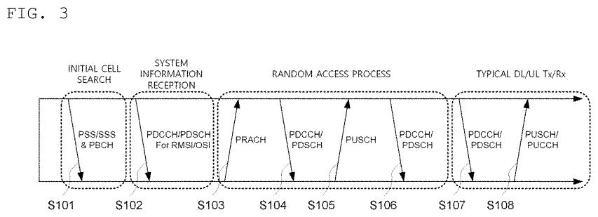

FIG. 3 is a diagram for explaining a physical channel used in a 3GPP system (e.g., NR) and a typical signal transmission method using the physical channel. If the power of the UE is turned on or the UE camps on a new cell, the UE performs an initial cell search (step S101). Specifically, the UE may synchronize with the BS in the initial cell search. For this, the UE may receive a primary synchronization signal (PSS) and a secondary synchronization signal (SSS) from the base station to synchronize with the base station, and obtain information such as a cell ID. Thereafter, the UE can receive the physical broadcast channel from the base station and obtain the broadcast information in the cell.

The UE having completed the initial cell search may acquire system information more specific than system information acquired through the initial cell search by receiving a physical downlink shared channel (PDSCH) according to a physical downlink control channel (PDCCH) and information carried by the PDCCH (Step S102).

When the UE initially accesses the base station or there is no radio resource for signal transmission, the UE may perform a random access process for the base station (Steps S103 to 106). First, the UE may transmit a preamble through a physical random access channel (PRACH) (Step S103), and receive a response message to the preamble from the base station through a PDCCH and a corresponding PDSCH (Step S104). When the UE receives a valid random access response message, the UE transmits data including its own identifier, etc. to the base station through a physical uplink shared channel (PUSCH) indicated by an uplink grant transferred from the base station through the PDCCH (Step S105). Next, in order to solve confliction, the UE waits for reception of the PDCCH as an indication of the base station. When the UE successfully receives the PDCCH through its own identifier (Step S106), the random access process ends.

After the above-described procedure, the UE receives PDCCH/PDSCH (step S107) and transmits a physical uplink shared channel (PUSCH)/physical uplink control channel (PUCCH) (step S108) as a general UL/DL signal transmission procedure. In particular, the UE may receive downlink control information (DCI) through the PDCCH. The DCI may include control information such as resource allocation information for the UE. Also, the format of the DCI may vary depending on the intended use. The uplink control information (UCI) that the UE transmits to the base station through UL includes a DL/UL ACK/NACK signal, a channel quality indicator (CQI), a precoding matrix index (PMI), a rank indicator (RI), and the like. Here, the CQI, PMI, and RI may be included in channel state information (CSI). In the 3GPP NR system, the UE may transmit control information such as HARQ-ACK and CSI described above through the PUSCH and/or PUCCH.

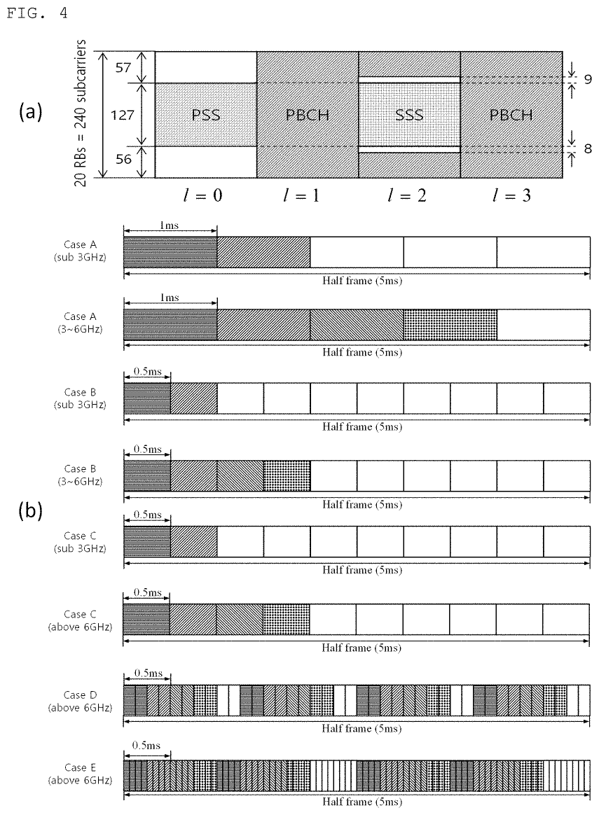

FIGS. 4a and 4b illustrate an SS/PBCH block for initial cell access in a 3GPP NR system. When the power is turned on or wanting to access a new cell, the UE may obtain time and frequency synchronization with the cell and perform an initial cell search procedure. The UE may detect a physical cell identity NcellID of the cell during a cell search procedure. For this, the UE may receive a synchronization signal, for example, a primary synchronization signal (PSS) and a secondary synchronization signal (SSS), from a base station, and synchronize with the base station. In this case, the UE can obtain information such as a cell identity (ID).

Referring to FIGS. 4a and 4b, a synchronization signal (SS) will be described in more detail. The synchronization signal can be classified into PSS and SSS. The PSS may be used to obtain time domain synchronization and/or frequency domain synchronization, such as OFDM symbol synchronization and slot synchronization. The SSS can be used to obtain frame synchronization and cell group ID. Referring to FIG. 4a and Table 2, the SS/PBCH block can be configured with consecutive 20 RBs (=240 subcarriers) in the frequency axis, and can be configured with consecutive 4 OFDM symbols in the time axis. In this case, the PSS is transmitted through 56-182^{th} subcarriers in the SS/PBCH block in the first OFDM symbol, and the SSS is transmitted through 56-182^{th} subcarriers in the third OFDM symbol. Here, the lowest subcarrier index of the SS/PBCH block is numbered from 0. In the first OFDM symbol in which the PSS is transmitted, the base station does not transmit a signal through the remaining subcarriers, i.e., 0th to 55th and 183th to 239th subcarriers. In addition, in the third OFDM symbol in which the SSS is transmitted, the base station does not transmit a signal through 48th to 55th and 183th to 191th subcarriers. The base station transmits a physical broadcast channel (PBCH) through the remaining RE except for the above signal in the SS/PBCH block.

TABLE 2

| | OFDM symbol number l | Subcarrier number k |
|---|---|---|
| Channel | relative to the start | relative to the start |
| or signal | of an SS/PBCH block | of an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 239 |
| | 2 | 48, 49, . . . , 55, 183, 184, . . . , |
| | | 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + v, 4 + v, 8 + v, . . . , 236 + v |
| for | 2 | 0 + v, 4 + v, 8 + v, . . . , 44 + v |
| PBCH | | 192 + v, 196 + v, . . . , 236 + v |

The SS identifies a total of 1008 unique physical layer cell IDs through a combination of three PSSs and SSSs. Specifically, the respective layer cell IDs are grouped into 336 physical-layer cell-identifier groups in which each group includes three unique identifiers so that each physical-layer cell ID is a part of only one physical-layer cell-identifier group. Therefore, the physical layer cell identifier N^{cell}_{ID}=3N⁽¹⁾_{ID}+N⁽²⁾_{ID} may be uniquely defined by a number N⁽¹⁾_{ID} ranging from 0 to 335 indicating a physical-layer cell-identifier group and a number N⁽²⁾_{ID} ranging from 0 to 2 indicating a physical-layer identifier in the physical-layer cell-identifier group. The UE may detect the PSS to identify one of the three unique physical-layer identifiers. In addition, the UE may detect the SSS to identify one of the 336 physical layer cell IDs associated with the physical-layer identifier. In this case, sequence d_{PSS}(n) of the PSS is as follows.

d_{PSS}(n)=1−2x(m)

m=(n+43N_{ID}⁽²⁾)mod 127

0≤n<127

Here x(i+7)=(x(i+4)+x(i))mod 2, and

[x(6) x(5) x(4) x(3) x(2) x(1) x(0)]=[1 1 1 0 1 1 0] is given.

In addition, sequence d_{SSS}(n) of the SSS is as follows.

$${d}_{S S S} ( n ) = [ 1 - 2 {x}_{0} ( ( n + {m}_{0} ) mod 127 ) ] [ 1 - 2 {x}_{1} ( ( n + {m}_{1} ) mod 127 ) ] {m}_{0} = 15 ⌊ \frac{{N}_{I D}^{( 1 )}}{112} ⌋ + 5 {N}_{I D}^{( 2 )} {m}_{1} = {N}_{I D}^{( 1 )} mod 112 \; 0 \leq n < 127$$

Here, x₀(i+7)=(x₀(i+4)+x₀(i))mod 2

x₁(i+7)=(x₁(i+1)+x₁(i))mod 2, and

[x₀(6) x₀(5) x₀(4) x₀(3) x₀(2) x₀(1) x₀(0)]=[0 0 0 0 0 0 1]

[x₁(6) x₁(5) x₁(4) x₁(3) x₁(2) x₁(1) x₁(0)]=[0 0 0 0 0 0 1] is given.

A radio frame with a 10 ms length may be divided into two half frames with a 5 ms length. Referring to FIG. 4(b), a description will be made of a slot in which SS/PBCH blocks are transmitted in each half frame. A slot in which the SS/PBCH block is transmitted may be any one of the cases A, B, C, D, and E. In the case A, the subcarrier spacing is 15 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case B, the subcarrier spacing is 30 kHz and the starting time point of the SS/PBCH block is {4, 8, 16, 20}+28*n. In this case, n=0 at a carrier frequency of 3 GHz or less. In addition, it may be n=0, 1 at carrier frequencies above 3 GHz and below 6 GHz. In the case C, the subcarrier spacing is 30 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case D, the subcarrier spacing is 120 kHz and the starting time point of the SS/PBCH block is the ({4, 8, 16, 20}+28*n)-th symbol. In this case, at a carrier frequency of 6 GHz or more, n=0, 1, 2, 3, 5, 6, 7, 8, 10, 11, 12, 13, 15, 16, 17, 18. In the case E, the subcarrier spacing is 240 kHz and the starting time point of the SS/PBCH block is the ({8, 12, 16, 20, 32, 36, 40, 44}+56*n)-th symbol. In this case, at a carrier frequency of 6 GHz or more, n=0, 1, 2, 3, 5, 6, 7, 8.

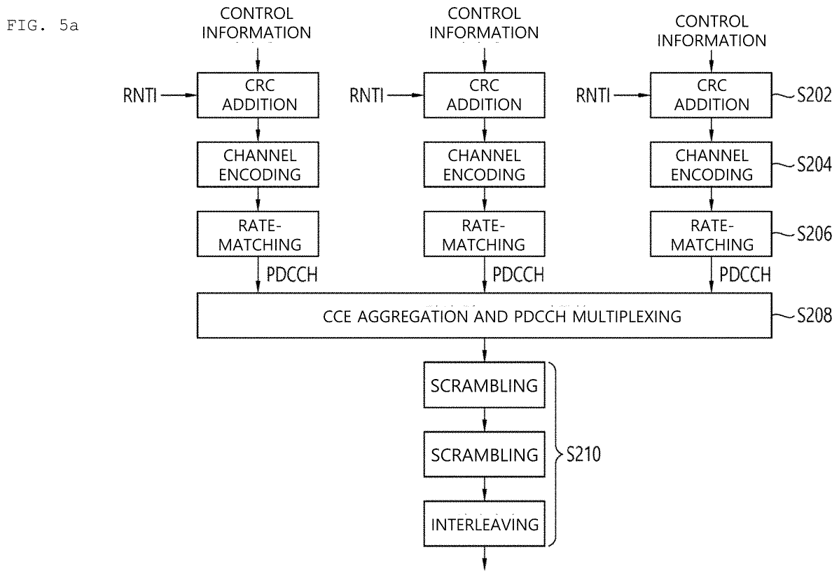

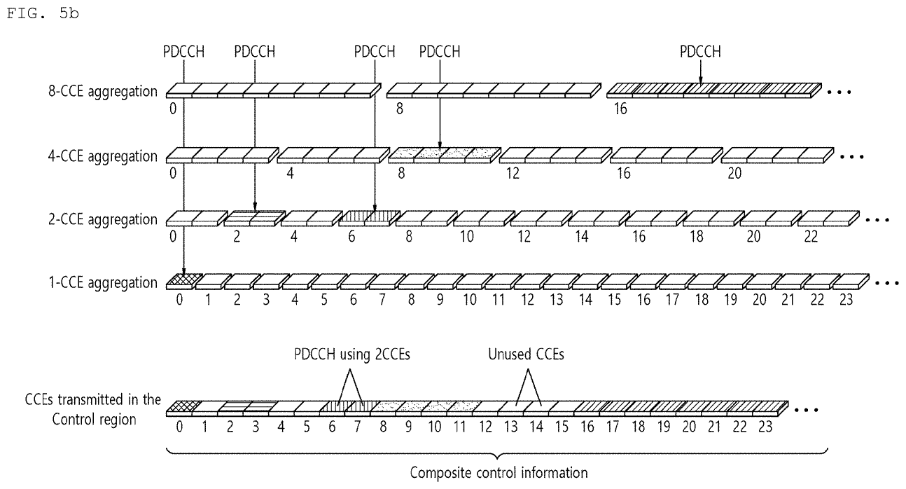

FIGS. 5a and 5b illustrate a procedure for transmitting control information and a control channel in a 3GPP NR system. Referring to FIG. 5a, the base station may add a cyclic redundancy check (CRC) masked (e.g., an XOR operation) with a radio network temporary identifier (RNTI) to control information (e.g., downlink control information (DCI)) (step S202). The base station may scramble the CRC with an RNTI value determined according to the purpose/target of each control information. The common RNTI used by one or more UEs can include at least one of a system information RNTI (SI-RNTI), a paging RNTI (P-RNTI), a random access RNTI (RA-RNTI), and a transmit power control RNTI (TPC-RNTI). In addition, the UE-specific RNTI may include at least one of a cell temporary RNTI (C-RNTI), and the CS-RNTI. Thereafter, the base station may perform rate-matching (step S206) according to the amount of resource(s) used for PDCCH transmission after performing channel encoding (e.g., polar coding) (step S204). Thereafter, the base station may multiplex the DCI(s) based on the control channel element (CCE) based PDCCH structure (step S208).

In addition, the base station may apply an additional process (step S210) such as scrambling, modulation (e.g., QPSK), interleaving, and the like to the multiplexed DCI(s), and then map the DCI(s) to the resource to be transmitted. The CCE is a basic resource unit for the PDCCH, and one CCE may include a plurality (e.g., six) of resource element groups (REGs). One REG may be configured with a plurality (e.g., 12) of REs. The number of CCEs used for one PDCCH may be defined as an aggregation level. In the 3GPP NR system, an aggregation level of 1, 2, 4, 8, or 16 may be used. FIG. 5b is a diagram related to a CCE aggregation level and the multiplexing of a PDCCH and illustrates the type of a CCE aggregation level used for one PDCCH and CCE(s) transmitted in the control area according thereto.

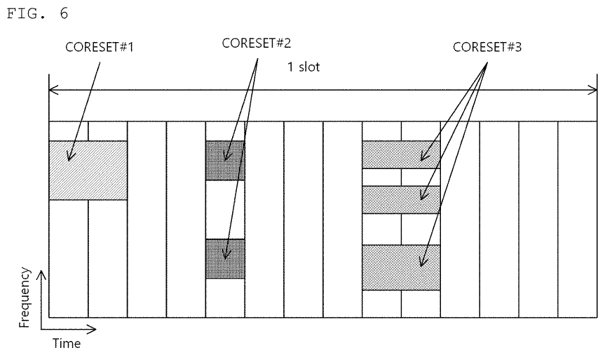

FIG. 6 illustrates a control resource set (CORESET) in which a physical downlink control channel (PUCCH) may be transmitted in a 3GPP NR system. The CORESET is a time-frequency resource in which PDCCH, that is, a control signal for the UE, is transmitted. In addition, a search space to be described later may be mapped to one CORESET. Therefore, the UE may monitor the time-frequency domain designated as CORESET instead of monitoring all frequency bands for PDCCH reception, and decode the PDCCH mapped to CORESET. The base station may configure one or more CORESETs for each cell to the UE. The CORESET may be configured with up to three consecutive symbols on the time axis. In addition, the CORESET may be configured in units of six consecutive PRBs on the frequency axis. In the embodiment of FIG. 5, CORESET #1 is configured with consecutive PRBs, and CORESET #2 and CORESET #3 are configured with discontinuous PRBs. The CORESET can be located in any symbol in the slot. For example, in the embodiment of FIG. 5, CORESET #1 starts at the first symbol of the slot, CORESET #2 starts at the fifth symbol of the slot, and CORESET #9 starts at the ninth symbol of the slot.

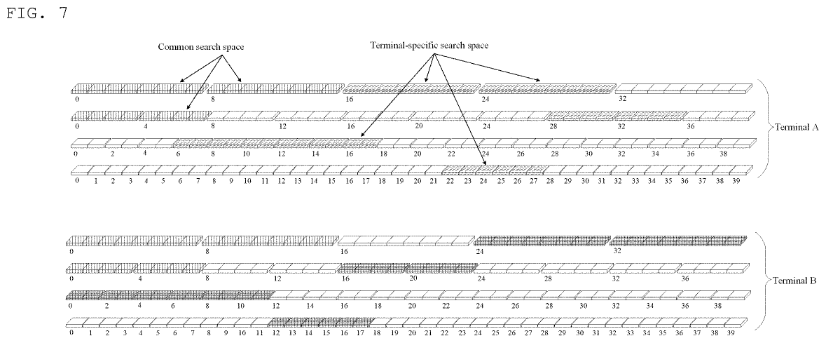

FIG. 7 illustrates a method for setting a PUCCH search space in a 3GPP NR system. In order to transmit the PDCCH to the UE, each CORESET may have at least one search space. In the embodiment of the present disclosure, the search space is a set of all time-frequency resources (hereinafter, PDCCH candidates) through which the PDCCH of the UE is capable of being transmitted. The search space may include a common search space that the UE of the 3GPP NR is required to commonly search and a UE-specific or a UE-specific search space that a specific UE is required to search. In the common search space, UE may monitor the PDCCH that is set so that all UEs in the cell belonging to the same base station commonly search. In addition, the UE-specific search space may be set for each UE so that UEs monitor the PDCCH allocated to each UE at different search space position according to the UE. In the case of the UE-specific search space, the search space between the UEs may be partially overlapped and allocated due to the limited control area in which the PDCCH may be allocated. Monitoring the PDCCH includes blind decoding for PDCCH candidates in the search space. When the blind decoding is successful, it may be expressed that the PDCCH is (successfully) detected/received and when the blind decoding fails, it may be expressed that the PDCCH is not detected/not received, or is not successfully detected/received.

For convenience of explanation, a PDCCH scrambled with a group common (GC) RNTI previously known to one or more UEs so as to transmit DL control information to the one or more UEs is referred to as a group common (GC) PDCCH or a common PDCCH. In addition, a PDCCH scrambled with a specific-terminal RNTI that a specific UE already knows so as to transmit UL scheduling information or DL scheduling information to the specific UE is referred to as a specific-UE PDCCH. The common PDCCH may be included in a common search space, and the UE-specific PDCCH may be included in a common search space or a UE-specific PDCCH.

The base station may signal each UE or UE group through a PDCCH about information (i.e., DL Grant) related to resource allocation of a paging channel (PCH) and a downlink-shared channel (DL-SCH) that are a transmission channel or information (i.e., UL grant) related to resource allocation of a uplink-shared channel (UL-SCH) and a hybrid automatic repeat request (HARD). The base station may transmit the PCH transport block and the DL-SCH transport block through the PDSCH. The base station may transmit data excluding specific control information or specific service data through the PDSCH. In addition, the UE may receive data excluding specific control information or specific service data through the PDSCH.

The base station may include, in the PDCCH, information on to which UE (one or a plurality of UEs) PDSCH data is transmitted and how the PDSCH data is to be received and decoded by the corresponding UE, and transmit the PDCCH. For example, it is assumed that the DCI transmitted on a specific PDCCH is CRC masked with an RNTI of “A”, and the DCI indicates that PDSCH is allocated to a radio resource (e.g., frequency location) of “B” and indicates transmission format information (e.g., transport block size, modulation scheme, coding information, etc.) of “C”. The UE monitors the PDCCH using the RNTI information that the UE has. In this case, if there is a UE which performs blind decoding the PDCCH using the “A” RNTI, the UE receives the PDCCH, and receives the PDSCH indicated by “B” and “C” through the received PDCCH information.

Table 3 shows an embodiment of a physical uplink control channel (PUCCH) used in a wireless communication system.

TABLE 3

| PUCCH format | Length in OFDM symbols | Number of bits |
|---|---|---|
| 0 | 1-2 | ≤2 |
| 1 | 4-14 | ≤2 |
| 2 | 1-2 | >2 |
| 3 | 4-14 | >2 |
| 4 | 4-14 | >2 |

The PUCCH may be used to transmit the following UL control information (UCI).
Scheduling Request (SR): Information used for requesting a UL UL-SCH resource.
HARQ-ACK: A Response to PDCCH (indicating DL SPS release) and/or a response to DL transport block (TB) on PDSCH. HARQ-ACK indicates whether information successfully transmitted on the PDCCH or PDSCH is received. The HARQ-ACK response includes positive ACK (simply ACK), negative ACK (hereinafter NACK), Discontinuous Transmission (DTX), or NACK/DTX. Here, the term HARQ-ACK is used mixed with HARQ-ACK/NACK and ACK/NACK. In general, ACK may be represented by bit value 1 and NACK may be represented by bit value 0.
Channel State Information (CSI): Feedback information on the DL channel. The UE generates it based on the CSI-Reference Signal (RS) transmitted by the base station. Multiple Input Multiple Output (MIMO)-related feedback information includes a Rank Indicator (RI) and a Precoding Matrix Indicator (PMI). CSI can be divided into CSI part 1 and CSI part 2 according to the information indicated by CSI.

In the 3GPP NR system, five PUCCH formats may be used to support various service scenarios, various channel environments, and frame structures.

PUCCH format 0 is a format capable of delivering 1-bit or 2-bit HARQ-ACK information or SR. PUCCH format 0 may be transmitted through one or two OFDM symbols on the time axis and one PRB on the frequency axis. When PUCCH format 0 is transmitted in two OFDM symbols, the same sequence on the two symbols may be transmitted through different RBs. Accordingly, the UE may obtain a frequency diversity gain. More specifically, the UE may determine a value mcs of a cyclic shift according to M_{bit} bit UCI (M_{bi t}=1 or 2), map a sequence obtained by cyclic shifting a base sequence having the length of 12 to a predetermined value mcs to 12 REs of one PRB and one OFDM symbol, and transmit the same. When the number of cyclic shifts usable by the UE is 12 and M_{bit}=1, 1-bit UCI 0 and 1 may be indicated as two cyclic shifted sequences having a difference of 6 in the cyclic shift value, respectively. In addition, when M_{bit}=2, 2-bit UCI 00, 01, 11, and 10 may be indicated as four cyclic shifted sequences having a difference of 3 in cyclic shift values, respectively.

PUCCH format 1 may deliver 1-bit or 2-bit HARQ-ACK information or SR. PUCCH format 1 may be transmitted through consecutive OFDM symbols on the time axis and one PRB on the frequency axis. Here, the number of OFDM symbols occupied by PUCCH format 1 may be one of 4 to 14. More specifically, UCI, in which M_{bit}=1, may be BPSK-modulated. The UE may modulate UCI, in which M_{bit}=2, with quadrature phase shift keying (QPSK). A signal is obtained by multiplying a modulated complex valued symbol d(0) by a sequence of length 12. The UE spreads the even-numbered OFDM symbols to which PUCCH format 1 is allocated through a time axis orthogonal cover code (OCC) to transmit the obtained signal. PUCCH format 1 determines the maximum number of different UEs multiplexed in the same RB according to the length of the OCC to be used. A demodulation reference signal (DMRS) may be spread with OCC and mapped to the odd-numbered OFDM symbols of PUCCH format 1.

PUCCH format 2 may deliver UCI exceeding 2 bits. PUCCH format 2 may be transmitted through one or two OFDM symbols on the time axis and one or multiple RBs on the frequency axis. When PUCCH format 2 is transmitted in two OFDM symbols, the same sequence may be transmitted in different RBs through two OFDM symbols. Accordingly, the UE may obtain a frequency diversity gain. More specifically, M_{bit} bit UCI (M_{bit}>2) is bit-level scrambled, QPSK modulated, and mapped to RB(s) of one or two OFDM symbol(s). Here, the number of RBs may be one of 1 to 16.

PUCCH format 3 or PUCCH format 4 may deliver UCI exceeding 2 bits. PUCCH format 3 or PUCCH format 4 may be transmitted through consecutive OFDM symbols on the time axis and one PRB on the frequency axis. The number of OFDM symbols occupied by PUCCH format 3 or PUCCH format 4 may be one of 4 to 14. Specifically, the UE modulates Mbit bits UCI (Mbit>2) with π/2-Binary Phase Shift Keying (BPSK) or QPSK to generate a complex valued symbol d(0) to d(Msymb−1). Here, when using n/2-BPSK, Msymb=Mbit, and when using QPSK, Msymb=Mbit/2. The UE may not apply block-unit spreading to the PUCCH format 3. However, the UE may apply block-unit spreading to one RB (i.e., 12 subcarriers) using PreDFT-OCC of a length of 12 such that PUCCH format 4 may have two or four multiplexing capacities. The UE performs transmit precoding (or DFT-precoding) on the spread signal and maps it to each RE to transmit the spread signal.

In this case, the number of RBs occupied by PUCCH format 2, PUCCH format 3, or PUCCH format 4 may be determined according to the length and maximum code rate of the UCI transmitted by the UE. When the UE uses PUCCH format 2, the UE may transmit HARQ-ACK information and CSI information together through the PUCCH. When the number of RBs that the UE may transmit is greater than the maximum number of RBs that PUCCH format 2, or PUCCH format 3, or PUCCH format 4 may use, the UE may transmit only the remaining UCI information without transmitting some UCI information according to the priority of the UCI information.

PUCCH format 1, PUCCH format 3, or PUCCH format 4 may be configured through the RRC signal to indicate frequency hopping in a slot. When frequency hopping is configured, the index of the RB to be frequency hopped may be configured with an RRC signal. When PUCCH format 1, PUCCH format 3, or PUCCH format 4 is transmitted through N OFDM symbols on the time axis, the first hop may have floor (N/2) OFDM symbols and the second hop may have ceiling(N/2) OFDM symbols.

PUCCH format 1, PUCCH format 3, or PUCCH format 4 may be configured to be repeatedly transmitted in a plurality of slots. In this case, the number K of slots in which the PUCCH is repeatedly transmitted may be configured by the RRC signal. The repeatedly transmitted PUCCHs must start at an OFDM symbol of the constant position in each slot, and have the constant length. When one OFDM symbol among OFDM symbols of a slot in which a UE should transmit a PUCCH is indicated as a DL symbol by an RRC signal, the UE may not transmit the PUCCH in a corresponding slot and delay the transmission of the PUCCH to the next slot to transmit the PUCCH.

Meanwhile, in the 3GPP NR system, a UE may perform transmission/reception using a bandwidth equal to or less than the bandwidth of a carrier (or cell). For this, the UE may receive the Bandwidth part (BWP) configured with a continuous bandwidth of some of the carrier's bandwidth. A UE operating according to TDD or operating in an unpaired spectrum can receive up to four DL/UL BWP pairs in one carrier (or cell). In addition, the UE may activate one DL/UL BWP pair. A UE operating according to FDD or operating in paired spectrum can receive up to four DL BWPs on a DL carrier (or cell) and up to four UL BWPs on a UL carrier (or cell). The UE may activate one DL BWP and one UL BWP for each carrier (or cell). The UE may not perform reception or transmission in a time-frequency resource other than the activated BWP. The activated BWP may be referred to as an active BWP.

The base station may indicate the activated BWP among the BWPs configured by the UE through downlink control information (DCI). The BWP indicated through the DCI is activated and the other configured BWP(s) are deactivated. In a carrier (or cell) operating in TDD, the base station may include, in the DCI for scheduling a PDSCH or a PUSCH, a bandwidth part indicator (BPI) indicating the BWP to be activated, so as to change a DL/UL BWP pair of the UE. The UE may receive the DCI for scheduling the PDSCH or PUSCH and may identify the DL/UL BWP pair activated based on the BPI. For a DL carrier (or cell) operating in an FDD, the base station may include, in the DCI for scheduling a PDSCH, a BPI indicating the BWP to be activated, so as to change the DL BWP of the UE. For a UL carrier (or cell) operating in an FDD, the base station may include, in the DCI for scheduling a PUSCH, a BPI indicating the BWP to be activated, so as to change the UL BWP of the UE.

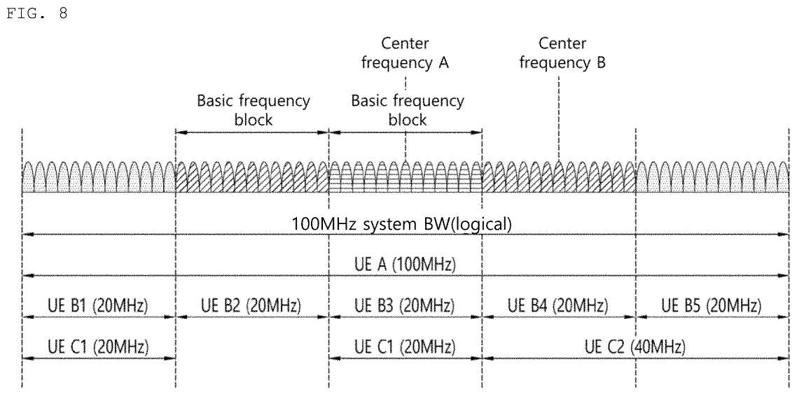

FIG. 8 is a conceptual diagram illustrating carrier aggregation. The carrier aggregation means a method in which the UE uses multiple frequency blocks or cells (in the logical sense) including UL resources (or component carriers) and/or DL resources (or component carriers) as one large logical frequency band in order for a wireless communication system to use a wider frequency band. Hereinafter, for convenience of description, the terms are unified by using the term “component carrier”.

Referring to FIG. 8, as an example of a 3GPP NR system, the entire system band may include up to 16 component carriers, and each component carrier may have a bandwidth of up to 400 MHz. The component carrier may include one or more physically consecutive subcarriers. Although it is shown in FIG. 8 that each of the component carriers has the same bandwidth, this is merely an example, and each component carrier may have a different bandwidth. Also, although each component carrier is shown as being adjacent to each other in the frequency axis, the drawings are shown in a logical concept, and each component carrier may be physically adjacent to one another, or may be spaced apart.

Different center frequencies may be used for each component carrier. Also, one common center frequency may be used in physically adjacent component carriers. Assuming that all the component carriers are physically adjacent in the embodiment of FIG. 8, center frequency A may be used in all the component carriers. Further, assuming that the respective component carriers are not physically adjacent to each other, center frequency A and the center frequency B can be used in each of the component carriers.

When the total system band is extended by carrier aggregation, the frequency band used for communication with each UE can be defined in units of a component carrier. UE A may use 100 MHz, which is the total system band, and performs communication using all five component carriers. UEs B1˜B5 can use only a 20 MHz bandwidth and perform communication using one component carrier. UEs C1 and C2 may use a 40 MHz bandwidth and perform communication using two component carriers, respectively. The two component carriers may be logically/physically adjacent or non-adjacent. UE C1 represents the case of using two non-adjacent component carriers, and UE C2 represents the case of using two adjacent component carriers.

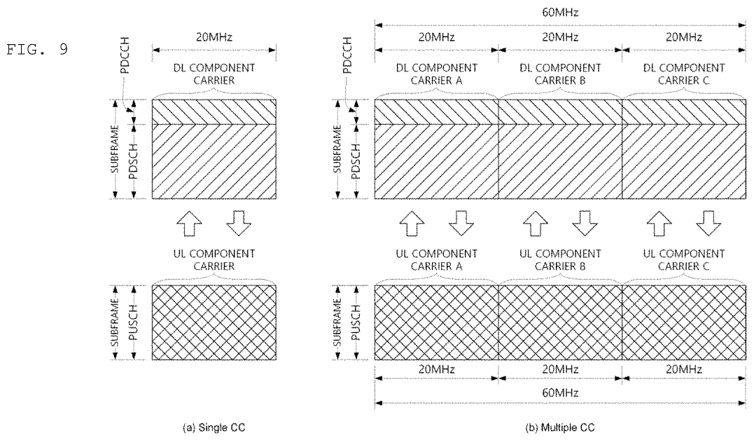

FIG. 9 is a drawing for explaining single carrier communication and multiple carrier communication. Particularly, FIG. 9(a) shows a single carrier subframe structure and FIG. 9(b) shows a multi-carrier subframe structure.

Referring to FIG. 9(a), in an FDD mode, a general wireless communication system may perform data transmission or reception through one DL band and one UL band corresponding thereto. In another specific embodiment, in a TDD mode, the wireless communication system may divide a radio frame into a UL time unit and a DL time unit in a time domain, and perform data transmission or reception through a UL/DL time unit. Referring to FIG. 9(b), three 20 MHz component carriers (CCs) can be aggregated into each of UL and DL, so that a bandwidth of 60 MHz can be supported. Each CC may be adjacent or non-adjacent to one another in the frequency domain. FIG. 9(b) shows a case where the bandwidth of the UL CC and the bandwidth of the DL CC are the same and symmetric, but the bandwidth of each CC can be determined independently. In addition, asymmetric carrier aggregation with different number of UL CCs and DL CCs is possible. A DL/UL CC allocated/configured to a specific UE through RRC may be called as a serving DL/UL CC of the specific UE.

The base station may perform communication with the UE by activating some or all of the serving CCs of the UE or deactivating some CCs. The base station can change the CC to be activated/deactivated, and change the number of CCs to be activated/deactivated. If the base station allocates a CC available for the UE as to be cell-specific or UE-specific, at least one of the allocated CCs can be deactivated, unless the CC allocation for the UE is completely reconfigured or the UE is handed over. One CC that is not deactivated by the UE is called as a Primary CC (PCC) or a primary cell (PCell), and a CC that the base station can freely activate/deactivate is called as a Secondary CC (SCC) or a secondary cell (SCell).

Meanwhile, 3GPP NR uses the concept of a cell to manage radio resources. A cell is defined as a combination of DL resources and UL resources, that is, a combination of DL CC and UL CC. A cell may be configured with DL resources alone, or a combination of DL resources and UL resources. When the carrier aggregation is supported, the linkage between the carrier frequency of the DL resource (or DL CC) and the carrier frequency of the UL resource (or UL CC) may be indicated by system information. The carrier frequency refers to the center frequency of each cell or CC. A cell corresponding to the PCC is referred to as a PCell, and a cell corresponding to the SCC is referred to as an SCell. The carrier corresponding to the PCell in the DL is the DL PCC, and the carrier corresponding to the PCell in the UL is the UL PCC. Similarly, the carrier corresponding to the SCell in the DL is the DL SCC and the carrier corresponding to the SCell in the UL is the UL SCC. According to UE capability, the serving cell(s) may be configured with one PCell and zero or more SCells. In the case of UEs that are in the RRC CONNECTED state but not configured for carrier aggregation or that do not support carrier aggregation, there is only one serving cell configured only with PCell.

As mentioned above, the term “cell” used in carrier aggregation is distinguished from the term “cell” which refers to a predetermined geographical area in which a communication service is provided by one base station or one antenna group. In order to distinguish between a cell referring to a predetermined geographical area and a cell of carrier aggregation, in the disclosure, a cell of a carrier aggregation is referred to as a CC, and a cell of a geographical area is referred to as a cell.

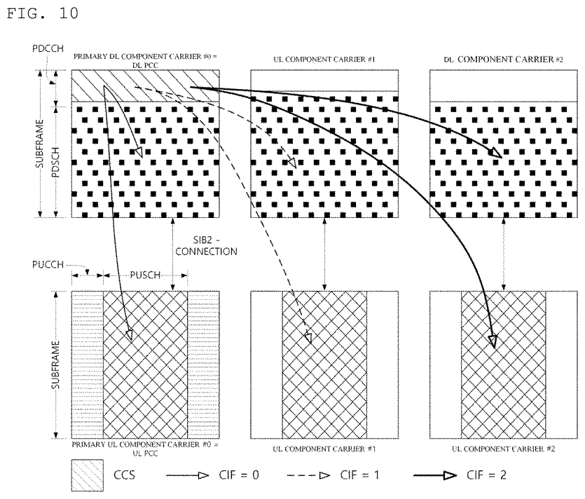

FIG. 10 is a diagram showing an example in which a cross carrier scheduling technique is applied. When cross carrier scheduling is set, the control channel transmitted through the first CC may schedule a data channel transmitted through the first CC or the second CC using a carrier indicator field (CIF). The CIF is included in the DCI. In other words, a scheduling cell is set, and the DL grant/UL grant transmitted in the PDCCH area of the scheduling cell schedules the PDSCH/PUSCH of the scheduled cell. That is, a search area for the plurality of component carriers exists in the PDCCH area of the scheduling cell. A PCell may be basically a scheduling cell, and a specific SCell may be designated as a scheduling cell by an upper layer.

In the embodiment of FIG. 10, it is assumed that three DL CCs are merged. Here, it is assumed that DL component carrier #0 is DL PCC (or PCell), and DL component carrier #1 and DL component carrier #2 are DL SCCs (or SCell). In addition, it is assumed that the DL PCC is set to the PDCCH monitoring CC. When cross-carrier scheduling is not configured by UE-specific (or UE-group-specific or cell-specific) higher layer signaling, a CIF is disabled, and each DL CC can transmit only a PDCCH for scheduling its PDSCH without the CIF according to an NR PDCCH rule (non-cross-carrier scheduling, self-carrier scheduling). Meanwhile, if cross-carrier scheduling is configured by UE-specific (or UE-group-specific or cell-specific) higher layer signaling, a CIF is enabled, and a specific CC (e.g., DL PCC) may transmit not only the PDCCH for scheduling the PDSCH of the DL CC A using the CIF but also the PDCCH for scheduling the PDSCH of another CC (cross-carrier scheduling). On the other hand, a PDCCH is not transmitted in another DL CC. Accordingly, the UE monitors the PDCCH not including the CIF to receive a self-carrier scheduled PDSCH depending on whether the cross-carrier scheduling is configured for the UE, or monitors the PDCCH including the CIF to receive the cross-carrier scheduled PDSCH.

On the other hand, FIGS. 9 and 10 illustrate the subframe structure of the 3GPP LTE-A system, and the same or similar configuration may be applied to the 3GPP NR system. However, in the 3GPP NR system, the subframes of FIGS. 9 and 10 may be replaced with slots.

<Communication Method in Unlicensed Band>

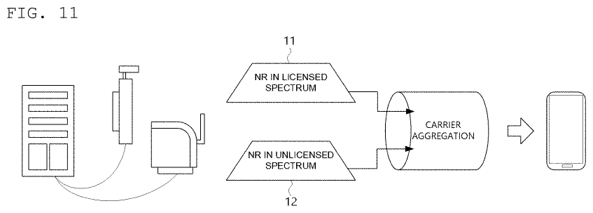

FIG. 11 illustrates a New Radio-Unlicensed (NR-U) service environment.

Referring to FIG. 11, a service environment in which NR technology 11 in the existing licensed band and NR-Unlicensed (NR-U), i.e., NR technology 12 in the unlicensed band may be provide to the user. For example, in the NR-U environment, NR technology 11 in the licensed band and the NR technology 12 in the unlicensed band may be integrated using technologies such as carrier aggregation which may contribute to network capacity expansion. In addition, in an asymmetric traffic structure with more downlink data than uplink data, NR-U can provide an NR service optimized for various needs or environments. For convenience, the NR technology in the licensed band is referred to as NR-L (NR-Licensed), and the NR technology in the unlicensed band is referred to as NR-U (NR-Unlicensed).

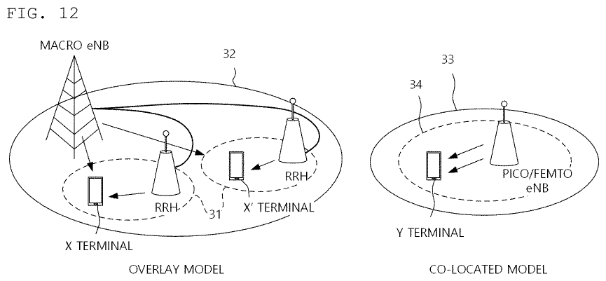

FIG. 12 illustrates a deployment scenario of a user equipment and a base station in an NR-U service environment. A frequency band targeted by the NR-U service environment has short radio communication range due to the high frequency characteristics. Considering this, the deployment scenario of the user equipment and the base station may be an overlay model or a co-located model in an environment in which coexist the existing NR-L service and NR-U service.

In the overlay model, a macro base station may perform wireless communication with UE X and UE X′ in a macro area (32) by using a licensed carrier, and may be connected with multiple radio remote heads (RRHs) through an X2 interface. Each RRH may perform wireless communication with UE X or UE X′ in a predetermined area (31) by using an unlicensed carrier. The frequency bands of the macro base station and the RRH are different from each other and have no interference with each other, but data needs to be promptly exchanged between the macro base station and the RRH through the X2 interface in order to use the NR-U service as an auxiliary downlink channel of the NR-L service through the carrier aggregation.

In the co-located model, a pico/femto base station may perform the wireless communication with a Y UE by using both the licensed carrier and the unlicensed carrier. However, it may be limited that the pico/femto base station uses both the NR-L service and the NR-U service to downlink transmission. A coverage (33) of the NR-L service and a coverage (34) of the NR-U service may be different according to the frequency band, transmission power, and the like.

When NR communication is performed in the unlicensed band, conventional equipments (e.g., wireless LAN (Wi-Fi) equipments) which perform communication in the corresponding unlicensed band may not demodulate an NR-U message or data. Therefore, conventional equipments determine the NR-U message or data as a kind of energy to perform an interference avoidance operation by an energy detection technique. That is, when energy corresponding to the NR-U message or data is lower than −62 dBm or certain energy detection (ED) threshold value, the wireless LAN equipments may perform communication by disregarding the corresponding message or data. As a result, that user equipment which performs the NR communication in the unlicensed band may be frequently interfered by the wireless LAN equipments.

Therefore, a specific frequency band needs to be allocated or reserved for a specific time in order to effectively implement an NR-U technology/service. However, since peripheral equipments which perform communication through the unlicensed band attempt access based on the energy detection technique, there is a problem in that an efficient NR-U service is difficult. Therefore, a research into a coexistence scheme with the conventional unlicensed band device and a scheme for efficiently sharing a radio channel needs to be preferentially made in order to settle the NR-U technology. That is, a robust coexistence mechanism in which the NR-U device does not influence the conventional unlicensed band device needs to be developed.

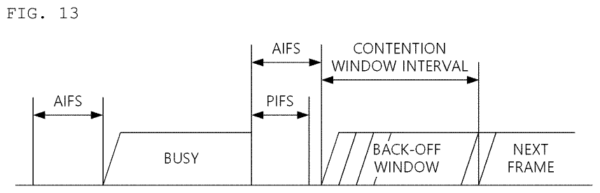

FIG. 13 illustrates a conventional communication scheme (e.g., wireless LAN) operating in an unlicensed band. Since most devices that operate in the unlicensed band operate based on listen-before-talk (LBT), a clear channel assessment (CCA) technique that senses a channel before data transmission is performed.

Referring to FIG. 13, a wireless LAN device (e.g., AP or STA) checks whether the channel is busy by performing carrier sensing before transmitting data. When a predetermined strength or more of radio signal is sensed in a channel to transmit data, it is determined that the corresponding channel is busy and the wireless LAN device delays the access to the corresponding channel. Such a process is referred to as clear channel evaluation and a signal level to decide whether the signal is sensed is referred to as a CCA threshold. Meanwhile, when the radio signal is not sensed in the corresponding channel or a radio signal having a strength smaller than the CCA threshold is sensed, it is determined that the channel is idle.

When it is determined that the channel is idle, a terminal having data to be transmitted performs a backoff procedure after a defer duration (e.g., arbitration interframe space (AIFS), PCF IFS (PIFS), or the like). The defer duration represents a minimum time when the terminal needs to wait after the channel is idle. The backoff procedure allows the terminal to further wait for a predetermined time after the defer duration. For example, the terminal stands by while decreasing a slot time for slot times corresponding to a random number allocated to the terminal in the contention window (CW) during the channel is idle, and a terminal that completely exhausts the slot time may attempt to access the corresponding channel.

When the terminal successfully accesses the channel, the terminal may transmit data through the channel. When the data is successfully transmitted, a CW size (CWS) is reset to an initial value (CWmin). On the contrary, when the data is unsuccessfully transmitted, the CWS increases twice. As a result, the terminal is allocated with a new random number within a range which is twice larger than a previous random number range to perform the backoff procedure in a next CW. In the wireless LAN, only an ACK is defined as receiving response information to the data transmission. Therefore, when the ACK is received with respect to the data transmission, the CWS is reset to the initial value and when feed-back information is not received with respect to the data transmission, the CWS increases twice.

As described above, since the existing communication in the unlicensed band mostly operates based on LBT, a channel access in the NR-U system also performs LBT for coexistence with existing devices. Specifically, the channel access method on the unlicensed band in the NR may be classified into the following four categories according to the presence/absence of LBT/application method.
Category 1: No LBT
   The Tx entity does not perform the LBT procedure for transmission.
Category 2: LBT without Random Backoff
   The Tx entity senses whether a channel is idle during a first interval without random backoff to perform a transmission. That is, the Tx entity may perform a transmission through the channel immediately after the channel is sensed to be idle during the first interval. The first interval is an interval of a predetermined length immediately before the Tx entity performs the transmission. According to an embodiment, the first interval may be an interval of 25 μs length, but the present disclosure is not limited thereto.
Category 3: LBT Performing Random Backoff Using CW of Fixed Size
   The Tx entity obtains a random value within the CW of the fixed size, sets it to an initial value of a backoff counter (or backoff timer) N, and performs backoff by using the set backoff counter N. That is, in the backoff procedure, the Tx entity decreases the backoff counter by 1 whenever the channel is sensed to be idle for a predetermined slot period. Here, the predetermined slot period may be 9 μs, but the present disclosure is not limited thereto. The backoff counter N is decreased by 1 from the initial value, and when the value of the backoff counter N reaches 0, the Tx entity may perform the transmission. Meanwhile, in order to perform backoff, the Tx entity first senses whether the channel is idle during a second interval (that is, a defer duration Td). According to an embodiment of the present disclosure, the Tx entity may sense (determine) whether the channel is idle during the second interval, according to whether the channel is idle for at least some period (e.g., one slot period) within the second interval. The second interval may be set based on the channel access priority class of the Tx entity, and consists of a period of 16 us and m consecutive slot periods. Here, m is a value set according to the channel access priority class. The Tx entity performs channel sensing to decrease the backoff counter when the channel is sensed to be idle during the second interval. On the other hand, when the channel is sensed to be busy during the backoff procedure, the backoff procedure is stopped. After stopping the backoff procedure, the Tx entity may resume backoff when the channel is sensed to be idle for an additional second interval. In this way, the Tx entity may perform the transmission when the channel is idle during the slot period of the backoff counter N, in addition to the second interval. In this case, the initial value of the backoff counter N is obtained within the CW of the fixed size.
Category 4: LBT Performing Random Backoff by Using CW of Variable Size
   The Tx entity obtains a random value within the CW of a variable size, sets the random value to an initial value of a backoff counter (or backoff timer) N, and performs backoff by using the set backoff counter N. More specifically, the Tx entity may adjust the size of the CW based on HARQ-ACK information for the previous transmission, and the initial value of the backoff counter N is obtained within the CW of the adjusted size. A specific process of performing backoff by the Tx entity is as described in Category 3. The Tx entity may perform the transmission when the channel is idle during the slot period of the backoff counter N, in addition to the second interval. In this case, the initial value of the backoff counter N is obtained within the CW of the variable size.

In the above Category 1 to Category 4, the Tx entity may be a base station or a UE. According to an embodiment of the present disclosure, a first type channel access may refer to a Category 4 channel access, and a second type channel access may refer to a Category 2 channel access.

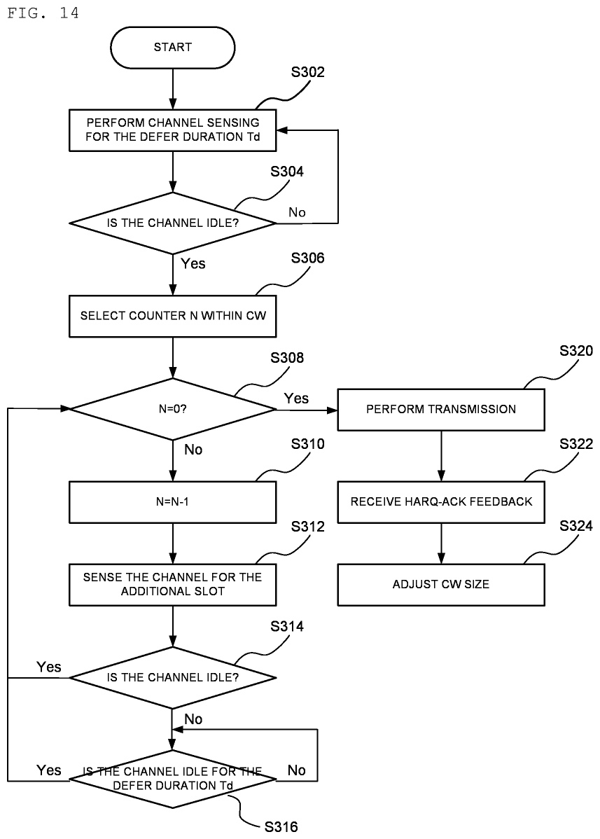

FIG. 14 illustrates a channel access procedure based on Category 4 LBT according to an embodiment of the present disclosure.

Referring to FIG. 14, in order to perform the channel access, first, the Tx entity performs channel sensing for the defer duration Td (step S302). According to an embodiment of the present disclosure, the channel sensing for a defer duration Td in step S302 may be performed through channel sensing for at least a portion of the defer duration Td. For example, the channel sensing for the defer duration Td may be performed through the channel sensing during one slot period within the defer duration Td. The Tx entity checks whether the channel is idle through the channel sensing for the defer duration Td (step S304). If the channel is sensed to be idle for the defer duration Td, the Tx entity proceeds to step S306. If the channel is not sensed to be idle for the defer duration Td (that is, sensed to be busy), the Tx entity returns to step S302. The Tx entity repeats steps S302 to S304 until the channel is sensed to be idle for the defer duration Td. The defer duration Td may be set based on the channel access priority class of the Tx entity, and consists of a period of 16 μs and m consecutive slot periods. Here, m is a value set according to the channel access priority class.

Next, the Tx entity obtains a random value within a predetermined CW, sets the random value to the initial value of the backoff counter (or backoff timer) N (step S306), and proceeds to step S308. The initial value of the backoff counter N is randomly selected from values between 0 and CW. The Tx entity performs the backoff procedure by using the set backoff counter N. That is, the Tx entity performs the backoff procedure by repeating steps S308 to S316 until the value of the backoff counter N reaches 0. Meanwhile, FIG. 14 illustrates that step S306 is performed after the channel is sensed to be idle for the defer duration Td, but the present disclosure is not limited thereto. That is, step S306 may be performed independently of steps S302 to S304, and may be performed prior to steps S302 to S304. When step S306 is performed prior to steps S302 to S304, if the channel is sensed to be idle for the defer duration Td by steps S302 to S304, the Tx entity proceeds to step S308.

In step S308, the Tx entity checks whether the value of the backoff counter N is 0. If the value of the backoff counter N is 0, the Tx entity proceeds to step S320 to perform a transmission. If the value of the backoff counter N is not 0, the Tx entity proceeds to step S310. In step S310, the Tx entity decreases the value of the backoff counter N by 1. According to an embodiment, the Tx entity may selectively decrease the value of the backoff counter by 1 in the channel sensing process for each slot. In this case, step S310 may be skipped at least once by the selection of the Tx entity. Next, the Tx entity performs channel sensing for an additional slot period (step S312). The Tx entity checks whether the channel is idle through the channel sensing for the additional slot period (step S314). If the channel is sensed to be idle for the additional slot period, the Tx entity returns to step S308. In this way, the Tx entity may decrease the backoff counter by 1 whenever the channel is sensed to be idle for a predetermined slot period. Here, the predetermined slot period may be 9 μs, but the present disclosure is not limited thereto.

In step S314, if the channel is not sensed to be idle for the additional slot period (that is, sensed to be busy), the Tx entity proceeds to step S316. In step S316, the Tx entity checks whether the channel is idle for the additional defer duration Td. According to an embodiment of the present disclosure, the channel sensing in step S316 may be performed in units of slots. That is, the Tx entity checks whether the channel is sensed to be idle during all slot periods of the additional defer duration Td. When the busy slot is detected within the additional defer duration Td, the Tx entity immediately restarts step S316. When the channel is sensed to be idle during all slot periods of the additional defer duration Td, the Tx entity returns to step S308.

On the other hand, if the value of the backoff counter N is 0 in the check of step S308, the Tx entity performs the transmission (step S320). The Tx entity receives a HARQ-ACK feedback corresponding to the transmission (step S322). The Tx entity may check whether the previous transmission is successful through the received HARQ-ACK feedback. Next, the Tx entity adjusts the CW size for the next transmission based on the received HARQ-ACK feedback (step S324).

As described above, after the channel is sensed to be idle for the defer duration Td, the Tx entity may perform the transmission when the channel is idle for N additional slot periods. As described above, the Tx entity may be a base station or a UE, and the channel access procedure of FIG. 14 may be used for downlink transmission of the base station and/or uplink transmission of the UE.

Hereinafter, a method for adaptively adjusting a CWS when accessing a channel in an unlicensed band is presented. The CWS may be adjusted based on UE (User Equipment) feedback, and UE feedback used for CWS adjustment may include the HARQ-ACK feedback and CQI/PMI/RI. In the present disclosure, a method for adaptively adjusting a CWS based on the HARQ-ACK feedback is presented. The HARQ-ACK feedback includes at least one of ACK, NACK, DTX, and NACK/DTX.

As described above, the CWS is adjusted based on ACK even in a wireless LAN system. When the ACK feedback is received, the CWS is reset to the minimum value (CWmin), and when the ACK feedback is not received, the CWS is increased. However, in a cellular system, a CWS adjustment method in consideration of multiple access is required. First, terms are defined as follows.
Set of HARQ-ACK feedback values (i.e., HARQ-ACK feedback set): refers to HARQ-ACK feedback value(s) used for CWS update/adjustment. The HARQ-ACK feedback set is decoded at a time when the CWS is determined and corresponds to available HARQ-ACK feedback values. The HARQ-ACK feedback set includes HARQ-ACK feedback value(s) for one or more DL (channel) transmissions (e.g., PDSCH) on an unlicensed band carrier (e.g., Scell, NR-U cell). The HARQ-ACK feedback set may include HARQ-ACK feedback value(s) for a DL (channel) transmission (e.g., PDSCH), for example, a plurality of HARQ-ACK feedback values fed back from a plurality of UEs. The HARQ-ACK feedback value may indicate reception response information for the code block group (CBG) or the transport block (TB), and may indicate any one of ACK, NACK, DTX, or NACK/DTX. Depending on the context, the HARQ-ACK feedback value may be mixed with terms such as a HARQ-ACK value, a HARQ-ACK information bit, and a HARQ-ACK response.
Reference window: refers to a time interval in which a DL transmission (e.g., PDSCH) corresponding to the HARQ-ACK feedback set is performed in an unlicensed band carrier (e.g., Scell, NR-U cell). A reference window may be defined in units of slots or subframes according to embodiments. The reference window may indicate one or more specific slots (or subframes). According to an embodiment of the present disclosure, the specific slot (or reference slot) may include a start slot of the most recent DL transmission burst in which at least some HARQ-ACK feedback is expected to be available.

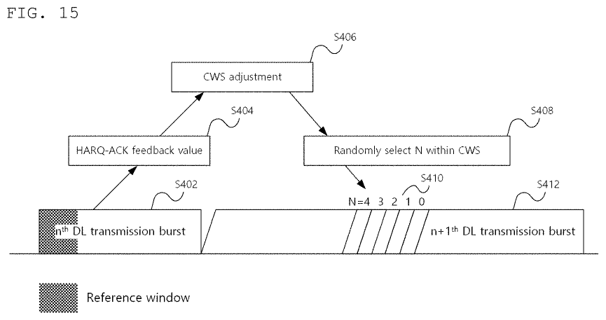

FIG. 15 illustrates an embodiment of a method of adjusting a contention window size (CWS) based on HARQ-ACK feedback. In the embodiment of FIG. 15, the Tx entity may be a base station and the Rx entity may be a UE, but the present disclosure is not limited thereto. In addition, although the embodiment of FIG. 15 assumes a channel access procedure for the DL transmission by the base station, at least some configurations may be applied to a channel access procedure for the UL transmission by the UE.

Referring to FIG. 15, the Tx entity transmits the n-th DL transmission burst on an unlicensed band carrier (e.g., Scell, NR-U cell) (step S402), and then if an additional DL transmission is required, the Tx entity may transmit the (n+1)-th DL transmission burst based on the LBT channel access (step S412). Here, the transmission burst indicates a transmission through one or more adjacent slots (or subframes). FIG. 15 illustrates a channel access procedure and a CWS adjustment method based on the aforementioned first type channel access (that is, Category 4 channel access).

First, the Tx entity receives a HARQ-ACK feedback corresponding to the PDSCH transmission(s) on an unlicensed band carrier (e.g., Scell, NR-U cell) (step S404). The HARQ-ACK feedback used for CWS adjustment includes a HARQ-ACK feedback corresponding to the most recent DL transmission burst (that is, n-th DL transmission burst) on the unlicensed band carrier. More specifically, the HARQ-ACK feedback used for CWS adjustment includes a HARQ-ACK feedback corresponding to the PDSCH transmission on the reference window within the most recent DL transmission burst. The reference window may indicate one or more specific slots (or subframes). According to an embodiment of the present disclosure, the specific slot (or reference slot) includes a start slot of the most recent DL transmission burst in which at least some HARQ-ACK feedback is expected to be available.

When the HARQ-ACK feedback is received, a HARQ-ACK value is obtained for each transport block (TB). The HARQ-ACK feedback includes at least one of a TB-based HARQ-ACK bit sequence and a CBG-based HARQ-ACK. When the HARQ-ACK feedback is the TB-based HARQ-ACK bit sequence, one HARQ-ACK information bit is obtained per TB. On the other hand, when the HARQ-ACK feedback is the CBG-based HARQ-ACK bit sequence, N HARQ-ACK information bit(s) are obtained per TB. Here, N is the maximum number of CBGs per TB configured in the Rx entity of the PDSCH transmission. According to an embodiment of the present disclosure, HARQ-ACK value(s) for each TB may be determined with the HARQ-ACK information bit(s) for each TB of the HARQ-ACK feedback for CWS determination. More specifically, when the HARQ-ACK feedback is the TB-based HARQ-ACK bit sequence, one HARQ-ACK information bit of the TB is determined as the HARQ-ACK value. However, when the HARQ-ACK feedback is the CBG-based HARQ-ACK bit sequence, one HARQ-ACK value may be determined based on N HARQ-ACK information bit(s) corresponding to CBGs included in the TB.

Next, the Tx entity adjusts the CWS based on the HARQ-ACK values determined in step S404 (step S406). That is, the Tx entity determines the CWS based on the HARQ-ACK value(s) determined with the HARQ-ACK information bit(s) for each TB of the HARQ-ACK feedback. More specifically, the CWS may be adjusted based on the ratio of NACKs among HARQ-ACK value(s). First, variables may be defined as follows.
p: Priority class value
CW_min_p: Predetermined CWS minimum value of priority class p
CW_max_p: Predetermined CWS maximum value of priority class p
CW_p: CWS for transmission of priority class p. CW_p is set to any one of a plurality of CWS values between CW_min_p and CW_max_p included in the allowed CWS set of the priority class p.

I. Method for Configuring NR-U DRS(or DRS)

In NR-U, a signal including an SSB burst set transmission having one or more SSB indices or at least SSB is defined, and the corresponding signal is designed to have the following characteristics specialized for operation in the unlicensed band.
There is no gap within a time interval in which the corresponding signal is transmitted at least in a beam.
An occupied channel bandwidth (OCB) needs to be satisfied. However, this may not be a requirement.
A channel occupancy time of the corresponding signal is minimized.
Prompt channel access can be facilitated.

In addition, when the corresponding signal is an NR-U discovery reference signal (DRS), the NR-U DRS (or DRS) includes not only an SSB burst set having one or more SSB indices or an SSB at least included in one consecutive burst, but also remaining system information (RMSI)-CORESET(s) and a PDSCH for carrying RMSI associated with an SS/PBCH, that is, a control channel transmission region for transmission of scheduling information for the RMSI. In addition, a CRI-RS may be also included in the NR-U DRS.

In addition, transmission of additional signals such as other system information or on-demand system information (OSI) may be included in the NR-U DRS.

II. DRS-Based LBT Method

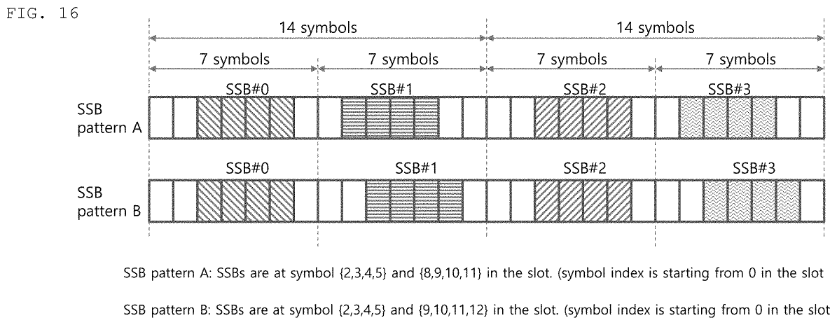

FIG. 16 illustrates the locations of OFDM symbols occupied by SSBs in a slot including 14 OFDM symbols. SSB pattern A in FIG. 16, as an SSB pattern for NR-U, has the same symbol location as that of an SSB used in the 3GPP Rel-15 NR system. On the other hand, in SSB pattern B in FIG. 16 for NR-U, the OFDM symbol location of an SSB in the second half slot in one slot is configured to be moved forward by one symbol so that the locations of symbols occupied by SSBs in one slot are symmetrically configured in unit of half-slots.

In NR-U enabling using of a 5 GHz band and a 6 GHz band, a maximum number of transmittable SSBs in a DRS may be configured as X. For example, X=2, X=4, or X=8. In addition, SCS supporting an SSB may be 15 kHz or 30 kHz. In a case of 15 kHz, one slot is configured as 1 ms, and in a case of 30 kHz, one slot is configured as 0.5 ms. Accordingly, the number of SSB which can be included within 1 ms may be two or four (15 kHz or 30 kHz). With respective to a duty cycle of the DRS, total duration of the DRS satisfying 1/20 may vary according to the configuration of a DRS period.

Normally, as a case where only a DRS is transmitted or a DRS to which non-unicast data or DL reference signals are multiplexed is transmitted, when the total duration of the DRS is 1 ms or less and the transmission duty cycle of the DRS is configured as 1/20 or less, Cat-2 LBT-based communication can be performed. However, when the preceding condition is not satisfied (that is, as a case where only a DRS is transmitted or a DRS to which non-unicast data is multiplexed is transmitted, when the total duration of the DRS is greater than 1 ms or the duty cycle of the DRS is greater than 1/20), Cat-4 LBT-based communication can be performed.

III. Designing for SS/PBCH Block Configuration

In NR, the UE receives a PBCH and an SS transmitted from the base station to perform initial cell access, RRM measurement, and mobility measurement. Hereinafter, the SS and the PBCH are combined and referred to as a “synchronization signal block (SSB)”. The SS and the PBCH may be also combined and referred to as an “SS/PBCH block”.

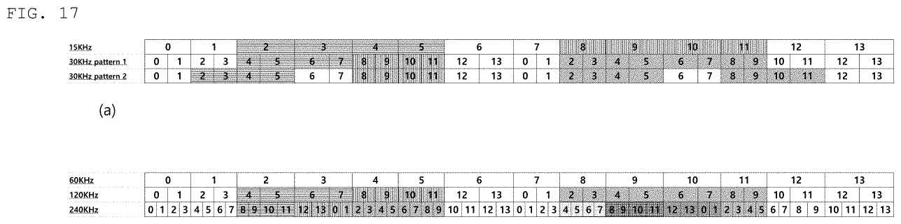

FIG. 17 illustrates the location of a symbol which can be occupied by an SSB in one slot. The SSB according to an example of FIG. 17 includes 20 RBs and four symbols to which a 1-symbol PSS, a 1-symbol SSS, and a PBCH, defined in NR, are mapped.

Part (a) of FIG. 17 illustrates an SSB in a case where subcarrier spacing (SCS) is 15 kHz and 30 kHz, and part (b) of FIG. 17 illustrates an SSB in a case where SCS is 60 kHz, 120 kHz, and 240 kHz. Numbers such as 0, 1, 2, 3, . . . , and 13 in parts (a) and (b) of FIG. 17 indicate symbol numbers in one slot, and hatched symbols indicate that the SSB is mapped.

As illustrated in parts (a) and (b) of FIG. 17, the location of symbol which can be occupied by the SSB in one slot may vary according to subcarrier spacing. For example, in a case of a slot in which 15 kHz subcarrier spacing is used, SSBs are located at four symbols corresponding to indices 2, 3, 4, and 5 and four symbols corresponding to indices 8, 9, 10, and 11, respectively. On the other hand, in a case of a slot in which 120 kHz subcarrier spacing is used, SSBs are located at four symbols corresponding to indices 4, 5, 6, and 7 and four symbols corresponding to indices 8, 9, 10, and 11, respectively.

In a case of 30 kHz, a pattern (pattern 1) for normal eMBB transmission and a pattern (pattern 2) for URLLC transmission, that is, two SSB allocation patterns, may be used.

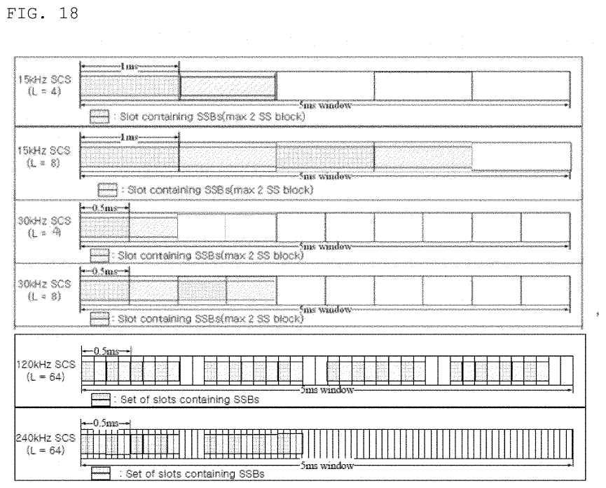

FIG. 18 illustrates the location of a slot which can be occupied by an SSB within 5 ms corresponding to a half radio frame.

Referring to FIG. 18, the location of a slot which can be occupied by an SSB within a half radio frame may vary according to SCS. In addition, a maximum number (L) of SSBs which can be transmitted within 5 ms may also vary according to the SCS.

In NR, one SCS is defined for each band for transmission of an SSB, so that complexity due to SSB search in the UE for initial cell access is reduced. Specifically, for a band equal to or lower than 6 GHz, one of 15 kHz SCS and 30 kHz SCS is configured to be used for the SSB, and for a band equal to or higher than 6 GHz, one of 120 kHz SCS and 240 kHz SCS is configured to be used for the SSB.

In NR-U, when the base station fails to perform LBT-based channel access, transmission of the SSB may be performed at the location configured by the base station. This is because the SSB needs to be also transmitted based on the LBT in the NR unlicensed band, similar to other channel/signals. Accordingly, even though SSB configuration information is configured for the UE so that the UE can assume or expect SSB reception at a specific location, the corresponding UE may fail to receive the SSB. When the SSB is transmitted by a specific period, and thus when the UE fails to receive the SSB at a specific location, the UE may receive the SSB after one period passes, which causes latency in RRM measurement and adjacent cell measurement. Furthermore, an increase in latency in the overall system may be caused.

For beam operation, the base station transmits different beams by using SSB indices transmitted in different time domains. Accordingly, a beam link connecting the UE and a corresponding beam is established, and beam management may be performed. However, if the base station fails to perform transmission of the SSB due to LBT failure, latency in establishing a beam link between the base station and the UE through beam sweeping may increase, which may cause huge deterioration in system performance.

Accordingly, in NR-U, 60 kHz SCS may be used to increase a channel access occasion. When an NR system is used in NR-L, in a band equal to or lower than 6 GHz, 15 kHz or 30 kHz SCS may be used for the SSB, and 15 kHz, 30 kHz, or 60 kHz SCS may be used for data transmission. In addition, in a band equal to or higher than 6 GHz, 120 kHz or 240 kHz SCS may be used for the SSB, and 60 kHz or 120 kHz SCS may be used for data transmission.

When the NR-U is used in a band lower than 7 GHz (equal to or lower than 7.125 GHz), 15 kHz or 30 kHz SCS may be considered. However, in a case where 60 kHz SCS, in which an interval between OFDM symbols in the time domain is reduced by ¼, compared to 15 kHz SCS, is used, as the interval between OFDM symbols is reduced, a transmission occasion in a symbol unit after channel access may be increased. Furthermore, in a case where 15 kHz SCS and 30 kHz SCS are used, when channel access is successfully performed within one symbol, a time interval required for transmission of a scheduled signal may be increased compared to a case where 60 kHz SCS is used. Accordingly, in NR-U, use of 60 kHz SCS may be considered.

IV. Candidate SS/PBCH Block in NR-U

Hereinafter, the SS and the PBCH are combined and referred to as a “SS/PBCH block”. As in the description above, the SS and the PBCH may be also combined and referred to as an “synchronization signal block (SSB)”.

In NR-U, the base station may transmit one or more SS/PBCH blocks having a maximum L of SS/PBCH block indices to the UE. In a case of being based on the NR-U channel access, as described above, the base station may transmit the one or more SS/PBCH blocks having the SS/PBCH block indices after a time point at which LBT-based channel access is successfully performed, rather than at a time point at a predetermined fixed time point.

Unlike an SS/PBCH block in a mode (hereinafter, referred to as a first operation mode) in which channel access is not performed as in the operation in the licensed band, in a mode (hereinafter, referred to as a second operation mode) in which NR-U channel access is performed, SS/PBCH blocks are in a candidate location at which the SS/PBCH blocks may or may not be transmitted in the unlicensed band according to whether channel access has been successfully performed or not. Accordingly, to distinguish the SS/PBCH blocks in the second operation mode from those in the first operation mode, one or more SS/PBCH blocks in the second operation mode are referred to as candidate SS/PBCH blocks. In the first operation mode, the SS/PBCH block is always transmitted, and may thus be identical to a candidate SS/PBCH.

Indices of the candidate SS/PBCH blocks may be preconfigured by the base station, and among the indices, indices of actually transmitted SS/PBCH blocks may be determined based on channel access.

The UE cannot identify information on a result of LBT performed by the base station, and thus cannot identify when an SS/PBCH block is actually transmitted from the base station. Such a situation causes ambiguity in communication between the UE and the base station, and thus a procedure for eliminating the ambiguity and providing smooth communication needs to be defined.

In addition, the UE considers transmission of a maximum L of SS/PBCH blocks from the base station, but the UE may assume that only one SS/PBCH block having the same SS/PBCH block index within a specific window is transmitted. Here, the specific window may be, for example, a discovery burst transmission window (DRS window). The DRS transmission window is a periodically configured non-continuous period in which the UE monitors a DRS, and is provided to reduce power consumption caused by continuous monitoring of the DRS.

The UE needs to be implemented to perform a downlink or uplink transmission operation by at least considering a time point at which one or more SS/PBCH blocks can be transmitted from the base station, as a candidate SS/PBCH block transmission time point. Hereinafter, in relation to a resource at a candidate SS/PBCH block transmission time point, operations of the UE for three cases are disclosed.

1. Candidate SS/PBCH Block Index-Based Downlink Resource Configuration Method

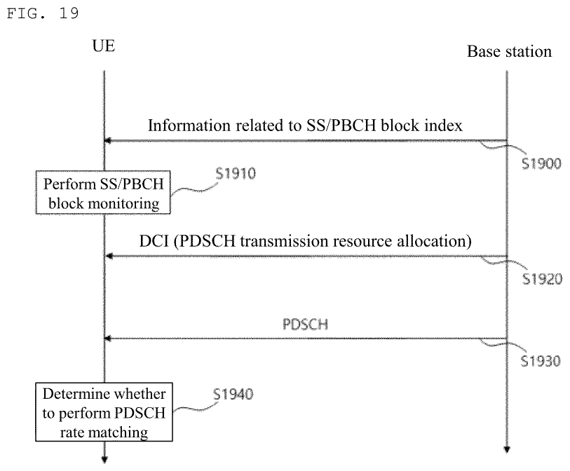

FIG. 19 is a flowchart illustrating a method for processing a downlink signal in an unlicensed band according to an example.

Referring to FIG. 19, the base station generates information indicating one or more SS/PBCH block indices in a mode in which unlicensed band channel access is performed, and transmit the same to the UE (S1900). Specifically, the base station may inform the UE of information indicating one or more SS/PBCH block indices actually transmitted from the base station, though an RRC parameter which is ssb-PositionInBurst include in ServingCellConfigCommon or SIB1, so that the UE can rate match a PDSCH received from the base station. Here, the information indicating the one or more SS/PBCH block indices may be ssb-PositionInBurst. That is, the UE receives, from the base station, information on a resource at which a candidate SS/PBCH block is to be positioned.

The one or more SS/PBCH block indices transmitted from the base station the UE are used for the UE to recognize one or more resources corresponding to the one or more SS/PBCH block indices, respectively, among multiple resources based on candidate SS/PBCH block indices.

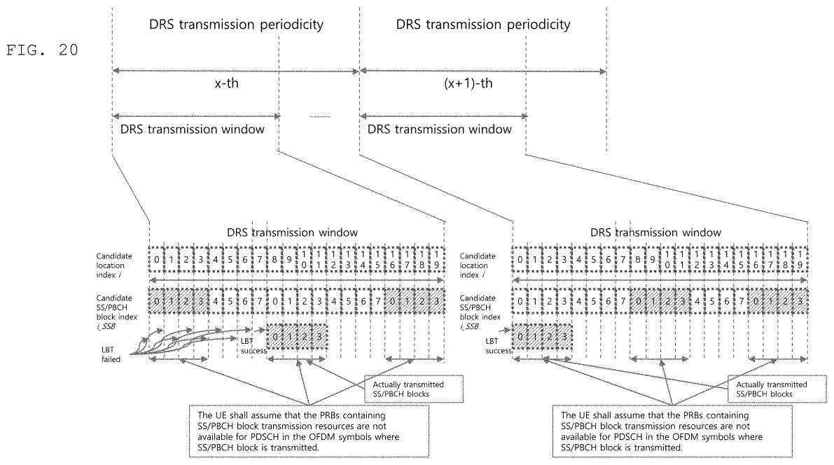

The UE cannot identify whether the base station has successfully performed channel access (or LBT) in an unlicensed band, the UE monitors whether an SS/PBCH block is actually received in the unlicensed band, based on a DRS transmission window (S1910). If the base station attempts and successfully performs channel access to an unlicensed band, the base station may transmit an SS/PBCH block through the unlicensed band, and if the base station fails to perform the channel access, the base station continuously attempts to perform channel access in the unlicensed band and continuously attempts to perform channel access within the DRS transmission window and in the order of the DRS transmission window of the next cycle. That is, the base station may continuously attempt to perform channel access within the DRS transmission window and in the order of the DRS transmission window of the next cycle, so as to perform transmission in one or more resources corresponding to the one or more SS/PBCH block indices, respectively, among multiple resources based on the candidate SS/PBCH block indices. Accordingly, when the base station successfully performs channel access to the unlicensed band before a resource corresponding to an SS/PBCH block of a specific index, the base station may transmit an SS/PBCH block of the specific index, and the UE may receive the SS/PBCH block through the unlicensed band. Step S1910 is not an operation necessary for implementation of the embodiment, and an embodiment in which step S1910 is omitted is also possible. Hereinafter, a detailed description in relation to Steps S1900 and S1910 will be made through FIG. 20.

FIG. 20 illustrates at least one candidate SS/PBCH block which can be transmitted within a DRS transmission window according to an example. The example of FIG. 20 is a case where SCS is 30 kHz, the length of a DRS transmission window is 5 ms, L=8, and an SS/PBCH block index actually transmitted from the base station corresponds to {0,1,2,3}. Here, L indicates a maximum number of SS/PBCH block indices in a cell, and may vary according to a frequency band range. For example, a maximum value of L may be 4 in a band equal to or lower than 3 GHz, a maximum value of L may be 8 in a band equal to or higher than 3 GHz to a band equal to or lower than 6 GHz, and a maximum value of L in a band equal to or greater than 6 GHz may be 64.

Referring to FIG. 20, the DRS transmission window may include a total of 20 slots from indices 0 to 19 as a resource in which a candidate SS/PBCH block is positioned, and each slot within the corresponding DRS transmission window corresponds to one of candidate SS/PBCH block indices (i_SSB) 0 to 7.

A hatched slot indicates a slot at which candidate SS/PBCH blocks corresponding to one or more SS/PBCH block indices {0,1,2,3} is positioned. Specifically, the base station successfully performs LBT from slots 0 to 6 but fails to perform channel access, and thus the base station cannot transmit the one or more SS/PBCH blocks positioned at slots 0 to 6. The base station successfully performs channel access before slot 8 and transmits transmission of SS/PBCH blocks having indices 0 to 3 over a total of four consecutive slots from slots 8 to 11.

Referring back to FIG. 19, the base station generates DCI for allocating a resource for a PDSCH for the UE in the unlicensed band, and transmits the same to the UE (S1920). That is, the UE receives DCI for allocating a resource for a PDSCH in an unlicensed band from the base station.

The base station generates a PDSCH, based on the DCI, and transmits the generated PDSCH to the UE (S1930).

In Step S1930, the UE determines processing of the PDSCH, that is, whether to perform rate matching of the PDSCH, based on whether a resource at which the candidate SS/PBCH block is to be positioned overlaps with a transmission resource of the PDSCH (S1940). Specifically, when the resource at which the candidate SS/PBCH block is to be positioned does not overlap with the resource for the PDSCH, the UE decodes the PDSCH, based on the resource for the PDSCH without rate matching of the PDSCH. On the other hand, when the resource at which the candidate SS/PBCH block is to be positioned is partially or completely overlaps with the resource for the PDSCH, the UE performs rate matching for the PDSCH by assuming that the resource partially or completely overlapping with the candidate SS/PBCH block, among resources for the PDSCH, is not used for the PDSCH.

That is, the base station may transmit information indicating one or more SS/PBCH block indices to the UE, and the UE may perform rate matching of the PDSCH, based on one or more resources corresponding to the one or more SS/PBCH block indices for reception of a candidate SS/PBCH block, respectively.

Hereinafter, detailed embodiments in relation to Step S1940 will be disclosed.

For example, in the first operation mode (e.g., mode using a licensed carrier), the UE having received information on a resource location of one or more SS/PBCH blocks assumes SS/PBCH block transmission according to ssb-PositionInBurst. If a PDSCH resource allocation partially or completely overlaps with a PRB corresponding to a resource including SS/PBCH block transmission, the UE performs rate matching of the PDSCH by assuming that an SS/PBCH block is transmitted to the corresponding overlapping resource. That is, the UE assumes that the PRB including the SS/PBCH block transmission resource in the OFDM symbol in which the SS/PBCH block is transmitted is not used for the PDSCH.

In another example, also in the second operation mode (in a case where an unlicensed carrier or shared spectrum operation is performed), the base station may inform the UE of the location of the resource of the one or more SS/PBCH blocks, through an RRC parameter or SIB1 corresponding to ssb-PositionInBurst, in the same scheme as the first operation mode. Transmission of the actually transmitted SS/PBCH block may vary according to an LBT result from the base station, but the UE cannot identify whether the corresponding station has successfully performed the LBT. Accordingly, for stable operation, the UE assumes SS/PBCH block transmission at resource locations of candidate SS/PBCH blocks corresponding to the one or more SS/PBCH block indices indicated through the RRC parameter or SIB1 corresponding to ssb-PositionInBurst, respectively, regardless of whether the SS/PBCH block is actually transmitted from the base station. Here, the resource locations of the one or more SS/PBCH blocks, indicated through the RRC parameter or SIB1 corresponding to ssb-PositionInBurst in the second operation mode, includes all the candidate SS/PBCH blocks having possibility of transmission of SS/PBCH blocks.

When the PDSCH resource allocation overlaps with the PRB including the candidate SS/PBCH block transmission, the UE performs rate matching of the PDSCH, regardless of whether the SS/PBCH block is actually transmitted, by assuming that the SS/PBCH block is transmitted in the corresponding resource. That is, the UE assumes that the PRB including the SS/PBCH block transmission resource in the OFDM symbol in which the candidate SS/PBCH block transmission is assumed is not used for the PDSCH.

For example, referring to FIG. 20, when the base station indicates one or more SS/PBCH block indices {0,1,2,3} to the UE through ssb-PositionInBurst, the UE performs PDSCH rate matching in the candidate SS/PBCH block transmission resource corresponding to the SS/PBCH block indices {0,1,2,3} within the DRS transmission window. That is, when the PDSCH resource allocation overlaps with the PRB at the location at which there is possibility that the candidate SS/PBCH block is transmitted, the UE performs PDSCH rate matching regardless of whether the one or more SS/PBCH blocks are actually transmitted or not, by assuming that the SS/PBCH block is transmitted in the corresponding resource. In this case, the UE assumes that the PRB including the SS/PBCH block transmission resource in the OFDM symbol in which the candidate SS/PBCH block transmission is assumed is not used for the PDSCH.

In another example, also in the second operation mode, the base station may inform the UE of the resource locations of the one or more SS/PBCH blocks through an RRC parameter or SIB1 corresponding to ssb-PositionInBurst in the same scheme as the first operation mode. However, an NR-U communication scheme according to this example may be designed so that an SS/PBCH block having the same SS/PBCH block index is not transmitted more than one time within a DRS transmission window. This means that when a specific SS/PBCH block index is detected within a DRS transmission window, the UE assumes that an SS/PBCH block corresponding to the specific SS/PBCH block index is no longer transmitted within the corresponding DRS transmission window. Accordingly, the UE may decode the PDSCH without performing PDSCH rate matching for an SS/PBCH block resource corresponding to a subsequence candidate SS/PBCH block index.

For example, referring back to FIG. 20, if the UE has detected candidate SS/PBCH block index 0 within the first DRS transmission window, the UE does not perform PDSCH rate matching for PDSCH transmission in candidate location index 16 by assuming that SS/PBCH block index 0 is not transmitted in subsequent candidate location index 16 having the same candidate SS/PBCH block index 0. Similarly, if the UE has detected all of the candidate SS/PBCH block indices {0,1,2,3}, the UE does not perform rate matching for PDSCH transmission in candidate location indices {16,17,18,19} by assuming that SS/PBCH block indices {0,1,2,3} are not transmitted in subsequent candidate location indices {16,17,18,19} having candidate SS/PBCH block indices {0,1,2,3}.

In another example, also in the second operation mode, the base station may inform the UE of the location of a resource of an SS/PBCH block through an RRC parameter or SIB1 corresponding to ssb-PositionInBurst in the same scheme as the first operation mode. However, in the NR-U communication scheme according to this example may be designed so that rate matching for PDSCH transmission is to be performed in SS/PBCH block resources corresponding to all the candidate SS/PBCH block indices within the DRS transmission window. This is because the UE may identify a maximum number value L specified for each frequency band, but cannot identify a value of a maximum number L′ of indices of SS/PBCH blocks actually transmitted. Accordingly, the UE may perform PDSCH rate matching in SS/PBCH block transmission resources corresponding to all the candidate SS/PBCH block indices within the DRS transmission window with reference to the value of a maximum number L of the SS/PBCH block indices which can be assumed.

In another example, in the second operation mode, the base station and the UE may configure a dynamic or semi-static channel access mode. A dynamic channel access mode is a scheme used for a load-based equipment (LBE) operation, and a semi-static channel access mode is a scheme used for a frame-based equipment (FBE) operation.

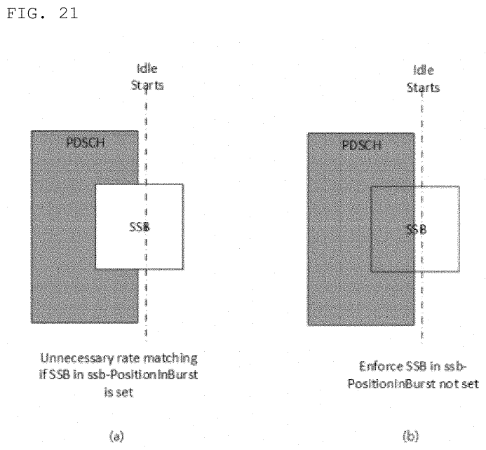

FIG. 21 illustrates an FBE operation in a semi-static channel access mode according to an embodiment.

Referring to FIG. 21, when the base station and the UE configure a semi-static channel access mode, the base station may have an interval allowing base station transmission and UE transmission and an idle period in which sensing is performed and within a fixed frame period (FFP).

However, a case where within the configured FFP, the idle period in which sensing is performed partially or completely overlaps with symbols in which SS/PBCH block transmission is assumed may occur. In this case, the base station does not perform transmission of the corresponding SS/PBCH block. Part (a) of FIG. 21 illustrates an embodiment in which even though the base station does not perform transmission of an SS/PBCH block, the UE performs PDSCH rate matching by assuming SS/PBCH transmission, based on information indicated through an RRC parameter or SIB1 corresponding to ssb-PositionInBurst. However, this may eventually cause loss in a data transmission rate according to the PDSCH rate matching. Here, the caused loss may correspond to symbol(s) which is assumed to be occupied by the SS/PBCH block, except for a symbol overlapping with the idle period of each FFP.

Accordingly, in the semi-static channel access mode configured by the base station and the UE according to the embodiment, when the idle period of the FFP overlaps with a symbol for which transmission of some SS/PBCH blocks is assumed, as shown in part (b) of FIG. 21, the UE performs PDSCH decoding instead of perform rate matching for the PDSCH scheduled with the overlapping resource. This is because both the base station and the UE may recognize that the corresponding PDSCH is scheduled in the idle period. In addition, the UE may not perform RRM/RLM measurement for the SS/PBCH block partially or completely overlapping with the idle period even though the location is the location of the SS/PBCH block assumed to be transmitted.

In another example, when the SS/PBCH block assumed to be transmitted partially or completely overlaps with the idle period within the FFP, the base station may configure bit(s) corresponding to the SS/PBCH block index overlapping with the idle period, among a bit string related to the SS/PBCH block index within the corresponding ssb-PositionInBurst, as 0. The UE receives the bit string related to the SS/PBCH block index within ssb-PositionInBurst indicated through SIB1 or the RRC parameter, and performs PDSCH decoding without performing PDSCH rate matching in the SS/PBCH index corresponding to the bit configured as 0.

2. Candidate SS/PBCH Block Index-Based Uplink Resource Configuration Method

Hereinafter, a detailed description of resource configuration for an uplink signal (random access preamble, PUCCH, PUCCH repetition, PUSCH, and PUSCH repetition) will be made.

An SS/PBCH block may be transmitted through a set of symbols including a semi-static DL symbol and a flexible symbol, rather than a UL resource semi-statically configured in a slot format. When transmission of the SS/PBCH block or transmission of a candidate SS/PBCH block is configured for the semi-static DL symbol, UL transmission cannot be performed in the semi-static DL symbol in any case, the semi-static DL symbol is basically excluded in configuring a resource for UL transmission, and thus no ambiguity arises.

However, when a set of flexible symbols are included in a resource at which transmission of the SS/PBCH block or the candidate SS/PBCH block is to be located, in configuring a resource for UL transmission, a method for performing resource configuration for UL transmission according to whether an SS/PBCH block is actually transmitted in the resource at which the candidate SS/PBCH block is to be located needs to be defined. Specifically, when the UE performs communication in the second operation mode, the base station may inform the UE of the locations of resources of one or more SS/PBCH blocks through an RRC parameter or SIB1 corresponding to ssb-PositionInBurst in the same scheme as the first operation mode. However, the transmission of the actually transmitted SS/PBCH block may vary according to an LBT result of the base station.

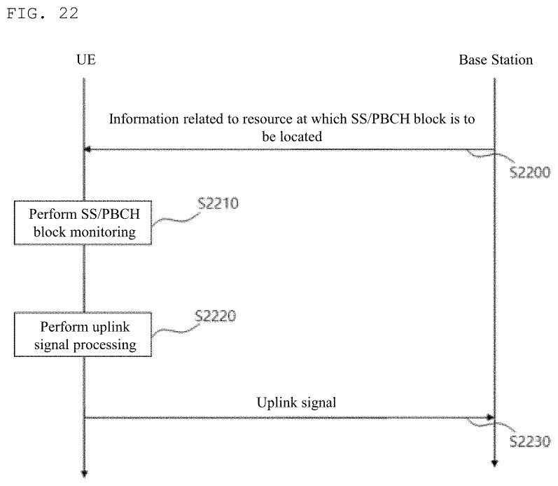

FIG. 22 is a flowchart illustrating a method for processing an uplink signal in an unlicensed band according to an example.

Referring to FIG. 22, the base station generates information indicating one or more SS/PBCH block indices in a mode in which unlicensed band channel access is performed, and transmits the same to the UE (S2200). Specifically, the base station may inform the UE of information indicating one or more SS/PBCH block indices actually transmitted from the base station, through an RRC parameter corresponding to ssb-PositionInBurst included in ServingCellConfigCommon or SIB1, so that the UE can rate match a PDSCH received from the base station. Here, the information indicating the one or more SS/PBCH block indices may be ssb-PositionInBurst. That is, the UE receives, from the base station, information on a resource at which a candidate SS/PBCH block is to be located.

The one or more SS/PBCH block indices transmitted from the base station to the UE are used so that the UE recognizes one or more resources corresponding to the one or more SS/PBCH block indices, respectively, among multiple resources based on candidate SS/PBCH block indices. The UE cannot identify whether the base station has successfully performed channel access (or LBT) in an unlicensed band, the UE monitors whether an SS/PBCH block is actually received in the unlicensed band, based on a DRS transmission window (S2210). If the base station attempts and successfully performs channel access to an unlicensed band, the base station may transmit an SS/PBCH block through the unlicensed band, and if the base station fails to perform the channel access, the base station continuously attempts to perform channel access in the unlicensed band and continuously attempts to perform channel access within the DRS transmission window and in the order of the DRS transmission window of the next cycle. That is, the base station may continuously attempt to perform channel access within the DRS transmission window and in the order of the DRS transmission window of the next cycle, so as to perform transmission in one or more resources corresponding to the one or more SS/PBCH block indices, respectively, among multiple resources based on the candidate SS/PBCH block indices. Accordingly, when the base station successfully performs channel access to the unlicensed band before a resource corresponding to an SS/PBCH block of a specific index, the base station may transmit an SS/PBCH block of the specific index, and the UE may receive the SS/PBCH block through the unlicensed band. Step S2210 is not an operation necessary for implementation of the embodiment, and an embodiment in which step S2210 is omitted is also possible.

The UE processes an uplink signal, based on the resource at which the candidate SS/PBCH block is to be located (SS2220). That is, the base station transmits information indicating one or more SS/PBCH blocks to the UE, and the UE processes an uplink signal or configures a resource for an uplink signal, based on the information on the resource of the SS/PBCH block.

For example, when uplink transmission is scheduled or configured via a higher-layer to overlap with some or all of SS/PBCH block resources corresponding to all candidate SS/PBCH block indices, the UE may drop transmission of the corresponding uplink signal or may not perform transmission of the uplink signal. Here, a situation in which the uplink transmission overlaps with some or all of the candidate SS/PBCH block resources includes a case where a set of flexible symbols is included at the locations of the candidate SS/PBCH blocks.

When the uplink transmission does not overlap with the SS/PBCH block resources corresponding to all candidate SS/PBCH block indices, or is spaced apart from the SS/PBCH block resources by a predetermined interval, the UE may perform transmission of the corresponding uplink signal (S2230).

In this embodiment, the uplink signal may include at least one of a random access preamble, a PUCCH, a PUCCH repetition, a PUSCH, and a PUSCH repetition.

Hereinafter, detailed embodiments relating to uplink signal processing by the UE according to Step S2220 when a set of flexible symbols is included at the location of the candidate SS/PBCH block or the SS/PBCH block transmission will be disclosed.

For example, when a set of flexible symbols are included at the location of the candidate SS/PBCH block or the SS/PBCH block transmission, the UE may assume transmission of the SS/PBCH block, regardless of whether the SS/PBCH block is actually transmitted in resources at which candidate SS/PBCH blocks corresponding to SS/PBCH block indices indicated through an RRC parameter or SIB1 corresponding to ssb-PositionInBurst are located, and may exclude the corresponding resources from uplink resource configuration. That is, the UE assumes SS/PBCH block transmission in a resource at which a candidate SS/PBCH block is located within a DRS transmission window, and excludes the corresponding resource from uplink resource configuration.

Referring to FIG. 20, when the base station indicates, to the UE, {0,1,2,3} as SS/PBCH block indices, the UE excludes transmittable resources of candidate S S/PBCH block indices corresponding to the S S/PBCH block indices {0,1,2,3} within the DRS transmission window from resources for uplink transmission. This is also applied the same to a case where a set of flexible symbols is included at the location of the candidate SS/PBCH block and the SS/PBCH block transmission.

In another example, when a set of flexible symbols is included at the location of the candidate SS/PBCH block and the SS/PBCH block transmission, an NR-U communication scheme according to this example may be designed so that an SS/PBCH block having the same SS/PBCH block index is not transmitted more than one time within a DRS transmission window. This means that when a specific SS/PBCH block index is detected within a DRS transmission window, the UE assumes that an SS/PBCH block corresponding to the specific SS/PBCH block index is no longer transmitted within the corresponding DRS transmission window. Accordingly, the locations of the flexible symbols overlapping with the candidate SS/PBCH block indices after the SS/PBCH block indices may be included in uplink resource configuration, and uplink transmission may be performed. In this case, the uplink transmission may be based on a resource configured via scheduling, dynamic scheduling, semi-static scheduling, or a higher-layer.

Referring to FIG. 20, if the UE has detected candidate SS/PBCH block index from candidate location index 8 within the first DRS transmission window, the UE may perform uplink transmission at subsequent candidate location index 16 having the same candidate SS/PBCH block index 0. Similarly, if the UE has detected all the candidate SS/PBCH block indices {0,1,2,3} from candidate location indices {8,9,10,11}, the UE may perform uplink transmission at subsequent candidate location indices {16,17,18,19} having the candidate SS/PBCH block indices {0,1,2,3}.

In another example, the UE may exclude uplink transmission (or uplink resource configuration) from SS/PBCH block resources corresponding to all candidate SS/PBCH block indices within the DRS transmission window. That is, the UE does not perform uplink transmission scheduled or configured via a higher layer within the DRS transmission window.

In another example, in a semi-statically configured channel access mode, when at least a part of an idle period of an FFP overlaps with a symbol where transmission of an SS/PBCH block corresponding to a candidate SS/PBCH block index is assumed, the UE may perform uplink transmission by using a resource overlapping with the symbol where transmission of the SS/PBCH block is assumed, as a resource for an uplink signal. This is because both the base station and the UE can recognize that the base station does not perform transmission of the SS/PBCH block in the overlapping resource.

Hereinafter, a method for configuring an uplink resource for each channel and each uplink transmission signal will be disclosed.

2.1 Resource Configuration for Random Access Preamble

In configuring a resource for a PRACH occasion in the second operation mode, the UE assumes transmission of an SS/PBCH block at the locations of candidate SS/PBCH blocks corresponding to one or more SS/PBCH block indices indicated through an RRC parameter or SIB1 corresponding to ssb-PositionInBurst, regardless of whether the SS/PBCH block is actually transmitted, determines whether the PRACH occasion is valid in a PRACH slot.

Specifically, if i) tdd-UL-DL-ConfigurationCommon is not provided, ii) the PRACH occasion does not precede, in the PRACH slot, a candidate SS/PBCH block location for each of the candidate SS/PBCH block locations corresponding to the one or more SS/PBCH block indices, and iii) the PRACH occasion starts after at least N_gap symbols from a last symbol of the candidate SS/PBCH block location, the UE determines that the PRACH occasion is valid.

On the other hand, i) tdd-UL-DL-ConfigurationCommon is provided, ii) the PRACH occasion does not precede a candidate SS/PBCH block location in the PRACH slot, iii) the PRACH occasion starts after at least N_gap symbols from a last DL symbol, and iv) the PRACH occasion starts after at least N_gap symbol from a last reception symbol of the candidate SS/PBCH block location, the UE determines that the PRACH occasion is valid.

The length of the N_gap symbols may be configured differently according to SCS used by the random access preamble. In addition, for preamble format B4, N_gap is configured as 0. When the SCS of the preamble is 1.25 kHz or 5 kHz, N_gap may be 0 (N_gap=0), and when the SCS of the preamble is 15 kHz 30 kHz, 60 kHz, or 120 kHz, N_gap may be 2 (N_gap=2).

As another example, in configuring a resource for a PRACH occasion in the second operation mode, an NR-U communication scheme according to this example may be designed so that an SS/PBCH block having the same SS/PBCH block index within a DRS transmission window is not transmitted more than one time. In this case, when one or more specific SS/PBCH block indices are detected within a DRS transmission window, the UE assumes that SS/PBCH blocks corresponding to the one or more specific SS/PBCH block indices are no longer transmitted within the corresponding DRS transmission window, and determines validity of the PRACH occasion in the PRACH slot. That is, this example is applicable only until the UE performs SS/PBCH detection at the candidate SS/PBCH block location(s) corresponding to the SS/PBCH block indices, and for candidate SS/PBCH block location(s) configured after the detection, the UE may determine whether the PRACH occasion is valid, without considering the SS/PBCH block.

Specifically, if i) tdd-UL-DL-ConfigurationCommon is not provided, ii) the PRACH occasion does not precede, in the PRACH slot, a candidate SS/PBCH block location for each of the candidate SS/PBCH block locations corresponding to the one or more SS/PBCH block indices, and iii) the PRACH occasion starts after at least N_gap symbols from a last symbol of the candidate SS/PBCH block location, the UE determines that the PRACH occasion is valid.

On the other hand, i) tdd-UL-DL-ConfigurationCommon is provided, ii) the PRACH occasion does not precede a candidate SS/PBCH block location in the PRACH slot, iii) the PRACH occasion starts after at least N_gap symbols from a last DL symbol, and iv) the PRACH occasion starts after at least N_gap symbol from a last reception symbol of the candidate SS/PBCH block location, the UE determines that the PRACH occasion is valid.

The length of the N_gap symbols may be configured differently according to SCS used by the random access preamble. In addition, for preamble format B4, N_gap is configured as 0. When the SCS of the preamble is 1.25 kHz or 5 kHz, N_gap may be 0 (N_gap=0), and when the SCS of the preamble is 15 kHz 30 kHz, 60 kHz, or 120 kHz, N_gap may be 2 (N_gap=2).

As another example, in configuring a resource for a PRACH occasion in the second operation mode, the UE determines the validity of the PRACH occasion in the PRACH slot by assuming transmission of an SS/PBCH block at all candidate SS/PBCH block locations within a DRS transmission window.

As another example, in the semi-statically configured channel access mode, when at least a part of an idle period of an FFP overlaps with a symbol where transmission of an SS/PBCH block corresponding to a candidate SS/PBCH block index is assumed, the base station does not perform transmission of the corresponding SS/PBCH block. Even though the base station does not perform the transmission, the UE may determine the validity of the PRACH occasion in the PRACH slot by assuming the transmission of the SS/PBCH block in the overlapping resource, regardless of whether the SS/PBCH block is actually transmitted.

Alternatively, unlike the case above, the UE may determine the validity of the PRACH occasion in the PRACH slot by assuming that the transmission of the SS/PBCH block is not performed at the location where the transmission of the SS/PBCH block is assumed. This is because both the base station and the UE can recognize that the base station does not perform the transmission of the SS/PBCH block overlapping with the idle period.

More specifically, if i) tdd-UL-DL-ConfigurationCommon is not provided to the UE, ii) the PRACH occasion at least partially overlaps, in the PRACH slot, with the idle period among candidate SS/PBCH block locations corresponding to one or more SS/PBCH block indices, the UE determines that the PRACH occasion is valid for each of the overlapping locations, regardless of the candidate SS/PBCH block locations, and performs PRACH transmission.

Alternatively, if i) tdd-UL-DL-ConfigurationCommon is provided to the UE, ii) the PRACH occasion does not precede the candidate SS/PBCH block location in the PRACH slot, iii) the PRACH occasion starts after at least N_gap symbols after a last DL symbol, and iv) the PRACH occasion even partially overlaps with the idle period among the candidate SS/PBCH block locations corresponding to the SS/PBCH block indices, the UE may determine that the PRACH occasion is valid for each of the overlapping locations, regardless of the candidate SS/PBCH block indices, and perform PRACH transmission.

The length of the N_gap symbols may be configured differently according to SCS used by the random access preamble. In addition, for preamble format B4, N_gap is configured as 0. When the SCS of the preamble is 1.25 kHz or 5 kHz, N_gap may be 0 (N_gap=0), and when the SCS of the preamble is 15 kHz 30 kHz, 60 kHz, or 120 kHz, N_gap may be 2 (N_gap=2).

2.2 Resource Configuration for PUCCH Repetition

In configuring N\hat{ }repeat PUCCH slots to perform a PUCCH repetition by the UE in the second operation mode, the UE may assume transmission of an SS/PBCH block at candidate SS/PBCH block locations corresponding to one or more SS/PBCH block indices indicated through an RRC parameter or SIB1 corresponding to ssb-PositionInBurst, regardless of whether the SS/PBCH block is actually transmitted, and may configure the N\hat{ }repeat PUCCH slots in consideration of UL symbols and a flexible symbol rather than a symbol including the candidate SS/PBCH block locations.

For example, in configuring N\hat{ }repeat PUCCH slots to perform a PUCCH repetition by the UE in the second operation mode, an NR-U communication scheme according this example may be designed so that an SS/PBCH block having the same SS/PBCH block index within a DRS transmission window is not transmitted more than one time. In this case, when one or more specific SS/PBCH block indices are detected within a DRS transmission window, the UE assumes that SS/PBCH blocks corresponding to the one or more specific SS/PBCH block indices are no longer transmitted within the corresponding DRS transmission window. In this case, the UE configures the N N\hat{ }repeat PUCCH slots before SS/PBCH detection in consideration of UL symbols and a flexible symbol rather than a symbol including the candidate SS/PBCH block locations, and configures the N N\hat{ }repeat PUCCH slots after the SS/PBCH detection in consideration of UL symbols and a flexible symbol, regardless of the candidate SS/PBCH block locations.

As another example, in configuring N\hat{ }repeat PUCCH slots to perform a PUCCH repetition by the UE in the second operation mode, the UE may configure the N\hat{ }repeat PUCCH slots by assuming transmission of an SS/PBCH block at all candidate SS/PBCH block locations within a DRS transmission window.

As another example, in the semi-statically configured channel access mode, when at least a part of an idle period of an FFP overlaps with a symbol where transmission of an SS/PBCH block corresponding to a candidate SS/PBCH block index is assumed, the base station does not perform transmission of the corresponding SS/PBCH block. Even though the base station does not perform the transmission, the UE may configure the N\hat{ }repeat PUCCH slots in consideration of UL symbols and a flexible symbol rather than a symbol including the candidate SS/PBCH block locations by assuming the transmission of the SS/PBCH block in the overlapping resource, regardless of whether the SS/PBCH block is actually transmitted.

Alternatively, unlike the case above, the UE may assume the transmission of the SS/PBCH block is not performed at the location where the transmission of the SS/PBCH block is assumed, and may configure the N\hat{ }repeat PUCCH slots in consideration of UL symbols and a flexible symbol by including the candidate SS/PBCH block locations overlapping with the idle period. Here, the description is limited to a case where the candidate SS/PBCH block locations are configured in the flexible symbol. This is because the flexible symbol may be used for a UL resource, but cannot be basically calculated as the UL resource when a DL symbol is configured.

2.3 Resource Configuration for PUSCH Repetition

In configuring an uplink resource for a PUSCH repetition by the UE in the second operation mode, the UE may assume transmission of an SS/PBCH block at candidate SS/PBCH block locations corresponding to one or more SS/PBCH block indices indicated through an RRC parameter or SIB1 corresponding to ssb-PositionInBurst, regardless of whether the SS/PBCH block is actually transmitted, and may configure the uplink resource for the PUSCH repetition in consideration of UL symbols and a flexible symbol rather than a symbol including the candidate SS/PBCH block locations.

As another example, in configuring an uplink resource for a PUSCH repetition by the UE in the second operation mode, an NR-U communication scheme according this example may be designed so that an SS/PBCH block having the same SS/PBCH block index within a DRS transmission window is not transmitted more than one time. In this case, when one or more specific SS/PBCH block indices are detected within a DRS transmission window, the UE assumes that SS/PBCH blocks corresponding to the one or more specific SS/PBCH block indices are no longer transmitted within the corresponding DRS transmission window.

In this case, the UE configures the uplink resource for the PUSCH repetition before SS/PBCH detection in consideration of UL symbols and a flexible symbol rather than a symbol including the candidate SS/PBCH block locations, and configures the uplink resource for the PUSCH repetition after the SS/PBCH detection in consideration of UL symbols and a flexible symbol, regardless of the candidate SS/PBCH block locations.

As another example, in configuring an uplink resource for a PUSCH repetition by the UE in the second operation mode, the UE may configure the uplink resource for the PUSCH repetition by assuming transmission of an SS/PBCH block at all candidate SS/PBCH block locations within a DRS transmission window.

As another example, in the semi-statically configured channel access mode, when at least a part of an idle period of an FFP overlaps with a symbol where transmission of an SS/PBCH block corresponding to a candidate SS/PBCH block index is assumed, the base station does not perform transmission of the corresponding SS/PBCH block. Even though the base station does not perform the transmission, the UE may configure the uplink resource for the PUSCH repetition in consideration of UL symbols and a flexible symbol rather than a symbol including the candidate SS/PBCH block locations by assuming the transmission of the SS/PBCH block in the overlapping resource, regardless of whether the SS/PBCH block is actually transmitted.

Alternatively, unlike the case above, the UE may assume the transmission of the SS/PBCH block is not performed at the location where the transmission of the SS/PBCH block is assumed, and may configure the uplink resource for the PUSCH repetition in consideration of UL symbols and a flexible symbol by including the candidate SS/PBCH block locations overlapping with the idle period. Here, the description is limited to a case where the candidate SS/PBCH block locations are configured in the flexible symbol. This is because the flexible symbol may be used for a UL resource, but cannot be basically calculated as the UL resource when a DL symbol is configured.

V. PUSCH Scheduling Method

1. RB Set and Interlaced Structure

A DCI format scheduling a PUSCH may include a frequency domain resource assignment (FDRA) field for indicating frequency domain resource assignment information. One of methods for indicating the frequency domain resource assignment information is an interlaced indication method. This embodiment relates to interlaced and RB set indication methods. The interlaced indication method according to an example is as follows.

The UE may indicate one or multiple interlaces among M interlaces. Here, M is determined according to SCS. When SCS is 15 kHz, M=10, and when SCS is 30 kHz, M=5. The method for indicating the interlaces may vary according to SCS. When SCS is 30 kHz, M (M=5) interfaces may be indicated by a bitmap of X (X=5 bits). Each bit may indicate each interlace.

When SCS is 15 kHz, M interfaces may be indicated X (X=6 bits).

Here, X is the length of a bitmap indicating the interlace, that is, the number of bits. The bitmap indicating the interlace may indicate a start index of the interlace and the number of consecutive interlaces. Here, the index of the interlace may be 0, 1, . . . , and M−1. More specifically, a code value indicated by X bits may be determined as a resource indication value as follows.

if (L−1)≤[M/2] then

RIV=M(L−1)+m₀

else

RIV=M(M−L+1)+(M−1−m₀)

M is the number of interlaces, L is the number of consecutive interlaces, and m₀ is an index of a start interlace. For reference, values not used as RIV values, among X bits, may be used to indicate a combination of other interlaces.

Next, an RB set indication method is as follows.

It is assumed that a total number of RB sets to which a UL BWP can be indicated is N. The UE may indicate a start index of an RB set and the number of consecutive RB sets through Y=ceil(log 2(N*(N+1)/2)). Here, the index of the RB set may be 0, . . . , and N−1. More specifically, a code value indicated by Y may be determined as RIV as follows.

if (L_{RBset}−1)≤[N/2] then

RIV_{RBset}=N(L_{RBset}−1)+RBset_{START}

else

RIV_{RBset}=N(N−L_{RBset}+1)(N−1−RBset_{START})

Here, N is the number of RB sets of the UL BPW, L_{RBset} is the number of consecutive RB sets, and RBset_{START} is an index of a start RB set.

The UE may determine a PUSCH scheduled frequency resource from X bits indicating the interlace and Y bits indicating the RB set. This may be PRBs in which interlaces indicated by X bits and RB sets indicated by Y bits overlap with each other.

2. Problem of Ambiguity in FDRA Field

2.1 Ambiguity in FDRA Field According to DCI Format and DCI Size Alignment

In the Rel-15 NR system, there may be DCI formats having different lengths as follows.

1) Fallback DCI (DCI formats 0_0 and 1_0 in a common search space): The length is represented as DCI size A.

2) Fallback DCI (DCI formats 0_0 and 1_0 in a UE-specific search space): The length is represented as DCI size B.

3) Non-fallback DCI scheduling a PUSCH (DCI format 0_1 in a UE-specific search space): The length is represented as DCI size C.

4) Non-fallback DCI scheduling a PDSCH (DCI format 1_1 in a UE-specific search space): The length is represented as DCI size D.

However, the UE cannot simultaneously decode four DCI formats having different lengths. That is, the UE may decode DCI formats having a maximum of three different lengths. Accordingly, when the four DCI formats have all different lengths, the lengths of some DCI formats need to be increased or decreased to match with the lengths of other DCI formats. To this end, in Rel-15, the following steps of configuring a DCI size are defined as follows.

In Step 0, the UE determines the length of fallback DCI (DCI formats 0_0 and 1_0 in a common search space). In this case, the length of DCI format 0_0 is determined according to a UL BWP size, and the length of DCI format 1_0 is determined according to a DL BWP size. Here, the DL BWP size is identical the size of CORESET0 when CORESET0 is configured, and is identical to the size of an initial DL BWP when CORESET0 is not configured. When the length of DCI format 0_0 in a common search space is greater than that of DCI format 1_0 in the common search space, the UE truncates a most significant bit (MSB) of an FDRA field of DCI format 0_0 in the common search space to make the length of DCI format 0_0 be same as that of DCI format 1_0. On the other hand, the length of DCI format 0_0 in the common search space is smaller than that of DCI format 1_0 in the common search space, the UE perform zero padding for DCI format 0_0 in the common search space to make the length of DCI format 0_0 be same as that of DCI format 1_0.

After Step 0, the UE may acquire the lengths of DCI format 0_0 in the common search space and DCI format 1_0 in the common search space, and both always have the same length. Thereafter, the length is called DCI size A. For reference, there is a 1-bit distinguisher (flag bit) for distinguishing between DCI format 0_0 and DCI format 1_0. The UE may distinguish between DCI format 0_0 and DCI format 1_0 having the same length, through the distinguisher.

In Step 1, the UE determines the length of fallback DCI (DCI formats 0_0 and 1_0) in the UE-specific search space. The length of DCI format 0_0 in the UE-specific search space is determined according to an active UL BWP size, and the length of DCI format 1_0 in the UE-specific search space is determined according to an active DL BWP size. When the length of DCI format 0_0 in the UE-specific search space is greater than DCI format 1_0 in the UE-specific search space, the UE may perform zero-padding for DCI format 0_0 in the UE-specific search space to make the length of DCI format 0_0 be same as that of DCI format 1_O. On the other hand, when the length of DCI format 0_0 in the common search space is smaller than DCI format 1_0 in the common search space, the UE may perform zero-padding for DCI format 1_0 in the common search space to make the length of DCI format 0_0 be same as that of DCI format 1_0.

After Step 1, the UE may acquire the lengths of DCI format 0_0 in the UE-specific search space and DCI format 1_0 in the UE-specific search space, and both always have the same length. Hereinafter, this length is called DCI size B. DCI size B may be identical to DCI size A. If DCI size B is identical to DCI size A, the UE may distinguish DCI format 0_0/1_0 in the common search space from DCI format 0_0/1_0 in the UE-specific search space by using a search space. For reference, there is a 1-bit distinguisher (flag bit) for distinguishing between DCI format 0_0 and DCI format 1_0. The UE may distinguish between DCI format 0_0 and DCI format 1_0 having the same length, through the distinguisher.

In Step 2, the UE determines non-fallback DCI (DCI formats 0_1 and 1_1) in a UE-specific search space. The length of DCI format 0_1 in the UE-specific search space is determined according to parameter values configured in an active UL BWP. The length of DCI format 1_1 in the UE-specific search space is determined according to parameter values configured in an active DL BWP. If the determined length of DCI format 0_1 in the UE-specific search space is identical to DCI size B (the length of DCI format 0_0/1_0 in the UE-specific search space), the UE adds a 1-bit padding bit to DCI format 0_1 in the UE-specific search space. If the determined length of DCI format 1_1 in the UE-specific search space is identical to DCI size B (the length of DCI format 0_0/1_0 in the UE-specific search space), the UE adds a 1-bit padding bit to DCI format 1_1 in the UE-specific search space.

After Step 2, the length of DCI format 0_1 in the UE-specific search space is called DCI size C, and the length of DCI format 1_0 in the UE-specific search space is called DCI size D. DCI size C may be or may not be identical to DCI size D. When DCI sizes C and D are identical to each other, there is a 1-bit distinguisher (flag bit) for distinguishing between DCI format 0_1 and DCI format 1_1. The UE may distinguish between DCI format 0_1 and DCI format 1_1 having the same length, through this distinguisher. For reference, DCI sizes C and D are never be identical to DCI size B.

In Step 3, the UE identifies whether the number of DCI formats having different lengths is more than three. If the number of DCI formats (DCI size A/B/C/D) having different lengths is no more than three, the UE may determine that the length of the DCI format is successfully determined. If not, the UE needs to perform the following additional process to adjust the number of DCI formats to three or less.

In Step 3, a case where the number of DCI formats is equal to or less than three includes the following cases. A first case (Case 1) is a case where DCI size A and DCI size B are identical. In this case, the UE has DCI formats having a maximum of three different lengths, regardless of the length of DCI format C and DCI format D. A second case (Case 2) is a case where DCI size C and DCI size D are identical. In this case, the UE has DCI formats having a maximum of three different lengths, regardless of DCI sizes A and B. Lastly, a third case (Case 3) is a case where DCI size C or DCI size D is identical to DCI size A.

When there are more than three DCI format lengths, the following Step 4 is additionally performed.

In Step 4, when there is a 1-bit padding bit in DCI format 0_1 in the UE-specific search space or DCI format 1_1 in the UE-specific search space in Step 2, the UE truncates the 1-bit padding bit. Then, the UE adjusts the length of DCI format 0_0/1_0 in the UE-specific search space to be same as the length of DCI format 0_0/1_0 in the common search space. That is, as in the first case above, the UE adjusts DCI size B to be same as DCI size A (DCI size B=DCI size A). To this end, the UE adjusts the length of DCI format 0_0 in the UE-specific search space according to the size of the initial UL BWP. In addition, if CORESET0 is configured, the UE adjusts the length of DCI format 1_0 in the UE-specific search space according to the size of CORESET0, and if there is CORESET0 is not configured, the UE adjusts the length of DCI format 1_0 according to the initial DL BWP. In addition, if the length of DCI format 0_0 in the UE-specific search space is greater than that of DCI format 1_0 in the UE-specific search space, the UE truncates a most significant bit (MSB) of an FDRA field of DCI format 0_0 in the UE-specific search space to make the length of DCI format 0_0 be same as that of DCI format 1_0. On the other hand, if the length of DCI format 0_0 in the UE-specific search space is smaller than DCI format 1_0 in the UE-specific search space, the UE performs zero-padding for DCI format 0_0 in the UE-specific search space to make the length of DCI format 0_0 be same as that of DCI format 1_0.

After Step 4, the UE has three different DCI sizes (DCI sizes A=B, C, and D). That is, the length of fallback DCI (DCI formats 0_0 and 1_0) in the common search space is identical to the length of fallback DCI (DCI formats 0_0 and 1_0) in the UE-specific search space, and in addition thereto, there may be DCI format 0_1 in the UE-specific search space and DCI format 1_1 in the UE-specific search space, which have different lengths.

The following cases after Step 4 may be determined as an error. A first case is a case where DCI format 0_0 in the UE-specific search space and DCI format 0_1 in the UE-specific search space have the same length. A second case is where DCI format 1_0 in the UE-specific search space and DCI format 1_1 in the UE-specific search space have the same length. That is, when fallback DCI format and non-fallback DCI format in the UE-specific search space have the same length, the UE cannot distinguish between two DCI formats.

In Rel-16, to support new URLLC service, a DCI format having a new length may be configured. This is called compact DCI, for convenience of description. The length of each field of compact DCI may be configured through an RRC signal. Accordingly, the length of compact DCI may be configured to be shorter by 16 bits than that of Rel-15 fallback DCI, may be configured to be same as that of Rel-15 fallback DCI, or may be configured to be longer than that of Rel-15 fallback DCI, according to the configuration through the RRC signal. There may be two DCI formats having two new lengths as follows.

5) Compact DCI scheduling a PUSCH in a UE-specific search space (DCI format 0_2): The length is represented as DCI format E.

6) Compact DCI scheduling a PDSCH in a UE-specific search space (DCI format 1_2): The length is represented as DCI format F.

To decode DCI formats 1), 2), 3), 4), 5) and 6) having different lengths, the UE needs to adjust the lengths of the DCI formats.

To this end, the UE may adjust the lengths of the DCI formats by perform an additional process below.

The UE may perform Step 2A below between Step 2 and Step 3.

In Step 2A, the UE determines the length of compact DCI (DCI formats 0_2 and 1_2) in a UE-specific search space. The length of DCI format 0_2 in the UE-specific search space is determined according to parameter values configured for DCI format 0_2 of an active UL BWP. The length of DCI format 1_2 in the UE-specific search space is determined according to parameter values configured for DCI format 1_2 of an active DL BWP.

In Step 3, the UE may identify whether the number of lengths of DCI formats 1), 2), 3), 4), 5), and 6) is no more than three. For example, Step 3 may be as follows.

In Step 3, the UE identifies whether the number of DCI formats having different lengths exceeds three. If the number of DCI formats (DCI size A/B/C/D/E/F) having different lengths does not exceed three, the UE may determine that the length of the DCI format is successfully determined. If not, the UE needs to perform the following additional process to adjust the number of DCI formats to be three or less.

Step 4 may be performed as follows.

In Step 4A, if there is a 1-bit padding bit in DCI format 0_1 in the UE-specific search space or DCI format 1)1 in the UE-specific search space in step 2, the UE truncates the 1-bit padding bit. Then, the UE adjusts the length of DCI format 0_0/1_0 in the UE-specific search space to be same as the length of DCI format 0_0/1_0 in the common search space. That is, the UE makes DCI size B and DCI size A be identical to each other (DCI size B=DCI size A). To this end, the UE adjusts the length of DCI format 0_0 in the UE-specific search space according to the size of the initial UL BWP. In addition, if there is CORESET0 is configured, the UE adjusts the length of DCI format 1_0 in the UE-specific search space according to the size of CORESET0, and if CORESET0 is not configured, the UE adjusts the length of DCI format 1_0 according to the initial DL BWP. In addition, if the length of DCI format 0_0 in the UE-specific search space is greater than that of DCI format 1_0 in the UE-specific search space, the UE truncates an MSB of an FDRA field of DCI format 0_0 in the UE-specific search space to make the length of DCI format 0_0 be same as that of DCI format 1_0. On the other hand, if the length of DCI format 0_0 in the UE-specific search space is smaller than that of DCI format 1_0 in the UE-specific search space, the UE performs zero-padding for DCI format 0_0 in the UE-specific search space to make the length of DCI format 0_0 be same as that of DCI format 1_0.

In Step 4B, the UE identifies whether the number of DCI formats having different lengths exceeds three after Step 4A. If the number of DCI formats (DCI size A/B/C/D/E/F) having different lengths exceeds three, the UE performs the following process. The UE adjusts the length of DCI format 0_2 in the UE-specific search space to be same as that of the length of DCI 1_2 in the UE-specific search space. In this case, the UE adds “0” until the length of a DCI format having the shortest length is to be identical to the length of a DCI format having the longest length, so as to adjust the different lengths to be identical.

In Step 4C, the UE identifies whether the number of DCI formats having different lengths exceeds three after Step 4B. If the number of DCI formats (DCI size A/B/C/D/E/F) having different lengths exceeds three, the UE performs the following process. The UE adjusts the length of DCI format 0_1 in the UE-specific search space to be same as that of the length of DCI 1_1 in the UE-specific search space. In this case, the UE adds “0” until the length of a DCI format having the shortest length is to be identical to the length of a DCI format having the longest length, so as to adjust the different lengths to be identical.

The UE may determine DCI formats having a maximum of three different lengths by performing the steps above.

In the steps above, the length of the FDRA field of DCI format 0_0, DCI format 0_1, or DCI format 0_2 scheduling the PUSCH may not be determined according to the active UL BWP. For example, in Steps 4 and 4A, the FDRA field of DCI format 0_0 in the UE-specific search space may be determined according to the initial UL BWP rather than the active UL BWP. Accordingly, when the UE has received DCI format 0_0 in the UE-specific search space in the active UL BWP, the method of interpreting the FDRA field of the DCI format may be a problem.

If the FDRA field of DCI format 0_0, DCI format 0_1, or DCI format 0_2 scheduling the PUSCH is greater than the number of bits required the active UL BWP, necessary bits among the FDRA field may be used to be interpreted as frequency domain resource assignment information.

If the FDRA field of DCI format 0_0, DCI format 0_1, or DCI format 0_2 scheduling the PUSCH is smaller than the number of bits required the active UL BWP, bits among the FDRA field may be insufficient to be used as frequency domain resource assignment information of the active UL BWP. If the number of bits of the FDRA field is not sufficient, smooth communication is impossible, and thus a communication protocol between the UE and the base station needs to be specified to solve the problem.

2.2. Ambiguity in FDRA Field According to BWP Switching

In the 3GPP NR system, the UE may perform transmission or reception by using a bandwidth equal to or smaller than that of a carrier (or cell). To this end, a bandwidth part (BWP) including some consecutive bandwidths among bandwidths of the carrier may be configured for the UE. A maximum of four DL/UL BWP pairs may be configured for the UE operating according to TDD or operating in the unpaired spectrum in one carrier (cell). In addition, the UE may active one DL/UL BWP pair. A maximum of four DL BWPs may be configured for the UE operating according to FDD or operating in the paired spectrum in a downlink carrier (cell), and a maximum of four UL BWPs may be configured for the UE in an uplink carrier (cell). The UE may activate a DL BWP and an UL BWP for each carrier (or cell). The UE may not perform reception or transmission in a time-frequency resource other than the activated BWP. The activated BWP may be referred to as an active BWP.

The base station may indicate an activated BWP among BWPs among configured BWPs to the UE through downlink control information (DCI). The BWP indicated through the DCI is activated, and the other configured BWP(s) are deactivated. In a carrier (or cell) operating according to TDD, to switch the DL/UL BWP pair of the UE, the base station may include, in DCI scheduling a PDSCH or a PUSCH, a bandwidth part indicator (BPI) indicating an activated BWP. The UE may receive the DCI scheduling the PDSCH or the PUSCH, and identify the activated DL/UL BWP pair, based on the BPI. In a case of a downlink carrier (or cell) operating according FDD, to switch the DL BWP of the UE, the base station may include, in DCI scheduling a PDSCH, a BPI indicating an activated BWP. In a case of an uplink carrier (or cell) operating according FDD, to switch the UL BWP of the UE, the base station may include, in DCI scheduling a PUSCH, a BPI indicating an activated BWP.

Different numbers of RBs and RB sets and different numerologies (SCS and CP type) may be configured for each BWP. The length of an FDRA field included in a DCI format may vary according to the number of RBs, the number of RB sets, or SCS. Accordingly, the lengths of the FDRA field included in the DCI format scheduling the PDSCH or PUSCH may be different in different BWPs.

In the NR system, the UE may acquire the length of the FDRA field according to the RBs, the RB sets, and SCS of the active UL BWP, and monitor a DCI format including the FDRA field. In other words, when the BPI of the DCI format scheduling the PUSCH activates a UL BWP other than the active UL BWP, the number of bits of the FDRA field may not be identical to that of the active UL BWP.

For example, when SCS of the active UL BWP is 30 kHz, the FDRA field may include X=5 bits to indicate the interlace of the active UL BWP. When the BPI of the DCI format activates a UL BWP having 15 kHz SCS, X=6 bits are required to indicate the interlace of the UL BWP. Accordingly, there is a shortage of 1 bit.

For example, when the active UL BWP includes N RB sets, the FDRA field may include Y=ceil(log 2(N*(N+1)/2)) bits to indicate the RB sets of the active UL BWP. When the BPI of the DCI format activates a UL BWP having N′ RB sets, Y=ceil(log 2(N′*(N′+1)/2)) are required to indicate the RB sets of the UL BWP.

Accordingly, when N′ is greater than N, there may be a shortage of bits.

3. Embodiment for Solving Ambiguity in FDRA Field

3.1 Truncation of X or Y

It is assumed that for frequency domain resource assignment by the UE, Z=(X+Y) bits are required as the length of an FDRA field. Here, X may indicate one or more interlaces. When SCS of an UL BWP is 15 kHz, X may be 6 bits (X=6 bits), and when SCS is 30 kHz, X may be 5 bits (X=5 bits). Y may indicate one or multiple RB sets among RB sets of the UL BWP. When the UL BWP includes M RB sets, Y may be ceil(log 2(M*(M+1)/2)) bits (Y=ceil(log 2(M*(M+1)/2)) bits).

The length of the FDRA field may be less than Z bit(s). This may be a result of reducing, by the base station, the length of the FDRA field for DCI size alignment, as described above. It is assumed that the length of the FDRA, actually received by the UE through DCI transmitted from the base station, is Z′ bits. In other words, Z may be greater than Z′ (Z′<Z). In this case, the UE may use X′ bits among Z′ bits to identify one or more interlaces, and may use Y′ bits to identify one or multiple RB sets among RB sets constituting the UL BWP. Here, X′+Y′=Z′ may be satisfied, and a method for obtaining X′ and Y′ among Z′ bits, a method for interpreting X′ bits, and a method for interpreting Y′ are required. For reference, if X′=X is satisfied, the method for indicating one or more interlaces may be used without change. In addition, for reference, if Y′=Y is satisfied, the method for indicating one or multiple RB sets among the RB sets constituting the UL BWP may be used without change. Accordingly, an additional interpretation method is required only for a case of X′<X or Y′<Y.

As an embodiment of the disclosure, a method for obtaining X′ and Y′ among Z′ bits is as follows.

For example, the UE may obtain Y′ bits by maintaining X′=X and truncating Y bits. Here, the UE may generate Y′ bits by truncating (Z−Z′) bits from Y bits. If (Z−Z′) bits are greater than Y bits (that is, if (Z−Z′)>Y), Y bits are 0 bit, and the UE may additionally truncate X bits. Here, (Z−Z′−Y) bits may be truncated from X bits.

In another example, the UE may obtain X′ bits by maintaining Y′=Y and truncating X bits. Here, the UE may obtain X′ bits by truncating (Z−Z′) bits from X bits. If (Z−Z′) bits are greater than X bits (that is, if (Z−Z′)>X), X bits are 0 bit, and the UE may additional truncate Y bits. Here, (Z−Z′−X) bits may be truncated from Y bits.

In another example, the UE may obtain X′ bits by truncating n bit(s) from X bits, and obtain Y′ bits by truncating k bit(s) from Y bits. Here, Z−Z′=n+k. By using a method for obtaining n and k which are non-negative integers, Z−Z′ may be at most equally divided into n and k. For example, n may be determined through at least one of n=floor((Z−Z′)/2), n=ceil((Z−Z′)/2), and n=round((Z−Z′)/2). k may be determined through k=Z−Z′−n.

The truncation above may be performed for the MSB of each DCI field (for each of X bits and Y bits). When the truncation is performed for the MSB of X bits, it may be interpreted that one or more interlaces are indicated after X bits are obtained by padding an (X−X′)-bit zero to the MSB of X′ bits. When the truncation is performed for the MSB of Y bits, it may be interpreted that one or multiple RB sets among the RB sets constituting the UL BWP are indicated after Y bits are obtained by padding a (Y−Y′)-bit zero to the MSB of Y′ bits.

3.2 Case where X Bits are Truncated and X′<X

As an embodiment of the disclosure, in a situation where X′ bits are obtained after some of X bits are truncated, X′ bits may be interpreted as follows.

The UE may generate an interlace group by grouping interlaces. Each interlace group may be indicated by X′ bits. Here, when grouping the interlaces, the UE may group adjacent interlaces. Here, the adjacent interlaces mean interlaces which are adjacent to each other in the frequency domain. First, the number of interlace groups may be determined on the basis of SCS as follows.

For example, when SCS is 15 kHz, the number of interlace groups which can be indicated by X′ bits may be determined,

An N value satisfying ceil(log 2(N*(N+1)/2)≤X′<ceil(log 2((N+1)*(N+2)/2) may be a maximum number of interlace groups which can be indicated by X′ bits. For reference, if X′=6 bits, N=10. Therefore, ten interlaces may be indicated by X′=6 bits without a separate interlace group. If X′=5 bits, N=7. Therefore, ten interlaces may be grouped into seven interlace groups so that an index of each of the groups is indicated by X′=5 bits. If X′=4 bits, N=5. Therefore, ten interlaces may be grouped into five interlace groups so that an index of each of the groups is indicated by X′=4 bits. If X′=3 bits, N=3. Therefore, ten interlaces may be grouped into three interlace groups so that an index of each of the groups is indicated by X′=3 bits. If X′=2 bits, N=2. Therefore, ten interlaces are grouped into two interlace groups so that an index of each of the groups is indicated by X′=2 bits. If X′=1 bit or X′=0 bit, N=1. Therefore, ten interlaces are grouped into one interlace group so that an index of the group is indicated by X′=1 bit or X′=0 bit.

In another example, if SCS is 30 kHz, the number of interlace groups which can be indicated by X′ bits may be determined. The UE may generate X′ interlace groups by grouping five interlaces, wherein each of the X′ interlace groups is indicated when each of X′ bits is 1. Each of the X′ interlace groups is not indicated when each of X′ bits is 0.

A method for grouping A interlaces into B interlace groups is as follows.

For example, the UE may generate one interlace group by grouping ceil(A/B) interlaces. The UE may then generate (B−1) interlace groups, wherein the last interlace group may have (A−ceil(A/B)*(B−1)) interlaces. As another embodiment, the UE may generate (B mod A) interlace groups by grouping ceil(A/B) interlaces, and generate (B−(B mod A)) interlace groups by grouping floor(AB) interlaces. When grouping the interlaces into interlace groups, the UE may group interlaces, which are adjacent to each other in the frequency domain, into an interlace group if possible. In another example, the UE may group interlaces, which are far away from each other in the frequency domain, into an interlace group if possible.

In another example, when grouping interlaces, the UE may group interlaces, which are far away from each other in the frequency domain, if possible, so as to acquire the maximum frequency diversity. For example, in a case where there are ten interlaces, X′=4 bits are smaller than X=6 bits, and interlace groups need to be configured to perform resource assignment by using five interlace groups, if there are ten interlaces having interlace indices such as {0,1,2,3,4,5,6,7,8,9} in the order of frequency on the frequency domain, the interlace groups are configured as five groups of {0,5}, {1,6}, (2,7), {3,8}, and {4,9} so that interlaces which are far away from each other on the frequency domain can be grouped if possible, and the UE can receive the resource assignment from the base station according to the corresponding X′ bits.

Next, a method for determining bits of an FDRA field is disclosed.

For example, in a process of adjusting a maximum number of DCI format lengths to three, bits of the FDRA field may be determined as follows.

In Steps 4 and 4A of adjusting a maximum number of DCI format lengths to three, a process of adjusting the length of DCI format 0_0 in the UE-specific search space to match the same to the length of DCI format 0_0/1_0 in the common search space is performed. In this process, the length of the FDRA field of DCI format 0_0 in the UE-specific search space may be determined according to the initial UL BPW rather than the active UL BWP. To indicate an interlace of the active UL BWP, for X bits of the FDRA field of DCI format 0_0 in the UE-specific search space, 6 bits are required when the active UL BWP is 15 kHz, and 5 bits are required when the active UL BWP is 30 kHz. In addition, to indicate the RB set of the active UL BWP, for Y bits of the FDRA field of DCI format 0_0 in the UE-specific search space, ceil(log 2(N*(N+1)/2)) bits are required. Here, N is the number of RB sets of the active UL BWP.

However, in Steps 4 and 4A, X bits of the FDRA field of DCI format 0_0 in the UE-specific search space is identical to the number of bits for indicating the initial UL BWP interlace. For example, the bits are 6 bits when the initial UL BWP is 15 kHz, and 5 bits when the initial UL BWP is 30 kHz. In Steps 4 and 4A, for Y bits of the FDRA field of DCI format 0_0 in the UE-specific search, ceil(log 2(N′*(N′+1)/2)) bits are required to indicate the RB set of the initial UL BWP. Here, N′ is the number of RB sets of the initial UL BWP.

For example, when the active UL BWP is 15 kHz, X=6 bits are required to receive indication of the interlace of the active UL BWP, but when the active UL BWP is 30 kHz, there are only X′=5 bits corresponding to the number of bits for receiving indication of the interlace of the initial UL BWP.

To solve this problem, the UE may obtain, in Steps 4 and 4A, X bits of the FDRA field in the UE-specific search space on the basis of SCS of the active UL BWP. That is, the X bits of the FDRA field in the UE-specific search space are 6 bits when the active UL BWP is 15 kHz, and are 5 bits when the active UL BWP is 30 kHz.

Accordingly, when the length of X bits of the FDRA field of DCI format 0_0 in the UE-specific search space is obtained on the basis of SCS of the active UL BWP in Steps 4 and 4A, the length (that is, both X bits and Y bits) of the FDRA field of DCI format 0_0 in the UE-specific search space may be a value smaller or greater than DCI format 0_0/1_0 in the common search space. For adjustment to the identical length, some of Y bits may be truncated or some bits may be added.

3.3. Case where Y Bits are Truncated and Y′<Y

A bit size indicating an RB set in an FDRA of a DCI format for uplink transmission, received from the base station is smaller than a bit size required to indicate all combinations of one or multiple RB sets among RB sets constituting a UL BWP, the UE may perform the following operation.

For convenience of description, it is assumed that the bit size indicating one or multiple RB sets among RB sets in the FDRA field of the DCI format received from the base station is Y′, and the bit size required to indicate all combinations of one or multiple RB sets among the RB sets constituting the UL BWP is Y. As mentioned above, Y=ceil(log 2(N*(N+1)/2)). Here, N is the number of RB sets constituting a UL BWP in which an uplink channel is scheduled. For example, Y′ bits are determined as follows.

Method 1 (UL BWP switching): When the DCI format includes an indication of active UL BWP switching of the UE, Y′ bits are determined on the basis of a UL BWP before the switching. More specifically, Y′ bits are determined according to Y′=ceil(log 2(N′*(N′+1)/2)). Here, N′ is the number of RB sets included in the UL BWP before the switching.

Method 2 (DCI size alignment): For DCI size alignment of the DCI format, the length of each DCI field may be truncated. In this case, Y′ bits correspond to a value determined according to the DCI size alignment.

In the disclosure, a case where the determined Y′ bits are smaller than the required Y bits is described, as in the two methods above. An embodiment of the disclosure is applicable to both methods, without separately distinguishing the methods. If the methods need to be separately distinguished from each other, a separate embodiment for each of the methods may be included.

The UE may determine RB set(s) an UL BWP for uplink transmission on the basis of an RB set having received a DCI format, among one or multiple RB sets of a DL BWP. The UE may determine an RB set having received the DCI format, by using frequency assignment information of the RB set(s) of the DL BWP and frequency assignment information of a CORESET in which the DCI format is received. The UE may determine one or more RB sets among the RB sets of the UL BWP by using the determined RB set of the DL BWP. Here, the RB set of the UL BWP may be an RB set(s) completely or partially overlapping with the determined RB set of the DL BWP. This RB set is called an overlapping RB set. There may be no RB set of the UL BWP, which overlaps with the determined RB set of the DL BWP. In this case, it is considered that there is no overlapping RB set.

If the CORESET in which the UE has received the DCI format overlaps with the multiple RB sets of the DL BWP, the UE may determine one of the multiple RB sets by using frequency information. For example, the UE may determine that an RB set having the lowest frequency is an RB set having received the DCI format. For example, the UE may determine that an RB set having the highest frequency is an RB set having received the DCI format. For example, the UE may determine that an RB set overlapping with the CORESET in which the DCI format has been received in the largest area in the frequency domain is an RB set having received the DCI format.

As another method, the UE may determine RB set(s) of the UL BWP for uplink transmission on the basis of a CORESET in which a DCI format is received. The UE may determine one or more RB sets overlapping with the CORESET, among the RB set(s) of the UL BWP by using frequency assignment information of the RB set(s) of the UL BWP and frequency assignment information of the CORESET in which the DCI format is received. Here, the RB set of the UL BWP may be an RB set(s) overlapping with the determined CORESET. This RB set(s) is called an overlapping RB set. There may be no RB set of the UL BWP, which overlaps with the determined RB set of the DL BWP. In this case, it is considered that there is no overlapping RB set.

If the CORESET in which the UE has received the DCI format overlaps with the multiple RB sets of the UL BWP, the UE may determine one of the multiple RB sets by using frequency information. For example, the UE may determine that an RB set having the lowest frequency is an RB set overlapping with the CORESET. For example, the UE may determine that an RB set having the highest frequency is an RB set overlapping with the CORESET. For example, the UE may determine that an RB set overlapping with the CORESET in which the DCI format has been received in the largest area in the frequency domain is an RB set overlapping with the CORESET.

As another method, the UE may determine RB set(s) of the UL BWP for uplink transmission on the basis of a control channel element (CCE), a resource element group (REG), or PRBs of a PDCCH in which the DCI format is received. The UE may determine one or more RB sets overlapping with the PDCCH in which the DCI format is received, among the RB set(s) of the UL BWP by using frequency information of the RB set(s) of the UL BWP and information on the CCE/REG/PRB of the PDCCH in which the DCI format is received. Here, the RB set of the UL BWP may be an RB set(s) overlapping with the determined PDCCH. This RB set(s) is called an overlapping RB set. There may be no RB set of the UL BWP, which overlaps with the determined RB set of the DL BWP. In this case, it is considered that there is no overlapping RB set.

If the PDCCH in which the UE has received the DCI format overlaps with the multiple RB sets of the UL BWP, the UE may determine one of the multiple RB sets by using frequency information. For example, the UE may determine that an RB set having the lowest frequency is an RB set overlapping with the PDCCH. For example, the UE may determine that an RB set having the highest frequency is an RB set overlapping with the PDCCH. For example, the UE may determine that an RB set overlapping with the PDCCH in which the DCI format has been received in the largest area in the frequency domain is an RB set overlapping with the PDCCH.

If there is no overlapping RB set, the UE may determine that bits (Y′ bits) indicating the RB set in the FDRA field of the received DCI format indicate one or multiple RB sets among the RB sets of the UL BWP. A detailed scheme is as follows.

For example, the UE may select at least one value among bits (Y′ bits) indicating the RB set in the FDRA field of the received DCI format from among the RB sets of the UL BWP, and determine that the at least one value indicates the lowest RB set in the frequency domain. The RB sets of the UL BWP may be indexed in an ascending order of the frequency. In this case, the UE may determine that at least one value of the bits (Y′ bits) indicating the RB set in the FDRA field of the received DCI format indicates RB set #0 of the UL BWP. In addition, the UE may determine that at least one value of the bits (Y′ bits) indicating the RB set in the FDRA field of the received DCI format indicates the highest RB set in the frequency domain.

In another example, the UE may select at least one value among bits (Y′ bits) indicating the RB set in the FDRA field of the received DCI format from among the RB sets of the UL BWP, and determine that the at least one value indicates the closest RB set from the RB set having received the DCI format in the DL BWP. Here, the closeness may be determined in the frequency domain. For example, the UE may determine that the at least one value indicates the closest RB set from the frequency (the center frequency, the lowest frequency, or the highest frequency) of the RB set having received the DCI format in the DL BWP, among frequencies (the center frequencies, the lowest frequencies, or the highest frequencies) of the RB sets of the UL BWP. For reference, when there are multiple closest RB sets, the UE may determine the RB set having the lowest frequency. Alternatively, when there are multiple closest RB sets, the UE may determine the RB set having the highest frequency.

In another example, the UE may select at least one value among bits (Y′ bits) indicating the RB set in the FDRA field of the received DCI format from among the RB sets of the UL BWP, and determine that the at least one value indicates one of the overlapping RB sets among the RB sets of the DL BWP. Here, when there are multiple RB sets of the UL BWP, which overlap with the RB sets of the DL BWP, among the RB sets of the UL BWP, the UE may determine that the at least one value indicates an RB set of the UL BWP, which has the lowest frequency, among the multiple RB sets. In addition, when there are multiple RB sets of the UL BWP, which overlap with the RB sets of the DL BWP, among the RB sets of the UL BWP, the UE may determine that the at least one value indicates an RB set of the UL BWP, which has the highest frequency, among the multiple RB sets.

In another example, in a case of Method 1 (UL BWP switching), the UE may select at least one value among bits (Y′ bits) indicating the RB set in the FDRA field of the received DCI format from among the RB sets of the UL BWP, and determine that the at least one value indicates one of overlapping RB sets among the RB sets of the UL BWP before the switching. Here, when there are multiple RB sets of the UL BWP after the switching, which overlap with the RB sets of the UL BWP, among the RB sets of the UL BWP before the switching, the UE may determine that the at least one value indicates an RB set of the UL BWP after the switching, which has the lowest frequency, among the multiple RB sets. In addition, there are multiple RB sets of the UL BWP after the switching, which overlap with the RB sets of the UL BWP, among the RB sets of the UL BWP before the switching, the UE may determine that the at least one value indicates an RB set of the UL BWP after the switching, which has the highest frequency, among the multiple RB sets.

If there is an overlapping RB set, the UE may determine that at least one of the bits indicating the RB set in the FDRA field of the received DCI format indicates the overlapping RB set. If the overlapping RB set includes multiple RB sets, the UE may determine one RB set as follows.

For example, when the overlapping RB set includes multiple RB sets, the UE may select one RB set on the basis of frequency information of the multiple RB sets. For example, the UE may select an RB set having the lowest frequency information. In addition, the UE may select an RB set having the highest frequency information.

In another example, when the overlapping RB set includes multiple RB sets, the UE may select one RB set on the basis of frequency information of the multiple RB sets and frequency information of the PDCCH in which the DCI format is transmitted. For example, the UE may select an RB set overlapping with the PDCCH in which the DCI format is transmitted in the largest area in the frequency domain, from among the multiple RB sets. In another example, the overlapping RB set may include an RB set which overlaps with (or which is closest from) a specific frequency of the PDCCH in which the DCI format is transmitted, among the multiple RB sets. For example, the overlapping RB set may include an RB set which overlaps with (or which is closest from) the lowest frequency of the PDCCH in which the DCI format is transmitted, among the multiple RB sets. Alternatively, the overlapping RB set may include an RB set which overlaps with (or which is closest from) the highest frequency of the PDCCH in which the DCI format is transmitted, among the multiple RB sets.

In another example, when the overlapping RB set includes multiple RB sets, the UE may select one RB set on the basis of frequency information of the multiple RB sets and frequency information of the RB set in which the DCI format is transmitted. For example, the UE may select an RB set overlapping with the RB set in which the DCI format is transmitted in the largest area in the frequency domain, from among the multiple RB sets. In another example, the overlapping RB set may include an RB set which overlaps with (or which is closest from) a specific frequency of the RB set in which the DCI format is transmitted, among the multiple RB sets. For example, the overlapping RB set may include an RB set which overlaps with (or which is closest from) the lowest frequency of the RB set in which the DCI format is transmitted, among the multiple RB sets. Alternatively, the overlapping RB set may include an RB set which overlaps with (or which is closest from) the highest frequency of the RB set in which the DCI format is transmitted, among the multiple RB sets.

In the embodiments above, it is considered that an RB set of the UL BWP which can be indicated by at least one value among bits (Y′ bits) indicating the RB set in the FDRA field of the DCI format received by the UE is a designated RB set.

In this case, with respect to the bits (Y′ bits) indicting the RB set in the FDRA field of the DCI format received by the UE, the number of combinations of RB set(s) which can be indicated may be determined according to the length corresponding to the bits. If the length corresponding to the bits (Y′ bits) indicating the RB set in the FDRA field of the received DCI format is 0 bit, the UE may determine that the RB set always indicates the designated RB set. For example, if Y′=2 bits is given, the 2 bits may have values of 00, 01, 10, and 11. Accordingly, if Y′=2 bits is given, a combination of a maximum of four RB set(s) may be indicated. Normally, if Y′ bit is given, the number of a maximum of 2\hat{ }Y′ RB set(s) may be indicated. One of the 2\hat{ }Y RB set(s) may mandatorily indicate the designated RB set. A method for determining a combination of the remaining (2\hat{ }Y′−1) RB set(s) is as follows.

For example, a combination of 2\hat{ }Y′ RB set(s) indicated by Y′ bits may be determined as follows. First, the UE may select the designated RB set and RB sets of the UL BWP, which are adjacent to the designated RB set. The combination of 2\hat{ }Y′ RB set(s) indicated by the Y′ bits may be a combination of adjacent RB sets among the RB sets of the UL BWP, which are selected as described above. Here, the adjacency is defined in the frequency domain. RB sets indicated by the combination of 2\hat{ }Y′ RB set(s) are not apart from each other in the frequency domain. The Y′ bits may indicate the designated RB set and adjacent RB sets among the RB sets adjacent to the designated RB set in the frequency domain. The combination of 2\hat{ }Y′ RB set(s) may indicate the designated RB and adjacent RB set(s) used for uplink among the RB sets adjacent to the designated RB set in the frequency domain. The designated RB set may be determined through the embodiment above. However, a method for obtaining RB sets adjacent to the designated RB set in the frequency domain is required. Specifically, a method for determining the order of the RB sets according to the adjacency is as follows.

In an aspect, the order of the RB sets which can be indicated by the 2\hat{ }Y′ RB set(s) indicated by the Y′ bits is the order of the designated RB set and the RB sets which are the most adjacent to the designated RB set, among the RB sets having higher frequencies than the designated RB set. For example, it is assumed that RB set indices of the UL BWP are given as RB set #0, RB set #1, RB set #2, and RB set #3 according to an ascending order of the frequency. If the designated RB set is RB set #1, an RB set which is the most adjacent to the designated RB set among the RB sets having higher frequencies than the designated RB set is RB set #2, and the second most adjacent RB set is RB set #3. However, in this case, RB set #0 has a lower frequency than RB set #1 and is thus not included in the combination of the 2\hat{ }Y′ RB set(s).

In another aspect, the order of the RB sets which can be indicated by the 2\hat{ }Y′ RB set(s) indicated by the Y′ bits is the order of the designated RB set and the RB sets which are the most adjacent to the designated RB set, among the RB sets having lower frequencies than the designated RB set. For example, it is assumed that RB set indices of the UL BWP are given as RB set #0, RB set #1, RB set #2, and RB set #3 according to an ascending order of the frequency. If the designated RB set is RB set #1, an RB set which is the most adjacent to the designated RB set among the RB sets having lower frequencies than the designated RB set is RB set #0. However, in this case, RB set #2 and RB set #3 have higher frequencies than RB set #1 and are thus not included in the combination of the 2\hat{ }Y′ RB set(s).

In another aspect, the order of the RB sets which can be indicated by the 2\hat{ }Y′ RB set(s) indicated by the Y′ bits is the order of the designated RB set and the RB sets which are the most adjacent to the designated RB set among the RB sets having higher frequencies than the designated RB set, and subsequently, is the order of the RB sets which are the most adjacent to the designated RB set among the RB sets having lower frequencies than the designated RB set. For example, it is assumed that RB set indices of the UL BWP are given as RB set #0, RB set #1, RB set #2, and RB set #3 according to an ascending order of the frequency. If the designated RB set is RB set #1, an RB set which is the most adjacent to the designated RB set among the RB sets having higher frequencies than the designated RB set is RB set #2, and the second most adjacent RB set is RB set #3. Subsequently, the third most adjacent RB set is RB set #0 having a lower frequency than RB set #1.

In another aspect, the order of the RB sets which can be indicated by the 2\hat{ }Y′ RB set(s) indicated by the Y′ bits is the order of the designated RB set and the RB sets which are the most adjacent to the designated RB set among the RB sets having lower frequencies than the designated RB set, and subsequently, is the order of the RB sets which are the most adjacent to the designated RB set among the RB sets having higher frequencies than the designated RB set. For example, it is assumed that RB set indices of the UL BWP are given as RB set #0, RB set #1, RB set #2, and RB set #3 according to an ascending order of the frequency. If the designated RB set is RB set #1, an RB set which is the most adjacent to the designated RB set among the RB sets having lower frequencies than the designated RB set is RB set #0. RB set #2 having a higher frequency than RB set #1 is the second most adjacent RB set, and RB set #4 is the third most adjacent RB set.

In another aspect, the combination of 2\hat{ }Y′ RB set(s) indicated by the Y′ bits is a combination of the designated RB set and RB sets having close frequencies from the designated RB set. For example, here, the frequency may include at least one of the center frequency of the RB set, the lowest frequency of the RB set, and the highest frequency of the RB set. When there are multiple RB sets which are close to the designated RB set, the UE may select one RB set according to the frequency of the RB set. For example, the UE may determine that an RB set having a lower frequency is an RB set closer to the designated RB set. For example, the UE may determine that an RB set having a higher frequency is an RB set closer to the designated RB set. For example, it is assumed that RB set indices of the UL BWP are given as RB set #0, RB set #1, RB set #2, and RB set #3 according to an ascending order of the frequency. It is also assumed that each RB set occupies 20 MHz and the center frequency is used as the frequency. If the designated RB set is RB set #1, the closest RB sets from the designated RB set are RB set #0 and RB set #2. The UE may determine one of RB set #0 and RB set #2 as a closer RB set. For example, the UE may determine that an RB set having a lower frequency among the two RB sets is a closer RB set. In this case, the closest RB set from the designated RB set is RB set #0, and the second closest RB set is RB set #2. In addition, the third closest RB set is RB set #3. According to an example, this embodiment is identical to a case where the order is alternately determined between the most adjacent RB set having a low frequency and the most adjacent RB set having a high frequency with reference to the designated RB set.

In the embodiments above, the order is determined according to the adjacency of RB sets included in the combination of 2\hat{ }Y RB set(s) indicated by Y′ bits. The UE may select RB sets on the basis of the order of the adjacency. A maximum number (hereinafter, referred to as “M”) of RB set(s) included in the combination may be determined according to Y′. The UE may determine M RB sets included in the combination of 2\hat{ }Y RB set(s). Here, one of the M RB sets is mandatorily a designated RB set, and the remaining (M−1) RB sets are RB sets adjacent to the designated RB set.

For example, if Y′=2 bit, the UE may include a maximum of M=2 RB sets. This is because ceil(log 2(M*(M+1)/2))=ceil(log 2(2*(2+1)/2))=2 is satisfied and Y′=2 or smaller, but in a case of M=3 RB sets, ceil(log 2(M*(M+1)/2))=ceil(log 2(3*(3+1)/2))=3 is satisfied and Y′=2 or greater. Normally, the maximum number M of RB set(s) which can be indicated by Y′ bit is the largest value among values of integer M satisfying ceil(log 2(M*(M+1)/2))≤Y′.

For example, in case of Step 1 (UL BWP switching), M may be determined as the number of RB sets included in the UL BWP before switching. As described above, in case of Step 1 (UL BWP switching), Y′ is determined according to ceil(log 2(M*(M+1)/2)), and thus the Y′ bits may indicate adjacent RB sets used for scheduling, among M RB sets.

For example, a bit size (Y′ bits) indicating the RB set in the FDRA field of the DCI format received by the UE has a value smaller than a bit size (Y bits) required to indicate the RB set of the UL BWP and all the Y′ bits are 0, the UE may determine that a designated RB set is indicated. If all the Y′ bits are not 0, the following interpretation can be applied.

In an aspect, Y bits are obtained by padding (Y−Y′)-bit zero to the MSB of the Y′ bits. The indicated RB set(s) among the RB set(s) of the UL BWP may be determined by interpreting that the Y bits are Y bits indicating the RB set of the UL BWP.

In another aspect, it is assumed that M virtual RB set(s) are virtual RB-set #0, virtual RB-set #1, . . . , and virtual RB-set #(M−1). Here, M may be one of values of integer M satisfying ceil(log 2(M*(M+1)/2))≤Y′. M may be also determined as the largest value. The indicated virtual RB sets(s) among the M virtual RB set(s) may be determined by Y′ bits. An actually scheduled RB set may be determined while assuming that index 0 of the virtual RB set determined to be indicated by Y′ bits is a designated RB set. For example, it is assumed that virtual RB set #1 and virtual RB set #2 are determined by Y′ bits and a designated RB set is RB set #1 of the UL BWP. In this case, RB set #1 of the UL BWP, which corresponds to the designated RB set, is considered as virtual RB set #0, and accordingly, virtual RB set #1 is RB set #2 of the UL BWP, and virtual RB set #2 is RB set #3 of the UL BWP.

The above-described embodiments may be selectively used according a situation. For example, when the bit size (Y′ bits) indicating the RB set in the FDRA field of the DCI format received by the UE has a value smaller than the bit size (Y bits) required to indicated the RB set of the UL BWP, any of the Y′ bit values does not indicate a designated RB set, and the Y′ bits correspond to a specific value, the UE may determine that the designated RB set is indicated. More specific embodiment is as follows.

For example, Y bits are obtained by padding a (Y−Y′)-bit zero to the MSB of the Y′ bits. The indicated RB set(s) among the RB set(s) of the UL BWP may be determined by interpreting that the Y bits are Y bits indicating the RB set of the UL BWP. The Y bits may indicate a combination of a maximum of 2\hat{ }Y RB set(s), but the MSB is fixed as 0, and thus only a maximum of 2\hat{ }Y′ values and a combination of 2\hat{ }Y′ RB set(s) may be indicated. Accordingly, the designated RB set may or may not be included in the combination of 2\hat{ }Y′ RB set(s). Therefore, if the designated RB set is not included in the combination of the RB set(s), the UE may interpret that one of 2\hat{ }Y′ values indicates the designated RB set. This value may correspond a case where all the Y′ values are 0. Alternatively, this value may correspond to a case where all the Y′ values are 1.

Possible combinations according to an embodiment of the disclosure are described below.

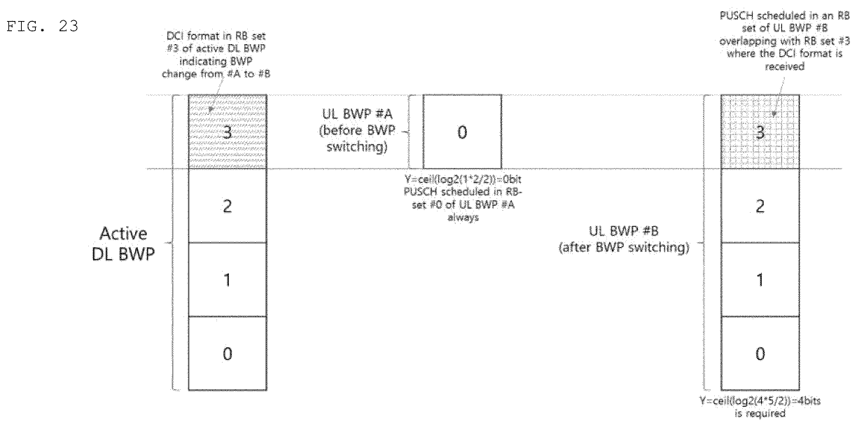

Scenario 1: As one of scenarios considered in the disclosure, referring to FIG. 23, the UE receives configuration of four RB sets (RB set #0, RB set #1, RB set #2, and RB set #3) in a DL BWP, wherein UL BWP #A includes one RB set (RB set #0 in UL BWP #A), and UL BWP #B includes four RB sets (RB set #0 in UL BWP #B, RB set #1 in UL BWP #B, RB set #2 in UL BWP #B, and RB set #3 in UL BWP #B). Here, an index of the RB set is determined according to each BWP (BWP-specifically). The UE may receive a DCI format in one RB set (e.g., RB set #3) of the DL BWP. Here, the DCI format may indicate changing of an active UL BWP from UL BWP #A to UL BWP #B, and a PUSCH may be scheduled in UL BWP B #. The DCI format may include Y′ bits for indicating the RB set of UL BWP #A before switching of the UL BWP. UL BWP #A includes one RB set, and thus Y′=ceil(log 2(1*2/2))=0 bit is satisfied. Accordingly, the DCI format includes Y′=0 to indicate the RB set. However, the UL BWP after switching, in which the PUSCH is scheduled, includes four RB sets, and thus Y=ceil(log 2(4*5/2))=4 bits are required to indicate RB sets in which the PUSCH is scheduled among the four RB sets. Accordingly, this scenario corresponds to a situation where Y′<Y. For reference, in this scenario, 2\hat{ }Y′=1 is satisfied, and the UE may receive an indication of only one designated RB set combination through Y′=0 bit of the DCI format.

Possible combination 1-1: The UE identifies whether there is an RB set overlapping with RB set #3 in which the DCI format is transmitted, in the frequency domain among RB sets of UL BWP #B after switching. Referring to FIG. 23, RB set #3 in UL BWP #B is an RB set overlapping in the frequency domain. Accordingly, the RB set in UL BWP #B may be determined as a designated RB set. This allows, when the base station successfully performs channel access for one or more specific RB set(s) on the unlicensed band, channel access at the UE to be simplified through sharing of a channel occupancy time (COT) configured by the base station with the UE for the RB set(s), and uplink transmission probability in terms of the channel access to be increased.

That is, when the UE performs transmission within a COT which is configured by the base station and can be indicated to the UE through group common signaling, the gNB performs COT sharing for the UE, and thus it is advantageous in that the UE can increase UL transmission possibility by using, as a channel access scheme, a simple Cat-2 scheme (a channel access scheme of performing channel access during a single interval) or No LBT scheme rather than a Cat-4 channel access scheme causing random backoff.

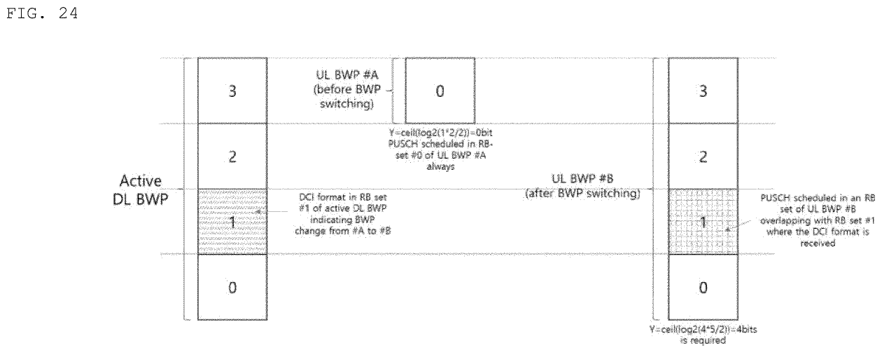

Possible combination 1-2: The DCI format is received in RB set #3 in possible combination 1-1. In addition, the RB set of the UL BWP before switching overlaps with RB set #3. According to an embodiment of the disclosure, a designated RB set may be determined using frequency domain information of the RB set of the UL BWP before switching. Referring to FIG. 24, the UE may receive the DCI format in RB set #1 of the DL DWP. This RB set #1 of the DL BWP does not overlap with the RB set of the UL BWP before switching. In this case, the UE identifies whether there is an RB set overlapping with RB set #1 in which the DCI format is transmitted, in the frequency domain among RB sets of UL BWP #B after switching. RB set #1 in UL BWP #B is an RB set overlapping in the frequency domain. Accordingly, RB set #1 in UL BWP #B may be determined as a designated RB set. This allows, when the base station successfully performs channel access for one or more specific RB set(s), channel access at the UE to be simplified through sharing of a COT configured by the base station with the UE for the RB set(s), and uplink transmission probability in terms of the channel access to be increased. That is, when the UE performs transmission within a COT which is configured by the base station and can be indicated to the UE through group common signaling, the gNB performs COT sharing for the UE, and thus it is advantageous in that the UE can increase UL transmission possibility by using, as a channel access scheme, a simple Cat-2 scheme or No LBT scheme rather than a Cat-4 channel access scheme causing random backoff.

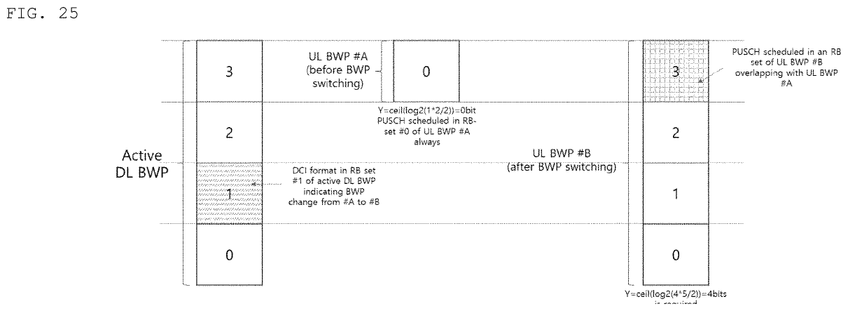

In another example, referring to FIG. 25, the UE identifies whether there is an RB set of UL BWP #3 after switching, which overlaps with an RB set of UL BWP #A before switching in the frequency domain. RB set #3 in UL BWP #B is an RB set overlapping in the frequency domain. Accordingly, RB set #3 in UL BWP #B may be determined as a designated RB set.

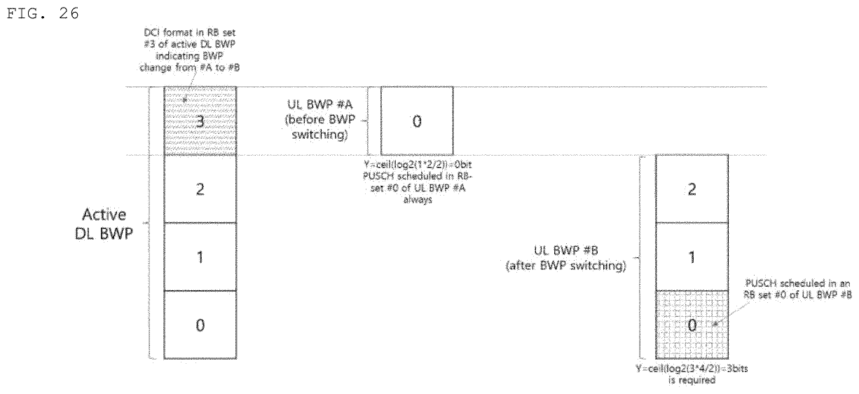

Scenario 2: As one of scenarios considered in the disclosure, referring to FIG. 26, the UE receives configuration of four RB sets (RB set #0, RB set #1, RB set #2, and RB set #3) in a DL BWP, wherein UL BWP #A includes one RB set (RB set #0 in UL BWP #A), and UL BWP #B includes three RB sets (RB set #0 in UL BWP #B, RB set #1 in UL BWP #B, and RB set #2 in UL BWP #B). Here, an index of the RB set is determined according to each BWP (BWP-specifically). The UE may receive a DCI format in one RB set (e.g., RB set #3) of the DL BWP. Here, the DCI format may indicate changing of an active UL BWP from UL BWP #A to UL BWP #B, and a PUSCH may be scheduled in UL BWP B #. The DCI format may include Y′ bits for indicating the RB set of UL BWP #A before switching of the UL BWP. UL BWP #A includes one RB set, and thus Y′=ceil(log 2(1*2/2))=0 bit is satisfied. Accordingly, the DCI format includes Y′=0 to indicate the RB set. However, the UL BWP after switching, in which the PUSCH is scheduled, includes three RB sets, and thus Y=ceil(log 2(3*4/2))=3 bits are required to indicate RB sets in which the PUSCH is scheduled among the three RB sets. Accordingly, this scenario corresponds to a situation where Y′<Y. For reference, in this scenario, 2\hat{ }Y′=1 is satisfied, and the UE may receive an indication of only one designated RB set combination through Y′=0 bit of the DCI format.

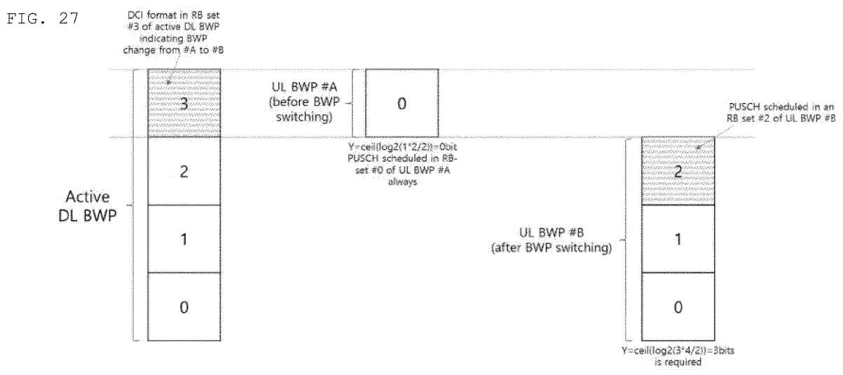

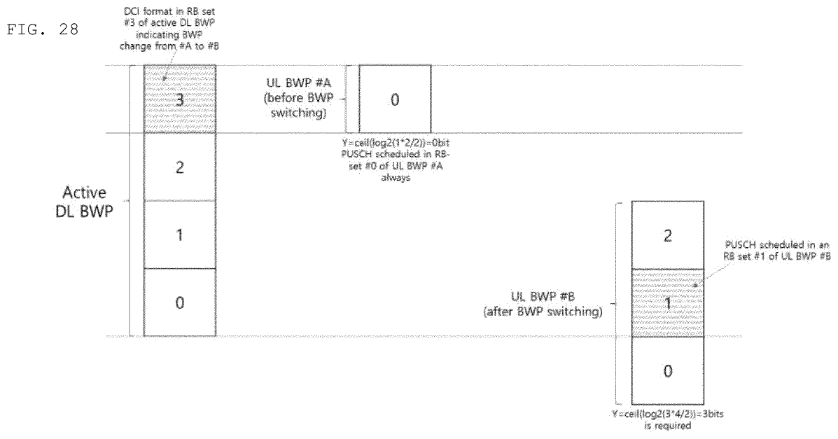

Possible combination 1-3: The UE identifies whether there is an RB set overlapping with RB set #3 in which the DCI format is transmitted, in the frequency domain among RB sets of UL BWP #B after switching. Referring to FIG. 26, all RB sets of UL BWP #B do not overlap with RB set #3 of the DL BWP, in which the DCI format is transmitted, in the frequency domain. Accordingly, the UE cannot obtain the RB set overlapping in the frequency domain, and needs to determine a designated RB set by using another method. As a method therefor, in FIG. 26, RB set #0 having the lowest frequency may be determined as a designated RB set. In FIG. 27, RB set #2 having the highest frequency may be determined as a designated RB set. In another example, referring to FIG. 28, RB set #1 having the lowest frequency among RB sets of the UL BWP overlapping with the DL BWP may be determined as a designated RB set.

In another example, an RB set of the UL BWP, which has the most adjacent frequency to RB set #3 of the DL BWP, in which the DCI format is transmitted, may be selected. Referring to FIG. 27, RB set #2 of the UL BWP after switching is most adjacent to RB set #3 of the DL BWP, the UE may determine RB set #2 of the UL BWP as a designated RB set. In a case where the RB set of the UL BWP, which has the most adjacent frequency to the RB set of the DL BWP, in which the DCI format is transmitted, is selected, there is high probability that RB sets of the DL BWP, which are most adjacent to the RB set of the DL BWP, in which the DCI format is transmitted, are RB set(s) in the DL BWP, for which channel access has been successfully performed, as Cat-2 scheme channel access is performed when downlink channel access is performed. Accordingly, when channel access has been successfully performed for the corresponding RB set(s), the base station can simplify channel access at the UE through COT sharing with the UE, thereby increasing uplink transmission possibility in terms of channel access. That is, when the UE performs transmission within a COT which can be indicated by the base station through group common signaling, the gNB performs COT sharing for the UE. Accordingly, it is advantageous in that the UE can increase UL transmission possibility by using, as a channel access scheme, a simple Cat-2 scheme or No LBT scheme rather than a Cat-4 channel access scheme causing random backoff.

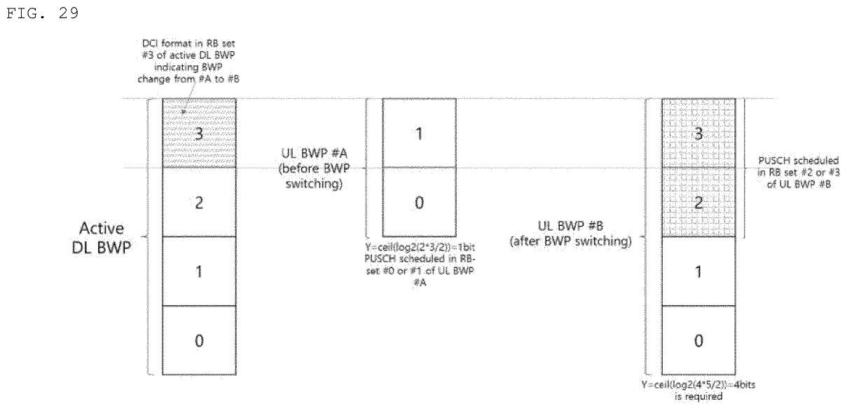

Scenario 3: As one of scenarios considered in the disclosure, referring to FIG. 29, the UE receives configuration of four RB sets (RB set #0, RB set #1, RB set #2, and RB set #3) in a DL BWP, wherein UL BWP #A includes two RB sets (RB set #0 in UL BWP #A and RB set #1 in UL BWP #A), and UL BWP #B includes four RB sets (RB set #0 in UL BWP #B, RB set #1 in UL BWP #B, RB set #2 in UL BWP #B, and RB set #3 in UL BWP #B). Here, an index of the RB set is determined according to each BWP (BWP-specifically). The UE may receive a DCI format in one RB set of the DL BWP. Here, the DCI format may indicate changing of an active UL BWP from UL BWP #A to UL BWP #B, and a PUSCH may be scheduled in UL BWP B #. The DCI format may include Y′ bits for indicating the RB set of UL BWP #A before switching of the UL BWP. UL BWP #A includes two RB sets, and thus Y′=ceil(log 2(2*3/2))=2 bits is satisfied. Accordingly, the DCI format includes Y′=2 bits to indicate the RB set. However, the UL BWP after switching, in which the PUSCH is scheduled, includes four RB sets, and thus Y=ceil(log 2(4*5/2))=4 bits are required to indicate RB sets in which the PUSCH is scheduled among the four RB sets. Accordingly, this scenario corresponds to a situation where Y′<Y. For reference, in this scenario, 2\hat{ }Y′=4 is satisfied, and the UE indicates a maximum of four RB set combinations through Y′=2 bits. One of the RB set combinations may include a designated RB set. In case of three RB sets, ceil(log 2(3*4/2))=3 bits is satisfied, exceeding Y′=2 bits, and thus Y′=2 bits may indicate a maximum M=2 of RB sets. Alternatively, UL BWP #A includes two RB sets, the same number M=2 of RB sets may be indicated.

Possible combination 3-1: The UE identifies whether there is an RB set overlapping with RB set #3 in which the DCI format is transmitted, in the frequency domain among RB sets of UL BWP #B after switching. Referring to FIG. 29, RB set #3 in UL BWP #B overlaps with RB set #3 in which the DCI format is transmitted. Accordingly, RB set #3 in UL BWP #B may be determined as a designated RB set. In addition, the UE may receive an indication of RB set #3 in UL BWP #B through Y′=2 bits. In addition, the UE may receive an indication of RB set #3 in UL BWP #B and RB sets adjacent to RB set #3 in UL BWP #B through Y′=2 bits. Accordingly, other than RB set #3 in UL BWP #B, one RB set adjacent to RB set #3 in UL BWP #B needs to be selected. Here, the adjacent RB set is RB set #2 in UL BWP #B. When an RB set of the UL BWP, which overlaps with the RB set of the DL BWP in which the DCI format is transmitted, or has the most adjacent frequency, is selected, for RB sets of the DL BWP, which are most adjacent to the RB set of the DL BWP in which the DCI format is transmitted, downlink channel access base on a Cat-2 scheme may be performed. Accordingly, there is high probability that the RB sets are RB set(s) in the DL BWP, for which channel access has been successfully performed, and accordingly, when channel access has been successfully performed for the corresponding RB set(s), the base station can simplify channel access at the UE through COT sharing with the UE, thereby increasing uplink transmission possibility in terms of channel access. That is, when the UE performs transmission within a COT which can be indicated by the base station through group common signaling, the gNB performs COT sharing for the UE. Accordingly, it is advantageous in that the UE can increase UL transmission possibility by using, as a channel access scheme, a simple Cat-2 scheme or No LBT scheme rather than a Cat-4 channel access scheme causing random backoff. In addition, this may be a method enabling transmission of only consecutive RB set(s) through selection of adjacent RB set(s) in case of uplink transmission.

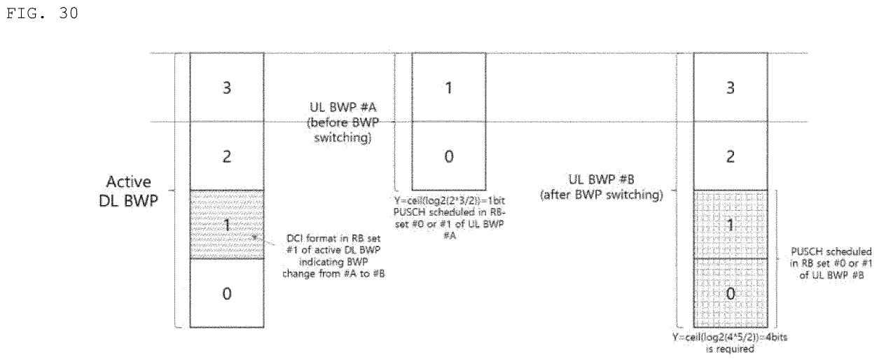

Possible combination 3-2: The UE identifies whether there is an RB set overlapping with RB set #1 in which the DCI format is transmitted, in the frequency domain among RB sets of UL BWP #B after switching. Referring to FIG. 30, RB set #1 in UL BWP #B overlaps with RB set #1 of the DL BWP, in which the DCI format is transmitted. Accordingly, RB set #1 in UL BWP #B may be determined as a designated RB set. In addition, the UE may receive an indication of RB set #1 in UL BWP #B through Y′=2 bits. In addition, the UE may receive an indication of RB set #1 in UL BWP #B and RB sets adjacent to RB set #0 in UL BWP #B through Y′=2 bits. In case of four RB sets, ceil(log 2(4*5/2))=4 bits is satisfied, exceeding Y′=2 bits, and thus Y′=2 bits may indicate a maximum M=2 of RB sets. Accordingly, other than RB set #1 in UL BWP #B, one RB set adjacent to RB set #1 in UL BWP #B needs to be selected. Here, the adjacent RB sets are RB set #0 in UL BWP #B and RB set #2 in UL BWP #B. The UE may select one of the two RB sets. Here, referring to FIG. 30, RB set #0 in UL BWP #B corresponding to an RB set having a lower frequency than RB set #1 in UL BWP #B may be selected. In another example, referring to FIG. 30, RB set #2 in UL BWP #B corresponding to an RB set having a higher frequency than RB set #1 in UL BWP #B may be selected.

A method for interpreting Y′ bits in possible combinations 3-1 and 3-2 is as follows.

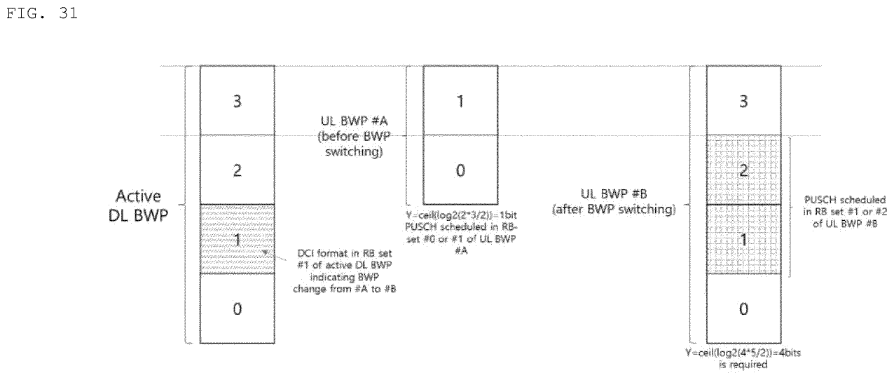

As a first method, the UE may interpret that Y′ bits are indication information of M′ RB sets of UL BWP #A. This acquired scheduling information may be determined as scheduling information of a designated RB set of UL BWP #B and adjacent RBs of the designated RB set. When the Y′ bits are interpreted as indication information of M′ RB sets of UL BWP #A and Q RB sets from RB set #P in UL BWP #A are indicated, it may be determined that an RB set having the lowest index among adjacent RBs of the designated RB set and the designated RB set of UL BWP #B is indexed as 0 again and Q RB sets from the (P+1)-th RB set are indicated. For example, referring to FIG. 31, Y′=2 bits may indicate RB set #0 in UL BWP #A and RB set #1 in UL BWP #A, and this may be mapped to RB set #1 in UL BWP #B and RB set #2 in UL BWP #B and indicated. For example, when Y′ (Y′=2 bits) is 00, it may be determined that RB set #0 in UL BWP #A is indicated, and it may be determined that this is mapped to RB set #1 in UL BWP #B and indicated. For example, when Y′ (Y′=2 bits) is 01, it may be determined that RB set #1 in UL BWP #A is indicated, and it may be determined that this is mapped to RB set #2 in UL BWP #B and indicated.

As a second method, the UE may obtain Y bits by padding a (Y−Y′)-bit zero to the MSB of Y′ bits and interpret that the obtained Y bits are indication information of M RB sets of UL BWP #B. When the Y bits are interpreted as indication information of M RB sets of UL BWP #B and Q RB sets from RB set #P in UL BWP #B are indicated, it may be determined that an RB set having the lowest index among adjacent RBs of the designated RB set and the designated RB set of UL BWP #B is indexed as 0 again and Q RB sets from the (P+1)-th RB set are indicated. In other words, in a case where the Y bits are interpreted as indication information of M RB sets of UL BWP #B and Q RB sets from RB set #P in UL BWP #B are indicated, when an index of an RB set having the lowest index among adjacent RBs of the designated RB set and the designated RB set of UL BWP #B is O, it may be determined that Q RB sets from RB set #(P+O) in UL BWP #B are indicated. This is identical to a case of acquiring a value by shifting O RB sets. For example, referring to FIG. 31, the UE obtains Y=4 bits by padding a 2-bit zero to Y′=2 bits. This Y bits may indicate RB set #0 in UL BWP B #, RB set #1 in UL BWP B #, RB set #2 in UL BWP B #, and RB set #3 in UL BWP B #. For example, when Y (Y=4 bits) is 0000, it is determined that RB set #0 in UL BWP #B is indicated. In FIG. 31, O=1. Accordingly, it may be determined that this is mapped to RB set #(0+1) in UL BWP #B and indicated. For example, when Y (Y=4 bits) is 0001, it is determined that RB set #1 in UL BWP #B is indicated, and it may be determined that this is mapped to RB set #(1+1) in UL BWP #B and indicated.

In another embodiment, a combination of RB set(s) for performing downlink transmission or uplink transmission may be predefined according to the regulation. That is, to take FIG. 3 as an example, only group {0,1} or {2,3} is made from among RB sets belonging to an active DL BWP as a scheme of making a group of two RB sets, or only group {0,1,2,3} is made when four RB sets are grouped. Accordingly, when a predefined RB sets are grouped, a method for selecting overlapping RB set(s) of UL BWP with reference to the corresponding group of RB sets may be considered. That is, as shown in FIG. 30, when the DCI format is transmitted in RB set #1 of the DL BWP and two of the RB sets of the UL BWP are configured to be selected, RB set(s) of the UL BWP, which can overlap with {0,1}, are selected in consideration of RB set #0 of the DL BWP, which can be grouped together with RB set #1 of the DL BWP. That is, the base station can simplify channel access at the UE through DL to UL COT sharing with the UE, thereby increasing uplink transmission probability in terms of channel access.

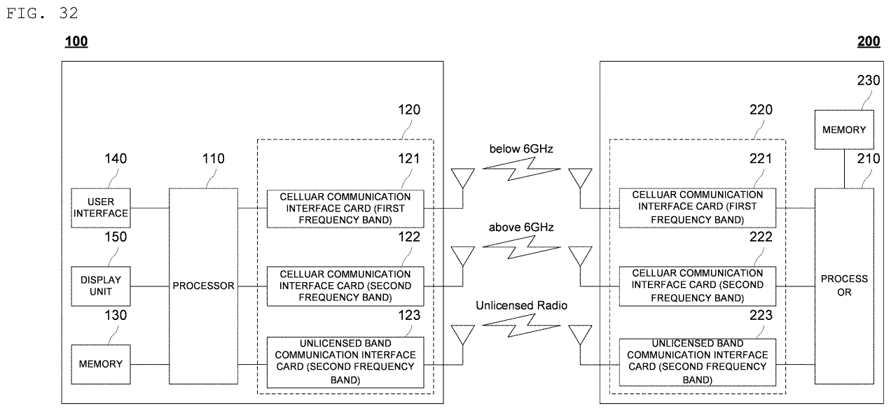

FIG. 32 illustrates configurations of a terminal and a base station according to an embodiment of the disclosure. In an embodiment of the disclosure, the terminal may be implemented by various types of wireless communication devices or computing devices of which portability and mobility are guaranteed. The terminal may be referred to as a user equipment (UE), a station (STA), a mobile subscriber (MS), and the like. In addition, in an embodiment of the disclosure, the base station may control and take charge of cells (e.g., a macro cell, a femto cell, a pico cell, and the like) corresponding to service areas and perform functions including signal transmission, channel designation, channel monitoring, self-diagnosis, relay, and the like. The base station may be referred to as a next generation Node B (gNB), an access point (AP), and the like.

As illustrated, a terminal 100 according to an embodiment of the disclosure may include a processor 110, a communication module 120, a memory 130, a user interface unit 140, and a display unit 150.

First, the processor 110 may execute various commands or programs and process data in the terminal 100. In addition, the processor 100 may control all operations of the respective units of the terminal 100 and control data transmission/reception among the units. Here, the processor 110 may be configured to perform operations according to the embodiments described in the disclosure. For example, the processor 110 may receive slot configuration information, determine a slot configuration on the basis of the information, and perform communication according to the determined slot configuration.

Next, the communication module 120 may be an integrated module that performs wireless communication using a wireless communication network and wireless LAN access using a wireless LAN. To this end, the communication module 120 may include multiple network interface cards (NICs) such as cellular communication interface cards 121 and 122 and an unlicensed band communication interface card 123 in an internal or external type. In FIG. 32, the communication module 120 is illustrated as an integrated module, but the respective network interface cards may be independently arranged according to a circuit configuration or purpose unlike FIG. 32.

The cellular communication interface card 121 may transmit or receive a radio signal to or from at least one of a base station 200, an external device, and a server by using the mobile communication network and provide a cellular communication service at a first frequency band on the basis of a command of the processor 110. According to an embodiment, the cellular communication interface card 121 may include at least one NIC module using a frequency band below 6 GHz.

At least one NIC module of the cellular communication interface card 121 may independently perform cellular communication with at least one of the base station 200, the external device, and the server according to a cellular communication specification or protocol of the frequency band below 6 GHz, supported by the corresponding NIC module.

The cellular communication interface card 122 may transmit or receive a radio signal to or from at least one of the base station 200, the external device, and the server by using the mobile communication network and provide a cellular communication service at a second frequency band on the basis of a command of the processor 110. According to an embodiment, the cellular communication interface card 122 may include at least one NIC module using a frequency band of 6 GHz or above. At least one NIC module of the cellular communication interface card 122 may independently perform cellular communication with at least one of the base station 200, the external device, and the server according to a cellular communication specification or protocol of the frequency band of 6 GHz or above, supported by the corresponding NIC module.

The unlicensed band communication interface card 123 may transmit or receive a radio signal to or from at least one of the base station 200, the external device, and the server by using a third frequency band corresponding to a unlicensed band and provide an unlicensed band communication service on the basis of a command of the processor 110. The unlicensed band communication interface card 123 may include at least one NIC module using an unlicensed band. For example, the unlicensed band may be a band equal to or above 2.4 GHz, 5 GHz, 6 GHz, 7 GHz, or 52.6 GHz. At least one NIC module of the unlicensed band communication interface card 123 may independently or dependently perform wireless communication with at least one of the base station 200, the external device, and the server according to an unlicensed band communication specification or protocol of the frequency band, supported by the corresponding NIC module.

Next, the memory 130 stores a control program used in the terminal 100 and various resulting data. The control program may include a predetermined program required for the terminal 100 to perform wireless communication with at least one of the base station 200, the external device, and the server.

Next, the user interface 140 includes various types of input/output means provided in the terminal 100. That is, the user interface 140 may receive a user input by using various input means, and the processor 110 may control the terminal 100 on the basis of the received user input. In addition, the user interface 140 may perform output based on a command of the processor 110 by using various output means.

Next, the display unit 150 outputs various images on a display screen. The display unit 150 may output various display objects such as a content executed by the processor 110 and a user interface based on a control command of the processor 110.

In addition, the base station 200 according to an embodiment of the disclosure may include a processor 210, a communication module 220, and a memory 230.

First, the processor 210 may execute various commands or programs and process data in the base station 200. In addition, the processor 210 may control all operations of the respective units of the base station 200 and control data transmission/reception among the units. Here, the processor 210 may be configured to perform operations according to the embodiments described in the disclosure. For example, the processor 210 may perform signaling of slot configuration information, and perform communication according to the signaled slot configuration.

Next, the communication module 220 may be an integrated module that performs wireless communication using a wireless communication network and wireless LAN access using a wireless LAN. To this end, the communication module 220 may include multiple network interface cards such as cellular communication interface cards 221 and 222 and an unlicensed band communication interface card 223 in an internal or external type. In FIG. 32, the communication module 220 is illustrated as an integrated module, but the respective network interface cards may be independently arranged according to a circuit configuration or purpose unlike FIG. 32.

The cellular communication interface card 221 may transmit or receive a radio signal to or from at least one of the terminal 100, the external device, and the server by using the mobile communication network and provide a cellular communication service at a first frequency band on the basis of a command of the processor 210. According to an embodiment, the cellular communication interface card 221 may include at least one NIC module using a frequency band below 6 GHz.

At least one NIC module of the cellular communication interface card 221 may independently perform cellular communication with at least one of the terminal 100, the external device, and the server according to a cellular communication specification or protocol of the frequency band below 6 GHz, supported by the corresponding NIC module.

The cellular communication interface card 222 may transmit or receive a radio signal to or from at least one of the terminal 100, the external device, and the server by using the mobile communication network and provide a cellular communication service at a second frequency band on the basis of a command of the processor 210. According to an embodiment, the cellular communication interface card 222 may include at least one NIC module using a frequency band of 6 GHz or above. At least one NIC module of the cellular communication interface card 222 may independently perform cellular communication with at least one of the terminal 100, the external device, and the server according to a cellular communication specification or protocol of the frequency band of 6 GHz or above, supported by the corresponding NIC module.

The unlicensed band communication interface card 223 may transmit or receive a radio signal to or from at least one of the terminal 100 by using a third frequency corresponding to an unlicensed band, the external device, and the server by using the mobile communication network and provide an unlicensed band communication service on the basis of a command of the processor 210. The unlicensed band communication interface card 223 may include at least one NIC module using an unlicensed band. For example, the unlicensed band may be a band equal to or above 2.4 GHz, 5 GHz, 6 GHz, 7 GHz, or 52.6 GHz. At least one NIC module of the unlicensed band communication interface card 223 may independently or dependently perform wireless communication with at least one of the terminal 100, the external device, and the server according to an unlicensed band communication specification or protocol of the frequency band, supported by the corresponding NIC module.

FIG. 16 illustrates the terminal 100 and the base station 200 according to an embodiment of the disclosure, and dividedly provided blocks logically divide and illustrate elements of a device. Accordingly, the elements of the device may be mounted as a single chip or multiple chips according to design of the device. In addition, some elements of the terminal 100, for example, the user interface 140, the display unit 150, and the like may be selectively provided in the terminal 100. In addition, the user interface 140, the display unit 150, and the like may be additionally provided in the base station 200 as necessary.

The method and the system of the disclosure are described in association with the specific embodiments, but some or all of the elements and operations of the disclosure may be implemented by using a computer system having a universal hardware architecture.

The description of the disclosure is provided as an example and those skilled in the art to which the disclosure belongs can understand that the disclosure can be easily modified to other detailed forms without changing the technical idea or an essential feature thereof. Therefore, the above-described embodiments are all illustrative in all aspects and are not limited. For example, each element described as a single type may be implemented to be distributed and similarly, elements described to be distributed may also be implemented in a combined form.

The scope of the disclosure is represented by the claims to be described below rather than the detailed description, and it is to be interpreted that the meaning and scope of the claims and all the changes or modified forms derived from the equivalents thereof come within the scope of the disclosure.

1. A method for receiving a downlink channel by a terminal in an unlicensed band, the method comprising:
receiving information indicating one or more synchronization signal/physical broadcast channel (SS/PBCH) block indices from a base station in the unlicensed band,
wherein the one or more SS/PBCH block indices are used to recognize one or more resources corresponding to the one or more SS/PBCH block indices, respectively, among multiple resources based on candidate SS/PBCH block indices; and
receiving downlink control information (DCI) for allocating resources for a physical downlink shared channel (PDSCH) from the base station in the unlicensed band,
wherein the PDSCH is received on the basis of a resource remaining after excluding the one or more resources from among the resources allocated by the DCI.

2. The method of claim 1, wherein the PDSCH is decoded on the basis of the resources when the resources for the PDSCH and the one or more resources do not overlap with each other, and
wherein when the resources for the PDSCH and the one or more resources partially or completely overlap with each other, resources partially or completely overlapping with the one or more resources among the resources are not used for the PDSCH.

3. The method of claim 1, wherein the SS/PBCH block indices correspond to multiple resources, and when SS/PBCH blocks are received in some resources among the multiple resources within a DRS transmission window, a resource remaining after excluding some resources from the multiple resources within the DRS transmission window is used for reception of the PDSCH.

4. The method of claim 1, further comprising receiving information on a maximum number of the one or more SS/PBCH block indices from the base station,
wherein rate matching of the PDSCH is performed in one or more resources corresponding to the maximum number within a DRS transmission window, among the multiple resources based on the candidate SS/PBCH block indices.

5. The method of claim 1, wherein a semi-static channel access mode is configured in the unlicensed band, and
wherein when the one or more resources among the multiple resources based on the candidate SS/PBCH block indices overlap with an idle period of a fixed frame period (FFP), the PDSCH is decoded on the basis of the resources for the PDSCH.

6. The method of claim 1, wherein a semi-static channel access mode is configured in the unlicensed band, and
wherein in the information indicating the one more synchronization signal/physical broadcast channel (SS/PBCH) block indices, a bit value corresponding to a resource overlapping with an idle period of an FFP is configured as 0.

7. A method for transmitting an uplink signal by a terminal in an unlicensed band, the method comprising:
receiving information indicating one or more synchronization signal/physical broadcast channel (SS/PBCH) block indices from a base station in the unlicensed band, wherein the one or more SS/PBCH block indices are used to recognize one or more resources corresponding to the one or more SS/PBCH block indices, respectively, among multiple resources based on candidate SS/PBCH block indices; and
determining a resource for the uplink signal in the unlicensed band, wherein the resource for the uplink signal is determined on the basis of the one or more resources corresponding to the one or more SS/PBCH block indices, respectively.

8. The method of claim 7, wherein the uplink signal is a random access preamble,
wherein the resource for the uplink signal is a physical random access channel (PRACH) occasion within a PRACH slot, and
wherein in a case where uplink/downlink configuration information is not provided, if the PRACH occasion does not precede the one or more resources corresponding to the one or more SS/PBCH block indices, respectively, starts after at least Ngap symbols from a last reception symbol of the one or more resources, the PRACH occasion is determined as valid.

9. The method of claim 7, wherein the uplink signal is a random access preamble,
wherein the resource for the uplink signal is a PRACH occasion within a PRACH slot, and
wherein in a case where uplink/downlink configuration information is provided, if the PRACH occasion does not precede the one or more resources corresponding to the one or more SS/PBCH block indices, respectively, starts after at least Ngap symbols from a last downlink symbol, and starts after at least Ngap symbols from a last reception symbol of the one or more resources, the PRACH occasion is determined as valid.

10. The method of claim 7, wherein a semi-static channel access mode is configured in the unlicensed mode,
wherein the uplink signal is a random access preamble, and the resource for the uplink signal is a PRACH occasion within a PRACH slot, and
wherein when the one or more resources overlap with an idle period of a fixed frame period, the PRACH occasion is determined regardless of the one or more resources.

11. The method of claim 7, wherein the uplink signal is a random access preamble, and the resource for the uplink signal is a PRACH occasion within a PRACH slot, and
wherein validity of the PRACH occasion is determined on a premise that SS/PBCH blocks having the one or more SS/PBCH block indices are transmitted in the one or more resources corresponding to all the one or more SS/PBCH block indices, respectively, within a DRS transmission window.

12. The method of claim 7, wherein the uplink signal is a physical uplink control channel (PUCCH) repetition, and the resource for the uplink signal is N slots for PUCCH transmission, and
wherein the N slots are selected from among multiple slots comprising an uplink symbol or a flexible symbol not overlapping with the one or more resources corresponding to the one or more SS/PBCH block indices, respectively.

13. The method of claim 7, wherein the uplink signal is a PUCCH repetition, and the resource for the uplink signal is N slots for PUCCH transmission, and
wherein when the SS/PBCH block indices correspond to multiple resources and SS/PBCH blocks are received in some resources among the multiple resources within a DRS transmission window, the N slots are selected from among multiple slots comprising an uplink symbol and a flexible symbol which remain after excluding some resources from the multiple resources within the DRS transmission window.

14. The method of claim 7, wherein the uplink signal is a PUCCH repetition, and the resource for the uplink signal is N slots for PUCCH transmission, and
wherein a slot comprising an uplink symbol or a flexible symbol not overlapping with the one or more resources corresponding to the one or more SS/PBCH block indices, respectively, is determined as the resource for the uplink signal on a premise that SS/PBCH blocks having the one or more SS/PBCH block indices are transmitted in the one or more resources corresponding to all the one or more SS/PBCH block indices, respectively, within a DRS transmission window.

15. The method of claim 7,
wherein the uplink signal is a PUCCH repetition, and the resource for the uplink signal is N slots for PUCCH transmission, and
wherein when the one or more resources corresponding to the one or more SS/PBCH block indices, respectively, overlap with an idle period of a fixed frame period, the N slots are determined regardless of the one or more resources corresponding to the one or more SS/PBCH block indices, respectively.

16. The method of claim 7, wherein the uplink signal is a physical uplink shared channel (PUSCH) repetition, and the resource for the uplink signal is a resource for PUSCH transmission, and
wherein an uplink symbol or a flexible symbol not overlapping with the one or more resources corresponding to the one or more SS/PBCH block indices, respectively, is determined as the resource for the PUSCH transmission.

17. The method of claim 7,
wherein the uplink signal is a PUSCH repetition, and the resource for the uplink signal is a resource for PUSCH transmission, and
wherein when the SS/PBCH block indices correspond to multiple resources and SS/PBCH blocks are received in some resources among the multiple resources within a DRS transmission window, an uplink symbol and a flexible symbol of a resource, which remain after excluding some resources from the multiple resources within the DRS transmission window are determined as the resource for the PUSCH transmission.

18. The method of claim 7,
wherein the uplink signal is a PUSCH repetition, and the resource for the uplink signal is a resource for PUSCH transmission, and
wherein an uplink symbol or a flexible symbol not overlapping with the one or more resources corresponding to the one or more SS/PBCH block indices, respectively, is determined as the resource for the PUSCH transmission on a premise that SS/PBCH blocks having the one or more SS/PBCH block indices are transmitted in the one or more resources corresponding to all the one or more SS/PBCH block indices, respectively, within a DRS transmission window.

19. The method of claim 7,
wherein the uplink signal is a PUSCH repetition, and the resource for the uplink signal is a resource for PUSCH resource, and
wherein when the one or more resources corresponding to the one or more SS/PBCH block indices, respectively, overlap with an idle period of a fixed frame period, the resource for the PUSCH transmission is determined regardless of the one or more resources corresponding to the one or more SS/PBCH block indices, respectively.
